(19) United States
(12) Patent Application Publication
(10) Pub. No.: US 2007/0006194 A1
(43) Pub. Date: Jan. 4, 2007

(54) Static analysis method regarding lyee-oriented software

(75) Inventors: Mohamed Mejri, Quebec (CA); Bechir Ktari, Quebec (CA); Hamido Fujita, Iwate (JP); Mourad Erhioui, St. Laurent (CA)

Correspondence Address: WILMER CUTLER PICKERING HALE AND DORR LLP, 1875 PENNSYLVANIA AVE., NW, WASHINGTON, DC, 20004, US

(73) Assignee: Catena Corporation, Tokyo (JP)

(21) Appl. No.: 10/548,632

(22) PCT Filed: Sep. 25, 2003
(86) PCT No.: PCT/JP03/12284

§ 371 Date: Aug. 15, 2006

(30) Foreign Application Priority Data
Mar. 10, 2003 (JP) 2003-064220

(51) Int. Cl. G06F 9/45

(52) U.S. Cl. 717/151; 717/141; 717/152

(57) ABSTRACT

A static analysis method conventionally used is applied to the Lyee requirement. More specifically, for Lyee requirement as an object, optimization (classical optimization, optimization by ordering of a predicate vector), slicing, requirement debug, and typing (error detection, type finding, security using a type) are performed. These are subjected to a pre-processing appropriate for generation of optimal code by the LyeeAll tool to obtain a format for outputting a requirement. Thus, it is possible to optimize the requirement definition for code generation having a more preferable quality (reduction in memory and execution time consumption) in the Lyee methodology.

### TECHNICAL FIELD

The present invention relates to a software analysis method which can be used for software in all purposes, types/contents, and forms irrespective of, e.g., business/individual purposes, types/contents of business applications/games or the like, and forms of single software/electronic product incorporated ROM or the like, and more particularly to a static analysis method regarding Lyee (registered trademark, similar hereinafter) oriented software.

### BACKGROUND ART

Software development and maintenance has become an activity of major importance in our economy. As computer comes into widespread use, this activity involves a big industry.

Hundreds of billions of dollars are spent every year in order to develop and maintain software. Today, competition between actors of software development field is fiercer than ever. To survive the race, these actors (companies) must keep productivity at its peek and cost at its bottom. They must also deliver products (software) having high qualities and deliver them in time. However, the available tools and methodologies for software development do not always suit properly the company needs?

Basically, the goal of the software development researches is to look for a method for building software of better quality easily and quickly. A large variety of methodologies and techniques have been elaborated and proposed, over the last 10 years, to improve one or many steps of the software development life cycle.

Despite their acknowledgedly considerable contributions, they have a big difficulty in finding their way into widespread use. In fact, almost all of them fail to produce clearly understandable and modifiable systems and their use is still considered to be an activity accessible only to specialists with a very large array of competencies, skills, and knowledge. This, in turn, means that highly paid personal, high cost maintenance, and extensive checks are needed for the software to be performed. For these reasons, companies are now more than welcome to any new promising methodology improvement in software development cycle and they are ready to pay the price.

Lyee (a word formed from the final letter of “governmentaL methodologY for softwarE providence”) is one of the new and very promising methodologies. Intended to deal efficiently with a wide range of software problems related to different field, Lyee allows the development of software by simply defining their requirements. More precisely, the user has only to give a word, the word's calculation formulae, the word's calculation conditions (preconditions) and layout of screens and printouts (e.g., see Patent Documents 1, 2, and 4 to 6).

Then all subsequent troublesome programming process (control logic aspects) is to be relegated in the hands of a computer. In other words, it is not necessary for a human such as a system engineer (SE) to design a logic. Despite Lyee'S infancy, the results of its use have shown its tremendous potential. In fact, compared to conventional methodologies, development time, maintenance time and documentation volume can be considerably reduced (70 to 80%). Up to now, a primitive supporting tool called LyeeAll is available to developers allowing the automatic generation of code from requirements (e.g., see Patent Documents 3 and 4).

Nevertheless, as is true for any new methodology, researches have to be made on Lyee to prove its efficiency, and to improve its good qualities. Furthermore, the LyeeAll tool has a room be further developed to make it more user-friendly.

On the other hand, as software static analysis methods, there are (1) an optimizing technique, (2) a program slicing technique, (3) requirement debugging, (4) typing, and the like (see Nonpatent Documents 1 and 4).

(1) The optimizing technique (see Nonpatent Documents 3 and 8) is carried out for the purpose of adopting a series of changes to reduce a volume of a code string, to shorten its execution time, and to reduce memory consumption or the like. However, in combination with Lyee methodology, an optimizing target has been a code string prepared by the Lyee methodology, and optimizing that targets Lyee requirements has not clearly been realized technically (see Patent Document 4).

(2) The program slicing technique has long been used as an approach of “dividing and controlling” program reading and debugging in traditional programming languages. It has successfully been used for analysis of many applications. However, objects of these applications are combination, algorithm debugging, reverse engineering, component reuse, automatic paralleling, program integration, measurement of verification assistance, and the like. There has been proposed no idea of combining this technique with the Lyee methodology (see Nonpatent Document 12).

(3) The requirement debugging can obtain a more useful result by detecting requirement bugs before codes are generated. However, there has been proposed no idea of combining this technique with the Lyee methodology.

(4) The typing (see Nonpatent Documents 2 and 11) is mainly used for statically guaranteeing some dynamic and good operational characteristics of programs. According to this typing, errors that frequently occur during program execution can be detected at the time of compiling. The typing technique has successfully been used for ensuring that developed software will deal with security problems of some kind (see Nonpatent Document 11). However, there has been proposed no idea of combining this technique with the Lyee methodology.

(Patent Document 1)

International Publication WO 97/16784 A1 pamphlet

(Patent Document 2)

International Publication WO 98/19232 A1 pamphlet

(Patent Document 3)

International Publication WO 99/49387 A1 pamphlet

(Patent Document 4)

International Publication WO 00/79385 A1 pamphlet

(Patent Document 5)

International Publication WO 02/42904 A1 pamphlet

(Patent Document 5)

Japan Patent Application Laid-Open Publication No. 2002-202883

(Nonpatent Document 1)

M. Bozga, J. C. Fernandez, and L. Ghirvu. Using static analysis to improve automatic test generation. pages 235-250, 2000.

(Nonpatent Document 2)

L. Cardelli. Type systems. Handbook of Computer Science and Engineering, Chapter 103, CRC Press, 1997.

(Nonpatent Document 3)

T. HENNING. Optimization Methods. Springer-Verlag, 1975.

(Nonpatent Document 4)

S. Muchnick. Compiler Design Implantation. Morgan Kaufman Publishers, California, 1999.

(Nonpatent Document 5)

F. Negoro. Principle of Lyee software. 2000 International Conference on Information Society in 21st Century (IS2000), pages 121-189, November 2000.

(Nonpatent Document 6)

F. Negoro. Introduction to Lyee. The Institute of Computer Based Software Methodology and Technology, Tokyo, Japan, 2001.

(Nonpatent Document 7)

F. Negoro and I. Hamid. A proposal for intention engineering. 5th East-European Conference Advances in Databases and Information System (ADBIS'2001), September 2000.

(Nonpatent Document 8)

S. PANDE and D. P. AGRAWAL. Compiler Optimizations for Scalable Parallel Systems: Languages, Compilation Techniques, and Run Time Systems. Springer-Verlag, 2001.

(Nonpatent Document 9)

D. E. Rutherford. Introduction to Lattice Theory. Hafner Publishing, New York, 1965.

(Nonpatent Document 10)

F. Tip. A survey of program slicing techniques. Journal of Programming Languages, 3(3):121-189, September 1995.

(Nonpatent Document 11)

D. Volpano, G. Smith, and C. Irvine. A sound type system for secure flow analysis. Journal of Computer Security, 4(3):167-187, 1996.

(Nonpatent Document 12)

W. Weiser. Program slicing. IEEE Trans Software Eng., pages 352-357, July 1984.

Thus, various methodologies and techniques have conventionally been proposed as methods capable of easily and quickly constructing higher-quality software, and steps of a software development life cycle has been improved to a certain extent. However, these methodologies and techniques have not realized clear understanding and modification. Moreover, their uses have been convenient only for specialists who have broad ranges of abilities, skills, and knowledge. Thus, there has been a problem that execution of the software has necessitated great labor costs, software maintenance costs, and checking costs.

To solve the problem, a promising methodology called Lyee has been proposed. However, there is still a room for improvement in studies on efficiency and quality, and in realization of higher user friendliness.

The present invention has been developed to solve the foregoing problems of the conventional art. Specifically, it is an object of the present invention to provide a static analysis method regarding Lyee-oriented software which assists higher quality (less consumption of memory and execution time) in a Lyee methodology.

Thus, it is another object of the present invention to show a way to further enhance Lyee methodology by using classical static analysis techniques to analyze Lyee requirements (a set of words within their definitions, their calculation conditions and their attributes), and to provide a static analysis method regarding Lyee-oriented software which can actually use the method.

It is yet another object of the present invention to show how typing and the other static analysis techniques can improve some aspect of the Lyee methodology, and to provide a static analysis method regarding Lyee-oriented software which can actually use the typing and the other static analyzing techniques.

It is a further object of the present invention to introduce the Lyee Requirement Analyzer, a prototype that we have developed to implement some static analysis techniques, and to provide a static analysis method regarding Lyee-oriented software which can actually use the Analyzer.

Finally, it is another object of the present invention to sketch some concluding remarks on this work and future research as a conclusion, and to provide a static analysis method regarding Lyee-oriented software which can actually use the results.

In this case, “Lyee (registered trademark)” means an invention and a technique regarding the software production method or the like invented by Fumio Negoro who is one of the inventors of this application. Its details are disclosed, for example, in International Publications of the Patent Documents 1 to 6 or the like.

### DISCLOSURE OF THE INVENTION

To achieve the object, the present invention comprises a step of obtaining a requirement definition including a definition expression of each word to produce software in accordance with Lyee methodology, a step of using the word of the obtained requirement definition as a key to detect a constant, and a step of propagating the constant in accordance with the definition expression which uses the detected constant.

“Propagation of the constant” means organizing of the definition expressions of the words by unbrokenly substituting the word with the constant, substituting the word having the definition expression which uses this word, and the like when the constant is present in the word of the requirement definition (Lyee requirements).

According to the present invention, as optimizing is executed for the Lyee requirements at a stage before software production by the Lyee, it is possible to achieve further reductions in volume of a code string, memory consumption, and program execution time in the software production by the Lyee methodology.

The present invention comprises a step of obtaining a requirement definition including a definition expression of each word to produce software in accordance with Lyee methodology, a step of detecting a pattern from the definition expression of the obtained requirement definition, and a step of substituting the requirement definition with representation in which the detected pattern is a substitution expression.

“Pattern is a substitution expression” means substitution of a pattern in the requirements with a temporary variable when the pattern appears many times.

According to the present invention, as the pattern in the Lyee requirements which appears by a plurality of times is calculated only once, thereby preventing calculations of many times, it is possible to achieve a reduction in code execution time.

The present invention comprises a step of obtaining a requirement definition including a definition expression and preconditions of each word to produce software in accordance with Lyee methodology, a step of obtaining a statement in which at least an identifier, the definition expression and the preconditions of the word are described in conformity with BNF grammar based on the requirement definition, a step of defining a Def/Use function for each obtained statement, and a step of obtaining an order relation among the statements from an order relation among the defined Def/use functions.

“Statement” means representing by one function of the word in the requirements and its definition expression, the preconditions, the input/output attributes and the like. “Def/use function” means a function of representing an undefined word for each statement, and a function of representing another word used for defining the undefined word.

According to the present invention, as a result of converting/analyzing the word in the Lyee requirements, its definition expression or the like into a statement form, the best combination of predicate vectors (i.e., execution time is reduced) in Lyee's Tense Control Vector can be known. Thus, by making a combination with a tool (LyeeAll) for generating codes from the requirements, it is possible to further increase efficiency of the software production by the Lyee.

The present invention comprises a step of obtaining a requirement definition including a definition expression and input/output attributes of each word to produce software in accordance with Lyee methodology, a step of obtaining a statement in which at least an identifier, the definition expression and the input/output attributes of the word are described based on the requirement definition, a step of deriving another statement (second statement) which contributes to definition of the word of the statement from the obtained statement (first statement) to execute for all the statements a slicing function which places the first and second statements in the same statement group, and a step of obtaining slices independent of each other from the slicing function.

“Slicing function” means a function of converging programs to statements regarding specific calculations to classify them into statement groups independent of each other.

According to the present invention, as slice groups independent of each other can be executed in parallel, it is possible to reduce execution time, especially understanding errors of the requirement definition even when there are many statements.

The present invention comprises a step of obtaining a requirement definition including a definition expression and input/output attributes of each word to produce software in accordance with Lyee methodology, a step of obtaining a statement in which at least an identifier, the definition expression and the input/output attributes of the word are described based on the requirement definition, and a step of detecting a bug in the requirement definition based on predetermined analysis for the obtained statement.

“Detection of a bug in the requirement definition” means discovery of an inactive statement, a cyclic statement, an incomplete-statement, an additional statement, or the like. Needless to say, the target of the bug detection is not limited to these statements, but other statements can be targeted.

According to the present invention, in scenario function execution by the Lyee methodology, transfer of control to a subprogram which is not actually executed can be prevented. Thus, it is possible to achieve a reduction in processing time, an increase in efficiency of a consumed memory, or the like.

The present invention comprises a step of obtaining a requirement definition including a definition expression and input/output attributes of each word to produce software in accordance with Lyee methodology, a step of obtaining a statement in which at least an identifier, the definition expression and the input/output attributes of the word are described based on the requirement definition, a step of defining type algebras for the obtained statement, an operator and data in the statement, and a step of discovering a type error in the requirement definition by using an environment and predetermined type rules correlated to the defined type algebras.

“Type algebra” is a concept introduced to perform, by an expression, an operation of introducing a concept of types for the word, the definition expression or the like regarding the statement generated from the requirements, and of removing equally treating different types of a statement, an operator and a data as errors at a requirement stage.

According to the present invention, as the Lyee requirements are targeted to execute analysis in terms of types, and an error is discovered in the requirements by using type rules, it is possible to further reduce program errors.

The present invention comprises a step of obtaining a requirement definition including a definition expression and input/output attributes of each word to produce software in accordance with Lyee methodology, a step of obtaining a statement in which at least an identifier, the definition expression and the input/output attributes of the word are described based on the requirement definition, a step of defining type algebras for the obtained statement, an operator and data in the statement, and a step of generating types of an intermediate article and an output word from an input word in the requirement definition by using a predetermined environment and type rules based on the defined type algebras.

According to the present invention, as the types of the output word and the intermediate article are uniquely derived beforehand from the input word, it is possible to simplify user's work and to reduce errors.

The present invention comprises a step of obtaining a requirement definition including a definition expression and input/output attributes of each word to produce software in accordance with Lyee methodology, a step of obtaining a statement in which at least an identifier, the definition expression, the input/output attributes and a security label of the word are described based on the requirement definition, a step of defining a label function which correlates the security label to a value of the word by using a lattice showing a relation between security labels in the obtained statement, and a step of determining a program which does not comply with a specific security policy by using a predetermined security policy based on the defined label function.

“Security label” is a label indicating security requirements (e.g., “disclosed, “secret” or the like) for certain information. “Label function” is a function of providing a security label to the word in the requirements to process the same by an expression. “Security policy” is a guide as to how to treat information having a security label to be freely defined by a user side.

According to the present invention, by expanding the aforementioned typing technique to information security, it is possible to achieve automatic program verification which is useful for clarifying design defects likely to cause security violations.

The present invention can be configured by comprising a requirement definition reception section for receiving a requirement definition including a definition expression and preconditions of each word to produce software in accordance with Lyee methodology, an analysis section for analyzing a vocabulary and a sentence structure contained in the received requirement definition from the same to output intermediate representation, a flow analysis section for executing analysis regarding a data flow and a control flow with respect to the requirement definition by starting from the outputted intermediate representation to output a data flow graph and a control flow graph, and an optimization section for optimizing the requirement definition passed through the flow analysis to output improved regulations.

In this case, “requirement definition reception section” is a unit having a function of having the Lyee requirements (requirement definition) imputted before processing by the present invention. For example, it can be realized as a recording medium or ROM which stores the program assuming the aforementioned function in a programmed and executable form.

“Analysis section” is a unit having a function of extracting and analyzing the vocabulary and the sentence structure from the received requirement definition and then outputting the requirement definition as intermediate representation in a sentence structure form. For example, it can be realized as a recoding medium or ROM which stores the program assuming the aforementioned function in a programmed and executable form.

“Flow analysis section” is a unit having a function of outputting all pieces of information regarding a cycle of data flow control from one requirement point to another one point starting from the intermediate representation as, e.g., a control flow graph (CFG), a data flow graph (DFG) and the like. For example, it can be realized as a recording medium or ROM which stores the program assuming the aforementioned function in a programmed and executable form.

“Optimization section” is a unit having a function of executing, e.g., a constant propagation technique to produce a sequence of regularly simplified statements, which is suitable for enabling a LyeeAll tool to generate program which can run more quickly and consumes less memory. For example, it can be realized as a recording medium or ROM which stores the program assuming the aforementioned function in a programmed and executable form.

“Slicer” is a unit having a function of receiving information (such as Def/use correlated to each word) regarding a flow generated by a flow base analysis element and a slicing evaluation standards, and outputting a slice corresponding to the provided evaluation standards. For example, it can be realized as a recording medium or ROM which stores the program assuming the aforementioned function in a programmed and executable form.

Thus, according to the present invention, as each of the aforementioned functions is set as, e.g., a medium of an executable unit, it is possible to receive Lyee requirements as an input, to provide a slice suitable for optimal code generation by the LyeeAll tool and order-refined requirements, and to execute the other requirements optimization such as constant propagation.

Furthermore, the present invention can be realized not only as the software analysis method but also as a software analysis device, or broadly a software development method and a software development device, software for causing a computer to function as the device and the method, a recording medium on which the software is recorded, an apparatus which installs the software a dedicated machine which stores the software in, e.g., ROM or the like, or a business model for executing these as application forms, or the like. These modes are within the present invention.

### BRIEF DESCRIPTION OF THE DRAWINGS

FIG. 1 is a conceptual diagram in which requirement execution in Lyee methodology of the present invention is represented by a code string.

FIG. 2 is a conceptual diagram explaining a concept of a pallet in the Lyee methodology of the present invention.

FIG. 3 is a conceptual diagram explaining a concept of a scenario function in the Lyee methodology of the present invention.

FIG. 4 is a flowchart showing a dynamic structure of a predicate vector in the Lyee methodology of the present invention.

FIG. 5 is a flowchart showing dynamic structures of predicate vectors of L4, a and L4, b in the Lyee methodology of the present invention.

FIG. 6 is a flowchart showing dynamic structures of predicate vectors of L3, a and L3, b in the Lyee methodology of the present invention.

FIG. 7 is a conceptual diagram conceptually explaining mutual operations of screens in the Lyee methodology of the present invention.

FIG. 8 is a conceptual diagram explaining a concept of a process route diagram in the Lyee methodology of the present invention.

FIG. 9 is a flowchart explaining an algorithm of UseDirectAndIndirect (s, S) according to an embodiment of the present invention.

FIG. 10 is a flowchart explaining an algorithm for detecting a cyclic statement according to the embodiment of the present invention.

FIG. 11 is a flowchart explaining an algorithm for detecting an incomplete statement according to the embodiment of the present invention.

FIG. 12 is a flowchart explaining an algorithm for detecting an unnecessary statement according to the first embodiment of the present invention.

FIG. 13 is a flowchart explaining an algorithm for detecting an unnecessary statement according to the embodiment of the present invention.

FIG. 14 is a flowchart explaining an algorithm for detecting one of two statements to be executed first according to the embodiment of the present invention.

FIG. 15 is a flowchart explaining an algorithm for refining (correcting) an order of statements according to the embodiment of the present invention.

FIG. 16 is a flowchart explaining an algorithm for refining (correcting) an order of statements according to the embodiment of the present invention.

FIG. 17 is a flowchart explaining an algorithm for extracting a slice of a word a according to the embodiment of the present invention.

FIG. 18 is a flowchart explaining an algorithm for extracting a slice of a word a according to the embodiment of the present invention.

FIG. 19 is a flowchart explaining an algorithm for extracting an independent slice according to the embodiment of the present invention.

FIG. 20 is a flowchart explaining an algorithm for typing according to the embodiment of the present invention.

FIG. 21 is a flowchart explaining an algorithm for typing according to the embodiment of the present invention.

FIG. 22 is a flowchart explaining an algorithm for typing according to the embodiment of the present invention.

FIG. 23 is a flowchart explaining an algorithm for typing according to the embodiment of the present invention.

FIG. 24 is a flowchart explaining an algorithm for typing according to the embodiment of the present invention.

FIG. 25 is a flowchart explaining an algorithm for typing according to the embodiment of the present invention.

FIG. 26 is a functional block diagram also serving as a flowchart to explain a dynamic structure of Lyee requirement analyzer according to the embodiment of the present invention.

### OVERVIEW OF THE INVENTION

A basic idea of the present invention is a development methodology called Lyee, and this is disclosed in the aforementioned Patent Documents 1 to 6 or the like.

One of the most problematic tasks in the process of the study and development of software is to well understand requirements and correctly transforming them into code. To solve this problem, the Lyee methodology propose a simple way to generate programs from requirements.

The philosophic principles behind the Lyee methodology should be cited herein from the above documents. Hereinafter, referring to the drawings and tables, we focus only on some practical ideas useful to understand how to write software using this methodology and how to look the codes that are automatically generated from requirements made by this methodology.

(1) Lyee Requirements

Within the Lyee methodology requirements are given in a declarative way as a set of statements containing words together with their definitions, their calculation conditions and their attributes (input/output, types, security attributes, etc.).

For the sake of simplicity, in the description, we consider that each statement contains the following pieces of information 1) to 5).

1) Word

It is an identifier of a word.

2) Definition: it is an expression defining the word. We suppose, for the sake of simplicity, that an expression can be one of the following:
Exp:=val|id||(Exp)|op Exp|Exp op Exp
val:=num|num.num|bool
num:=0|1 . . . |9|num num
bool:=true|false
id:=a| . . . |z|A| . . . |Z|id num|id id
Op:=+|−|*|or|and|<|<=|=|<>|>|>=|not

The above definition of the expression Exp can be interpreted as following:
Exp: An expression “Exp” can be a value “val”, an identifier “id”, a parenthesized expression “(Exp)”, a unary operator “op Exp”, followed by an expression (e.g. −2, −(a+b)) or an expression “Exp op Exp” followed by a binary operator accompanied by another expression.
val: A value val can be a numeric value “num”, a float value “num.num” (numeric dot numeric) or a Boolean (true/false value)“bool”.
num: A numeric “num” can be a number (digit) or a numeric “num num” followed by another numeric.
bool: A boolean can be true or false.
id: An identifier “id” can be a letter, “id num”, a letter followed by a numeric, or “id id”, an identifier followed by an identifier.
op: An operator can be +, −, *, or, and, <, <=, =, <>, >, >= or not

2) Condition

Condition is the calculation condition of the word which is an expression Exp that is supposed to be Boolean operator. Notice that if there is no condition (that is the condition is always true), we leave this field empty.

3) IO:

This field allows to specify whether the defined word is an input word, output word or an intermediate word. If the word is an input, and if it is an input from a file, this field can take the value IF, or if the word is an input from screen if it is IS. Similarly, if the word is an output, then this field can take the value OF (output to the file) or OS (output onto the screen). However, if the word is intermediate word, we leave this field empty. The intermediate word is a word which is not an input, whose value generated by the definition expression is not output but contributes only to generation of a value of another output word.

4) Type

This field is allocated to specify the type of the word. It takes one of an integer “int”, a floating point number “float”, and a boolean value “bool.”

5) Security

This field is allocated to determine a security level to the defined word and it takes one of the following value: public or secret. Notice, that the fields “Type” and “Security” can be empty if the defined word is not an input. Notice also, that the other types and the other security level can be easily extended to match exactly the real Lyee requirements.

Table 1 gives an example of Lyee requirements.

TABLE 1
Lyee Requirements.

| Word | Definition | Condition | IO | Type | Security |
|---|---|---|---|---|---|
| | | . | | | |
| | | . | | | |
| | | . | | | |
| a | b+c | b*e>2 | OF | int | secret |
| c | | | IS | float | public |
| b | 2*c+5 | c>0 | OS | float | public |
| e | | | IS | float | public |
| | | . | | | |
| | | . | | | |
| | | . | | | |

In the description, hereinafter, we mean by statement a line in a table of requirements.

For instance, the statement defining the word a, denoted Sa, in the Table 1 is described in Table 2.

TABLE 2
Statement of the Word “a”

| Word | Definition | Condition | IO | Type | Security |
|---|---|---|---|---|---|
| a | b+c | b*e>2 | OF | int | secret |

In the description, hereinafter, if s is a statement, the following definition is used as a meaning below.

1) Word(s) to denote the field “Word” of the statement.

2) Definition(s) to denote the field “Definition” of the statement.

3) Condition(s) to denote the field “Condition” of the statement.

4) IO(s) to denote the field “IO” of the statement.

5) Type(s) to denote the field “Type” of the statement.

6) Security(s) to denote the field “Security” of the statement.

(2) Code Generation of Lyee Program

Let Sw be the statement defining the word w. Then the requirements given in the Table 1, in a traditional programming language, correspond to the code given in Table 3.

Within the Lyee methodology, the user does not need to specify the order (control logic) in which these definitions will be executed. As shown in Table 1, despite the fact that the definition of the word a uses the word b, the statement Sb is given after the statement Sa. The control logic, or a logical part of the software will be, within the Lyee methodology, automatically generated, then as a result dramatically reducing programming errors and programming time.

TABLE 3

| Statement | Code |
|---|---|
| Sₐ | If b * e > 2 |
| | then a: = b + c; output(a); |
| | endif |
| S_{c} | Input(c); |
| S_{b} | If c > 2 |
| | then b: = 2 * c + 5; output(b); |
| | endif |
| Sₑ | Input(e); |

From requirements in Table 1, we can automatically generate a program that computes the value of a and b and output them. FIG. 1 is a conceptual diagram in which of the requirements reflected in execution is represented as a code string. As shown in the drawing, program will simply repeat the execution of these instructions until a fixed point is reached, i.e., until any other iteration will not change the value of any word as shown in FIG. 1.

Moreover, changing the order of codes associated to the statement given in Table 3, the semantic of the program will never change, i.e. it will always associate the correct values to the words.

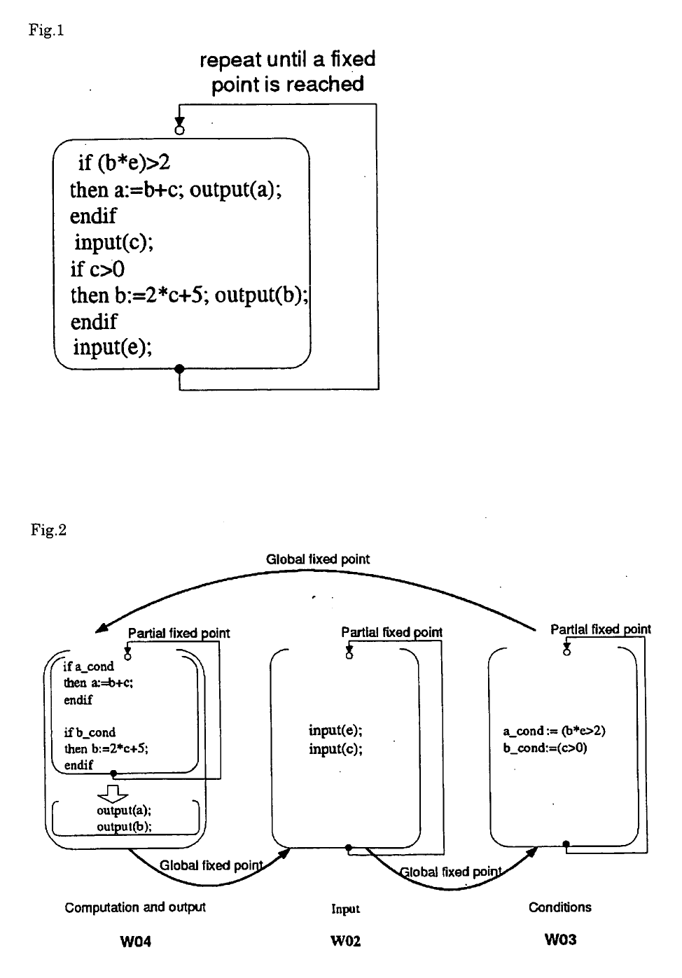

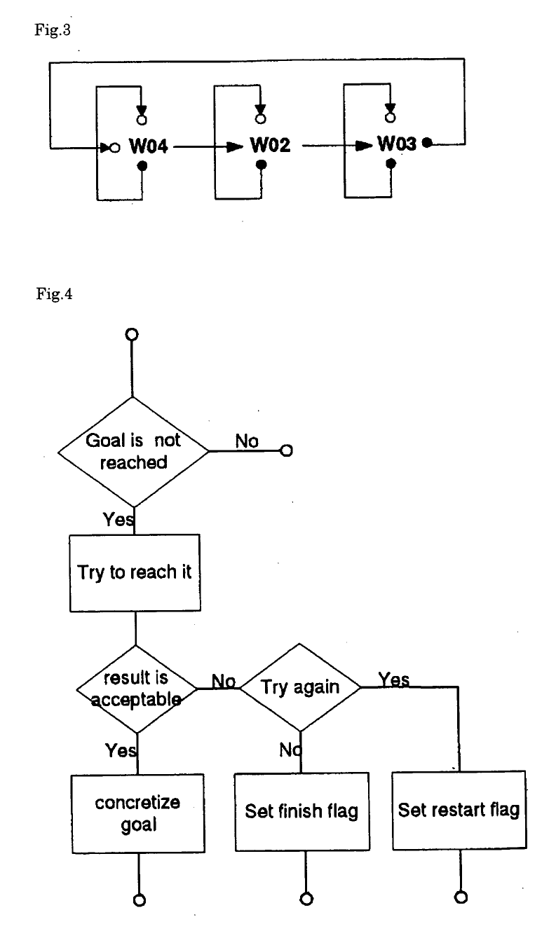

Let's give more precision about the structure and the content of the program that will be automatically generated by Lyee from requirements. Within the Lyee methodology, the execution of a set of statements, such the ones given in Table 1, is accomplished in a particular manner. Lyee distributes the code associated to statements over three spaces, called Pallets (W02, W03 and W04) in the Lyee terminology, as shown in FIG. 2.

As shown in the drawing, the W02 pallet deals with the input words, the W03 pallet computes the calculation conditions of the words and the results are saved in some boolean variables (Bool value taken as a value). For instance, the condition ‘b*e>2’ used within the definition of the word ‘a’ is calculated in W03 pallet and the true/false result is saved in another variable ‘a_cond’. Finally, the W04 pallet deals with the calculation of the words according to their definition given within the requirements. It also outputs the value of the computed words.

Starting form the W04 pallet, a Lyee program tries to compute the values of all the defined words until a fixed point is reached. Once there is no evolution in W04 concerning the word values, the control is given to the W02 pallet. In its turn, this second pallet tries repeatedly to input the missing words until a fixed point is reached (no other inputs are available) and then transfer the control to the W03 pallet. Finally, and similarly to the W04 pallet, the W03 pallet tries to compute the calculation conditions of the words according to the requirements until a fixed point is reached.

As shown in FIG. 3, this whole process (W04→W02→W03) will repeat until a situation of overall stability is reached and it is called Basic Structure, or a Scenario Function. Besides, it is simple to see that the result of the execution of the program shown in FIG. 1 will be the same as the result of the one shown in FIG. 2.

In addition, Lyee has established a simple elementary program with a fixed structure (called Predicate Vector in the Lyee terminology) that makes the structure of generated codes uniform and independently from the requirement content. The global program which integrates the whole will be simple calls of predicate vectors. The structure of a predicate vector is as shown in FIG. 4.

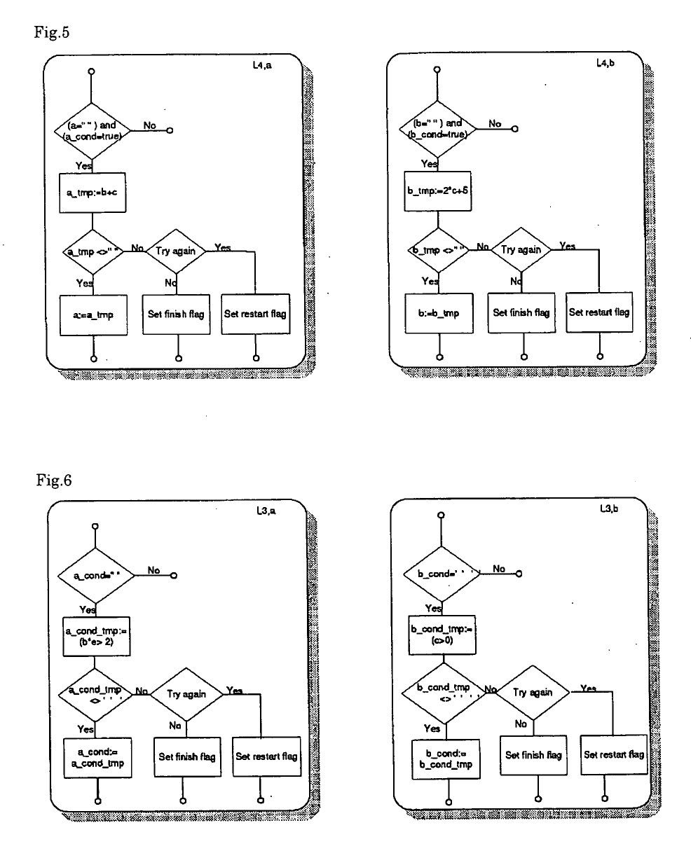

As shown in the drawing, the goal of a predicate vector change from one pallet to another. For instance, in the W04 pallet, the first goal is to give a value to a word according to its calculation definition. For the example shown in FIG. 2, the predicate vectors associated to the calculation of the word ‘a’ and that of the word ‘b’ are as shown in FIG. 5. The detailed explanation on the steps of FIGS. 4 and 5 should cite the corresponding parts of the Patent Documents 1 to 6, and thus detailed description thereof will be omitted.

Once there is no evolution in the calculation of the words, the Lyee generated code tries to output the words which will be the next goal. The predicate vector having the goal to output values is called output vector. In the W02 pallet, we find two predicate vectors having a goal of associating values to input words. For the sake of simplicity, predicate vector dealing with inputs, outputs and the initialization of the memory will be omitted within other detailed description. Finally, in the W03 pallet, the goal of predicate vectors is to judge preconditions specified within requirements, as shown in FIG. 6. The detailed explanation on the steps of the drawing should cite the corresponding parts of the Patent Documents 1 to 6, and thus detailed description thereof will be omitted.

Finally, the Lyee program associated to the requirements given in Table 1 is as shown in Table 4.

(3) Process Route Diagram

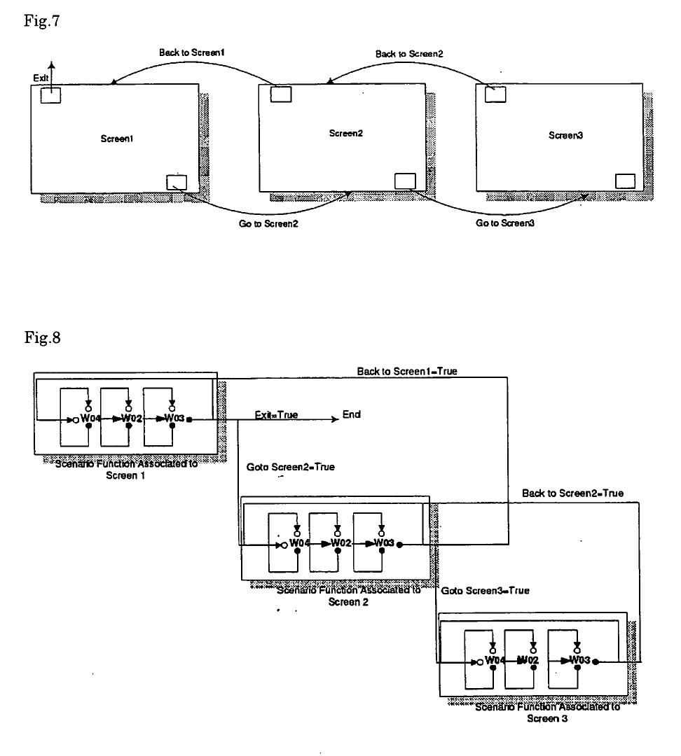

The Basic Structure, or a Scenario Function presented in the previous section can be a complete program for a simple case of given requirements and specially when all the input and output words belong to the same screen and there is no use of any database. However, if we need to input and output words that belong to databases or to different screens interconnected together, then the situation can be a little complicated. For the sake of simplicity, we deal, in the sequel, only with the case when we have many screens. For instance, suppose that we have three interconnected screens, as shown in FIG. 7 allowing a user to navigate from one to another and in each one of them he can input, compute and output plural words. Therefore, in the specification, the user has to give how these screens are interconnected.

TABLE 4

| Pallet | Program | Comments |
|---|---|---|
| W04 | Call S4 | Initialize memory |
| | Do | |
| | Call L4_a | Calculate a |
| | Call L4_b | Calculate b |
| | while a fixed point is not reached | |
| | Call O4 | Output the result |
| | Call R4 | Go to W02 |
| W02 | Do | |
| | Call L2_e | |
| | Call L4_c | |
| | while a fixed point is not reached | |
| | Call I2 | Input results |
| | Call R2 | Go to W03 |
| W03 | Do | |
| | Call L3_a | Calculate a_cond |
| | Call L3_b | Calculate b_cond |
| | while a fixed point is not reached | |
| | Call R3 | Go to W04 |

Furthermore, it is not convenient to define only one Basic Structure (scenario function) in order for us to compute all the words defined in all the screens. In fact, some screens may not be executed for a given execution of the program and then the computation of the value of their words will be a waste of time. For that reason, Lyee associates each screen to its responsible scenario function that will be executed only if this screen is executed. The scenario functions associated to screens are connected to each other showing when to move from one of them to another. In the Lyee terminology, many scenario functions connected together make up a Process Route Diagram as shown in FIG. 8.

To sum up, according to the Lyee methodology, generally a program contains many process route diagrams. Each of them is a set of interconnected scenario functions and each scenario function contains three interconnected pallets W02, W03 and W04.

(4) Drawback of the Lyee Methodology

In spite of the Lyee methodology simplicity and their several positive impacts on all the steps of the software development cycle, it has a room for improvement in terms of the volume of the generated code. In fact, to each word given within requirements, Lyee attributes several memory areas. For more details about the exact volume of the memory consumed, the aforementioned Nonpatent Documents 6 and 7 should be referred to.

In the rest of this paper, how static analysis techniques can help to produce Lyee programs that run faster, consume less memory space and enjoy other better qualities will be shown.

### BEST MODES FOR CARRYING OUT THE INVENTION

Hereinafter, referring to the drawings, the embodiments of the present invention directed to static analysis on Lyee requirements will be described.

Software static analysis (refer to the Nonpatent Documents 1 and 4) means generally the examination of the code of a program without running it. Experience has shown that many quality attributes of specifications and codes can be controlled and improved by static analysis techniques. Among others, static analysis techniques allow to make program run faster, consume less memory space and to find its bugs. Applied on requirements, static analysis allow also to find out logic errors and omissions before the code is generated and consequently they allow the user to save precious development and testing time.

The description is to pinpoint some static analysis techniques that could improve the qualities of the Lyee requirements and their generated codes.

The optimization of a program is generally introducing a series of modifications on it to reduce the size of its code, the time of its execution, the consumed memory, etc. Obviously, the optimization of a given code is the biggest objective, however the semantics of the initial program should not be modified in any case.

1. Classical Optimizations

In this section we give some classical optimization techniques (refer to the Nonpatent Documents 3 and 8) and the impact of their use on the memory consumption and the execution time of Lyee programs.

(1-1) Constant Propagation

This simple technique detects constants in the program, propagates the constant values along expressions using them, and finally removes these constants. For example, in the example of Table 1, in requirements before constant propagation, a constant 5 is given to a definition of a word a. In a definition of a word b, if the constant propagation is executed by substitution of a=5, the definition of the word b takes a constant 20 since a+3*5 is established. As a definition of a word d is e+b*a, if the constant propagation is executed by substitution of a=5 and b=20, its definition expression becomes e+100. As a result of such constant propagation, initial requirements become similar to those of “after constant propagation analysis” of Table 5. A statement whose definition is a constant is removed from the requirements as it is not necessary to generate any value.

TABLE 5

| Before Constant Propagation | | | | | After Constant Propagation | | | | |
|---|---|---|---|---|---|---|---|---|---|
| | | Condi- | | | | Defini- | Condi- | | |
| Word | Definition | tion | I/O | . . . | Word | tion | tion | I/O | . . . |
| a | 5 | | | . . . | d | e+100 | | | . . . |
| b | a+3*5 | | | . . . | e | | | IO | . . . |
| d | c+b*a | | | . . . | | | | | |
| e | | | IO | . . . | | | | | |

(1-2) Pattern Detection

A pattern is a sub-expression that is repeated many times in a program. This means that each sub-expression will be computed many times. Therefore, if patterns are present in requirements, we can generally reduce the execution time of their associated code by replacing each one of these patterns by a temporary variable in which the sub-expression will be computed only one time. Table 6 gives an example where the sub-expression b*c is a pattern.

TABLE 6

| Before Pattern Propagation | | | | | After Pattern Propagation | | | | |
|---|---|---|---|---|---|---|---|---|---|
| | | Condi- | | | | Defini- | Condi- | | |
| Word | Definition | tion | I/O | . . . | Word | tion | tion | I/O | . . . |
| a | b*c+5 | | | . . . | t | b*c | | | . . . |
| e | a+b*c+1 | | | . . . | a | t+5 | | | . . . |
| d | e+b*c | b+c>2 | | . . . | e | a+t+1 | | | . . . |
| | | | | | d | e+t | | | . . . |

Let us now discuss how the use of these simple and classical optimization techniques can improve the memory space consumption and the execution time of the Lyee generated codes. It is a well known fact that these optimization techniques are implemented in almost all available compilers. Furthermore, since Lyee generates generally a code in high level programming language such as COBOL, then one may conclude that once the Lyee high level code is generated, the compiler used to produce the low level code will do these optimizations. However a deep study of this problem shows that this conclusion is not totally true. In fact, the way used by Lyee to generate codes may complicate the task of the compiler when searching for these classical optimization.

To confirm that, we have written two programs in C programming language that implement simple requirements. We have given to one of these programs a structure similar to the one generated by the LyeeAll (registered trademark) tool and the second a usual structure. After a compilation, with optimization options, on the two programs we have discovered that within the program having a Lyee structure the compiler has not been able to apply the constant propagation technique, but that this optimization has been successfully done within the second program. We have concluded that within the Lyee methodology it is more beneficial and easier to use these optimization techniques before the code generation, i.e. once requirements are given by the user.

2. Basic Analysis of Lyee Requirement Static Analysis

In this section, we give some basic definitions that are very useful to simplify the explanation on most of static analysis techniques exposed in the description.

(2-1) Def/Use Analysis

(2-1-1) Informal Definition of Def/Use Analysis

Each statement s in a given Lyee requirements uses some words, either in definition expression or in condition expression, to define a new word. The set of words used in the definition expression or in condition expression are called Use(s) and the new defined word is called Def(s).

The Table 7 gives a concrete illustration of the Def/Use notions.

TABLE 7
Illustration of the Def/Use Notions.

| Statements | | | | | | | |
|---|---|---|---|---|---|---|---|
| Word | Definition | Condition | IO | Type | Security | Def | Use |
| e | | | IS | int | public | {e} | { } |
| b | 3 | e>0 | OS | int | public | {b} | {e} |
| c | 2*b | e>2 | OS | int | public | {c} | {b, e} |
| a | b+c | | OS | int | public | {a} | {b, c} |

(2-1-2) Formal Definition of Def/Use

Let s be a statement (wrd,Def,Cond, io, type, SecType) The Def of the statement s, denoted by Def(s), is simply wrd. Then, the Use of the statement s, denoted by Use(s), is defined as follows:

<Use of a statement>
Use(s) = Use (Def) ∪ Use(Cond)
<Use of an expression>
Use (val) = φ
Use(Id) = {Id}
Use(Op Exp) = Use(Exp)
Use(Exp₁ Op Exp₂) = Use(Exp₁) ∪ Use(Exp₂)

The definition given above can be read as follows:

1) Use of a Statement

Use(s)=Use(Def)∪Use(Cond): word (Use(s)) used for definition and conditions of the statement s is a sum-set of words (Use(Def)) used for definition and conditions of the definition and words (Use(Cond)) used for definition and conditions of the conditions. Since, the definition and the condition are both expression, then to complete the definition of Use of any statement, we need only to define Use of the expression. To that end, for each kind of expression we need to clarify its Use.

2) Use of Expression
Use(val)=0:

If the expression is a value “val” then its Use is empty. That is, there are no words used for the definition and the conditions.
Use(Id)={Id}:

If the expression is an identifier “Id”, then its Use is the identifier itself.
Use(Op Exp)=Use(Exp):
If the expression is “Op Exp” (a unary operator “Op” followed by an expression “Exp”), then its Use is equal to the use of the expression “Exp”.
Use(Exp₁ Op Exp₂)=Use(Exp₁)∪Use(Exp₂):

If the expression is “Exp₁ Op Exp₂”, then its Use is a sum-set of Use of the expression, “Exp₁” and Use of the expression₂ “Exp₂”.

(2-2) Direct and Indirect Use

As stated in the previous section, each statement s of the requirement may use some words defined by the word set Use(s). This word set is called the direct Use of the statement s. In fact, each word found in Use(s) is directly used in the statement s either in its definition expression or in its condition expression.

In addition to the words of direct Use, the statement s may use the other words indirectly. For instance, if the statement s directly use a word “a” and if the statement defining the word “a” use a word “b” , then we can say that the statement s uses indirectly the word “b” . Furthermore, if the statement defining the word b uses a word “c”, then we can say also that the statement s uses indirectly the word “c”.

Let us take a concrete example to clarify the notion of indirect Use in table 8.

TABLE 8
Illustration of the indirect Use Notions.

| Statements | | | | | | | | |
|---|---|---|---|---|---|---|---|---|
| | Defini- | Condi- | | | | | | Indirect |
| Word | tion | tion | IO | Type | Security | Def | Use | Use |
| e | | | IF | int | public | {e} | { } | { } |
| i | e | | | int | public | {i} | {e} | { } |
| b | i | i>0 | OS | int | public | {b} | {i} | {e} |
| c | 2*b | b>2 | OF | int | public | {c} | {b} | {e, i} |
| a | b | c>0 | OS | int | public | {a} | {b, c} | {e, i} |

In the example of the Table 8, as a word e is an input word, its Use (direct Use. Hereinafter, direct Use will be simply referred to as “Use”) is blank. Thus, indirect Use is also blank. For a word I, as the word e which is its Use is the input word and its definition and conditions are blank, indirect Use is blank. For a word b, as use of a word i which is its Use is a word, indirection Use is a word e. For a word c, as Use of the word b which is its Use is the word i, and its indirect Use is word e, indirect Use of the word c is a word e and a word i. For the word a, Use of the word b which is its Use is the word i, the indirect Use is the word e, and Use of the word c which is its another Use is the word b, and the indirect Use is the word e and the word i. Thus, indirect Use of the word a is the word e and the word i (not added to the direct Use, since word b is direct Use).

The following algorithm of the function UseDirectAndIndirect(s, S) allows to collect both the Use and the indirect Use of a given statement s in a given Lyee requirement S (a set of statements).

```
UseDirectAndIndirect(s: statement, S : set of statements)
    Var W_Old, W_New : set of words
  Begin
    W_Old [symbol] Use(s)
    W_New [symbol] W_Old
    Fix_Point [symbol] False
    While(Fix_Point = False)
      For all a ∈ Use(s) ∩ Word(S)
        W_New [symbol] W_New ∪ Use(Statement(a, S))
      EndFor
      If(W_New = W_Old)
        Then Fix_Point [symbol] True
        Else W_Old [symbol] W_New
        EndIf
    EndWhile
    return W_New
  End
```

The algorithm of the aforementioned function UseDirectAndIndirect (s, S) has the following meaning. S is a statement, and S is a set of statements which are requirements. A variable W_Old and a variable W_New are sets of words.

```
<Begin>
Record Use(s) [word (group) which is direct Use of statement
s] in the variable W_Old.
Record a value of the variable W_Old in the variable W_Old.
Record a value False in a variable Fix_Point.
  <Start of While sentence> Execute the following while the
value of the variable Fix_Point is False.
  <Start of For sentence> Execute the following for all the
words a in the case of Use of statement s belonging to a
requirement S.
  Record a word (group) recorded in the variable W_New and a
word (group) which is Use of statement of the word a, in the
variable W_New.
  <End of For sentence>
  <Start of If sentence> If a value of the variable W_New is
equal to the value of the variable W_Old,
  record a value True in the variable Fix_Point.
  If not, record the value of the variable W_New in the
variable W_Old.
  <End of If sentence>
  <End of While>
<End>
```

Notice that the function Statement (a, S) is a function that returns the statement that defines the word a in the Lyee requirements S. That is, it retunes statement sₐ ∈ S (statement sₐ of the word a included in the requirement S) in which Def(sₐ)={a} (Def of the statement sₐ of the word a indicates that it is a word a) is true.

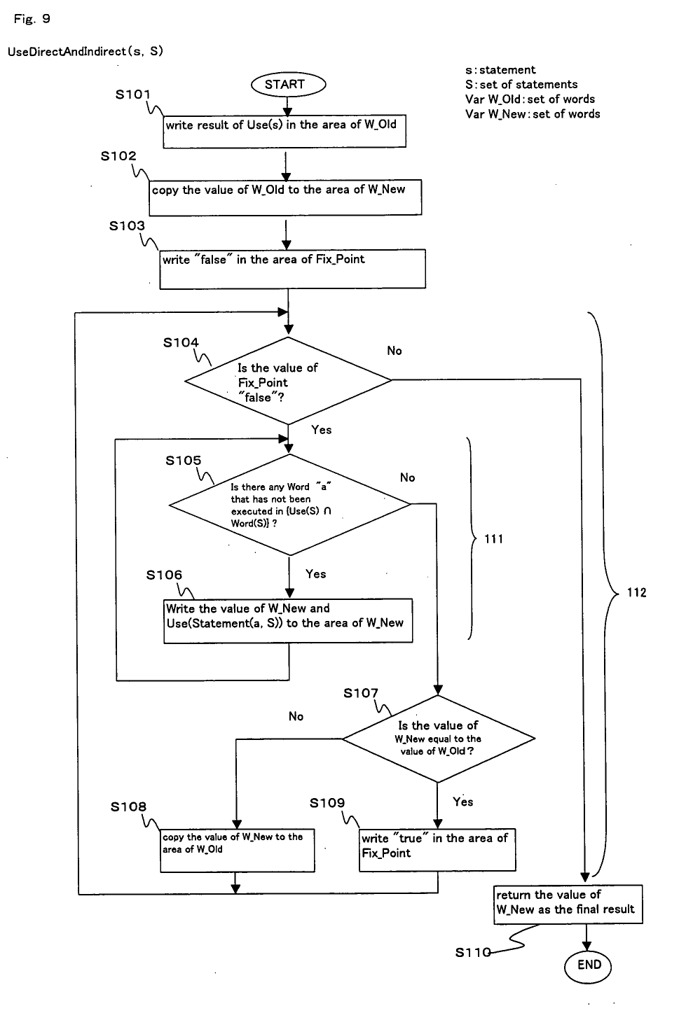

FIG. 9 is a flowchart showing the algorithm of the function UseDirectAndIndirect (s, S). Processing steps of FIG. 9 will be sequentially described in the followings. A result of Use(s) [word (group) which is direct Use of statement s] is recorded in an area of the variable W_Old (step 101), and a value of the W_Old is copied to an area of the variable W_New (step 102). Next, “False” is recorded in the area Fix_Point (step 103).

If condition determination of step 104 shows that the value of the Fix_Point is false, the process proceeds to step 105.

In the step 105, in determination as to “whether there is a word a unprocessed in step 106 or not in a set of words which is a sum of a result of Use(s) and a result of Word(S) [words of all statements of Use of statement s and all statements of requirement S]”, if the result is true, the process proceeds to step 106. In the step 106, a value of the variable W_New and a value of Use (Statement (a, S)) [Use of statement of word a] is recorded in the area of the variable W_New.

After an end of the step 106, the process returns to the step 105 to execute the determination again. As long as the determination result of the step 105 is true, first restart processing (111) of the steps 105 and 106 is repeated.

When the result becomes false in the determination of the step 105, that is, when there are no more unprocessed words in the set of words which is the sum of the result of Use(s) and the result of Word(S) [words of Use of statement s and all the statements of the requirement S], the process proceeds to step 107. In determination of the step 107 as to “whether the value of the variable W_New is equal to that of the variable W_Old or not”, if a result is a false, the process proceeds to step 108 to copy the value of the variable W_New to the area of the variable W_Old. If the result is true, the process proceeds to step 109 to record truth in the area Fix_Point. After an end of the step 108 or 109, the process returns to the step 104 to execute the determination again. As long as the determination result of the step 104 is true, second start processing (112) from the step 104 to the step 109 is repeated.

When the value of the Fix_Point becomes true and the determination result of the step 104 becomes false, the process proceeds from the step 104 to step 110 to return the value of the variable W_New as a result of the function UseDirectAndIndirect (s, S).

3. Debugging Requirements

(3-1) Dead Statements

A statement is considered dead if it will never be executed. Dead statement could be due to many causes. One of the most known causes is the presence of contradictory preconditions within statements. In fact, if the precondition associated to a given statement is always false, then this statement cannot have a meaning and consequently the predicate vectors associated to it will never be completely executed. This fact generally originates in a specification error and has to be communicated to the user. To detect this kind of dead code, we have only to analyze preconditions associated to statements. If it is possible to statically prove that the preconditions associated to a given statement is always false (notice that it is not necessary to have the value of all the words used in a condition in order to evaluate it. IN other words, if the condition Φ [symbol] Φ is always false independently from the value of Φ), then this statement is dead. Furthermore, all the other statements that use a dead statements are consequently dead. Put formally, if a statement s is dead, then each statement s′ in which s′ [symbol] s is true is also dead. ( [symbol] indicates that a word of the statement in the left side is included in Use of the statement in the right side).

(3-2) Cyclic Statements

(3-2-1) Informal Definition of Cyclic Statement

A statement is said to be cyclic if the director indirect definition of a word involved in the statement includes the word itself. In other words, it can be said so if, to define a given word “a”, we need the word “a”. Hereafter, we give some concrete examples.

The example shown in Table 9 gives an example of a direct cycle since the word “a” is defined using itself.

TABLE 9
Cyclic Statement: word “a”

| Word | Definition | Condition | IO | Type | Security |
|---|---|---|---|---|---|
| i | | | IF | int | secret |
| a | a*i | i≠0 | OF | int | secret |

Let us give an example of indirect cycle. In the Table 10, the definition of the word “a” requires, among others, the definition of the word “b”. However, the definition of the word “b” requires the definition of the word “a”. It follows, the word “a” and the word “b” fall into therefore, an indirect cycle.

TABLE 10
Cyclic Statement: word “a”, word “b”.

| Word | Definition | Condition | IO | Type | Security |
|---|---|---|---|---|---|
| i | | | IS | int | public |
| a | b+i | | OS | int | public |
| b | 2*a | | OS | int | public |

(3-2-2) Formal Definition of Cyclic Statement

Hereinafter, a formal definition of the cyclic statement will be described. Let S be a set of statements. When the following conditions are satisfied, a statement s ∈ S (statement s belonging to the requirement S) is cyclic.
Def(s)∈UseDirectAndIndirect(s, S)
That is, Def(s)∈UsedirectAndIndirect(s, S) formally indicates that “Def of a statement s is included in direct and indirect Use of the statement s belonging to the requirement S”.

The algorithm of the following function CyclicStatements(S) allows us to detect cyclic statement in any given Lyee requirement S.

```
CyclicStatements(S: set of statements)
  Var CyclicSet: set of statements
  Begin
    CyclicSet [symbol] ∅
    For all s ∈ S do
      If( Def(s) ∈ UseDirectAndIndirect(s))
        Then CyclicSet [symbol] CyclicSet ∪ {s}
      EndIf
    EndFor
    return CyclicSet
  End
```

The algorithm of the aforementioned CyclicStatements(S) has the following meaning.

S is a set of statements which are requirements. A variable CyclicSet is a set of statements.

```
<START>
Record “0” in the variable CyclicSet.
  <Start of For sentence> Execute the followings for all the
statements s belonging to the set S of statements.
  <Start of If sentence> If Def(s) [word of statement s] is
included in Use DirectAndIndirect(s) [direct and indirect Use
of statements s],
record a value of the variable CyclicSet and {s} [statement
s] in the variable CyclicSet.
  <End of If sentence>
  <End of For sentence>
  Return the value of the variable CyclicSet.
<End>
```

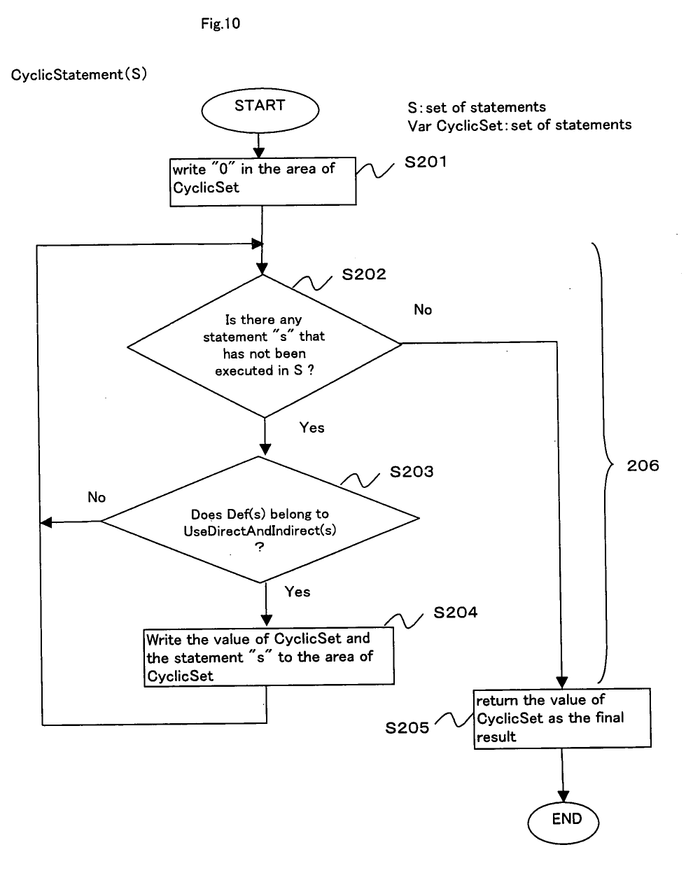

FIG. 10 is a flowchart showing the algorithm of the function CylicStatements (S). Processing steps of FIG. 10 will be sequentially described in the followings. First, “0” is recorded in an area of the variable CyclicSet (step 201), and determination is made as to “whether there is a statement s unprocessed in step 202 or not in a set S of statements” (step 202). If the determination is truth, determination is made as to “whether Def(s) [word of statement s] belongs to UseDirectAndIndirect(s) (direct and indirect Use of statement s] or not” (step 203). If the determination shows truth, a value of the CyclySet and the statement s are recorded in the variable CyclicSet (step 204), and the process returns to the step 202. If the determination of the step 203 is False, the process directly returns to the step 202 to make determination again. As long as the determination result of the step 202 is true, restart processing (206) of the steps 202 to 204 is repeated.

When the result becomes false in the determination of the step 202, the process proceeds to step 205 to return a value (set of statements) of the variable CyclicSet as a result of the function CtyclicStatement.

It is worthwhile to mention that the verification of cyclic statement have to be the first static analysis applied onto a statement. Therefore, in the description, the static analysis presented in the followings suppose that the analyzed is not cyclic.

(3-3) Incomplete Statements

(3-3-1) Informal Definition of Incomplete Statement

A set of statements S (Lyee requirement) is said to be incomplete if it contains at least one statement s that uses one or more words that have not been directly or indirectly defined in S. The previous definition capture the following principle: all used words have to be defined.

The Table 11 gives a concrete example of incomplete statement. In fact, the word “a” uses the word “i”, however the word “i” is not yet defined.

TABLE 11
Incomplete Statement.

| Word | Definition | Condition | IO | Type | Security |
|---|---|---|---|---|---|
| a | i+1 | | OS | int | public |
| b | 2*a | | OS | int | public |

For easier explanation of the notion of incomplete statements, we need first to introduce the following notations: Defined(S):

Suppose there is a set S (requirement S) of a given statement, the function Defined(S) returns the set of words already defined in S. More formally, it is represented as follows.

$$Defined ( S ) = {⋃}_{s ∈ S} Def ( s )$$

In the foregoing, the function Defined (S) indicates “whole set of words which are a result of Def of all the statements s belonging to the requirements S”. However, a defined state means that there exists a statement of the word, but it does not necessarily mean that necessary information for all the items of the statements have been satisfied. For example, even in the case of an output word, a definition expression or a condition expression may not have been defined. Such a statement becomes Use(s)={}. Incomplete statements include a statement of a word which has been defined but whose definition expression and condition expressions is undefined, and not an input.

Definition of an incomplete statement will be described by referring to the diagram below.

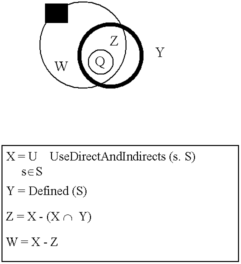

X is a set of words which [symbol] direct and indirect Use of all the statements s of the requirement S. Y is a set of words defined in the requirement S. Z is a product set of X and Y, i.e., a set of words used in a certain statement of the requirement S and already defined. W is a set of words undefined in the requirement S among words used in the statement of the requirement S. Q is a word which is not an input and whose definition and condition expressions are undefined in the Z, “set of words used in a certain statement of the requirement S and already undefined”.

Thus, an incomplete statement is a sum of a statement of W, “set of words undefined in the requirement S among words used in the statement of the requirement S”, and a statement of the set Q of words which are not input and whose definition and condition expressions are undefined in Z, “set of words used in a certain statement of the requirement S and already defined”.

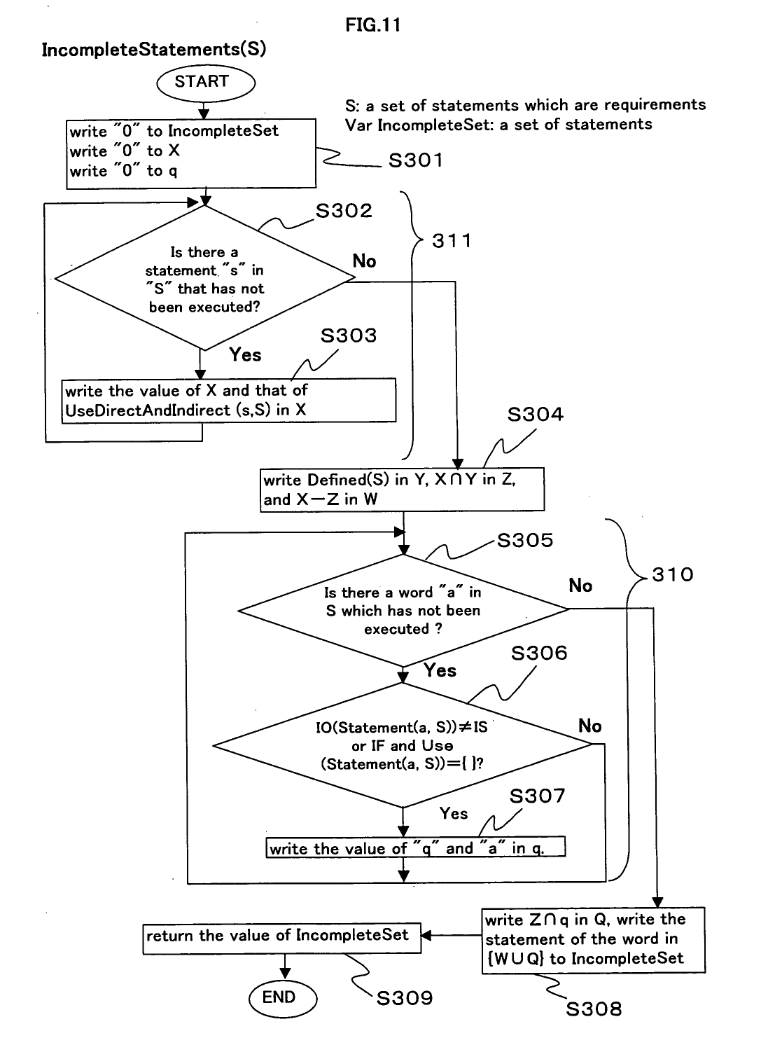

FIG. 11 is a flowchart showing processing of extracting an incomplete statement. First, values “0” are recorded in variables IncompleteSet, X and q (step 301). Next, in step 302, determination is made as to “whether there is a statements unprocessed in step 303 or not in the requirement S”. If a result of the determination is true, the process proceeds to the step 303 to record value of the variable X and the value of UseDirectAndeIndirect (s, S) in the variable X. After an end of the step 303, the process returns to the step 302 to execute the determination again. As long as the determination result of the step 302 is true, first restart processing (311) of the steps 302 to 303 is repeated.

When the result becomes false in the determination of the step 302, the process proceeds to step 304 to record a result of a function Defined(S) [return a set of defined words in the requirement S] in the variable Y, X ∩ Y [a set of words used in the statements of the requirement S and defined in the requirement S] in the variable Z, and X−Z [a set of words obtained by subtracting a set of words Z from a set of words used in the statements of the requirement S, i.e., a set of words used in the statements of the requirement S but undefined in the requirement S] in the variable W.

Next, in step 305, determination is made as to “whether there is a word a unprocessed in step 306 or not in the requirement S”. If a result of the determination is true, in the statement 306, determination is made as to “whether IO (Statement (a, S))≠IS or IF [word a is not an input], and Use (Statement (a, S))={}[direct Use of a statement of the word a is blank, i.e., definition and condition expressions of the word a are undefined] or not”. If a result of the determination is true, a value of the variable q and the word a are recorded in the variable q in step 307, and the process returns to step 305 to execute determination again. As long as the determination of the step 305 is true, second start processing (310) from the step 305 to the step 307 is repeated.

When the determination result of the step 305 becomes false, the process proceeds to step 308 to record a value of Z ∩ q [word (=Z) used in the statement of the requirement S and defined and word (=q) which is not an input and whose definition and condition expressions are undefined] in the variable Q, and write statements of all the words of W ∪ Q [words (=W) used in the statements of the requirement S but undefined, and the words of the Q] in the variable IncompleteSet. Lastly, as an incomplete statement in the requirement S, the value of the variable IncompletSet is returned (step 309) to finish the processing.

(3-4) Superfluous Statements

(3-4-1) Informal Definition of Superfluous Statement

A statement s is considered as superfluous in a given Lyee requirement S, if the statement S does not contribute directly or indirectly in the definition of any output word of S. This definition capture the following principle: each defined word has to be used. The word “used” means “contribute directly of indirectly in the definition of an output word”. The superfluous definition together with incomplete definition capture the following principle: All that are defined have to be used and all that are used have to be defined.

The Table 12 gives a concrete example of superfluous statements. In this case, the word “j” does not contribute directly or indirectly in the definition of any output word. Therefore, the word “j” can be removed form the requirement without yielding any negative effect on the execution of the program.

TABLE 12
Superfluous Statements.

| Word | Definition | Condition | IO | Type | Security |
|---|---|---|---|---|---|
| i | | | IS | int | public |
| J | 2*i | | | int | public |
| a | i+1 | | OS | int | public |
| b | 2*a | | OS | int | public |

To formally define the notion of superfluous statement, we need to introduce the following notions:
OutputStatements(s):
Suppose there is given a set of statement S, the function OutputStatements(S) returns the statements in S which have OS or OF as input/output attributes. It is formally defined as follows.
OutputStatements(S)={s∈S|IO(s)=OS or IO(s)=OF}
The above formal representation means that a result of the S function OutputStatements(S) is “a statement s belonging to a set S of statements, in which a value of its IO (input/output attributes) is an OS (output onto the screen) or OF (output to the file)”.

The algorithm of the following function OutputStatements(S) allows to deduce statement OutputStatements from a given Lyee requirement S whose input/output attributes are outputs (OS or OF).

```
OutputStatements(S: set of statements)
  Var OutputSet set of statements
  Begin
    OutputSet [symbol] ∅
    For all s ∈ S do
      If(IO(s) = ”OS” or IO(s) = ”OF”)
        Then OutputSet [symbol] OutputSet ∪ {s}
      EndIf
    EndFor
    return OutputSet
  End
```

The algorithm of the aforementioned function OutputStatements (S) has the following meaning.

S is a set of statements which are requirements. A variable OutputSet is a set of statements.

```
<START>
Record “0” in an area of the variable OutputSet.
  <Start of For sentence> Execute the followings for all the
statements s belonging to the set S of statements.
  <Start of If sentence> If IO [input/output attributes] of
statements s are OS [outputs to the screen] or OF [outputs to
the file OF],
record a value of the variable OutputSet and the statements s
in an area of the variable OutputSet.
  <End of If sentence>
  <End of For sentence>
```

As a result of the function OutputStatements (S), return a value of OutputSet (set of statements).

By the aforementioned definition, it is easy to formally define superfluous statements as shown in a next section

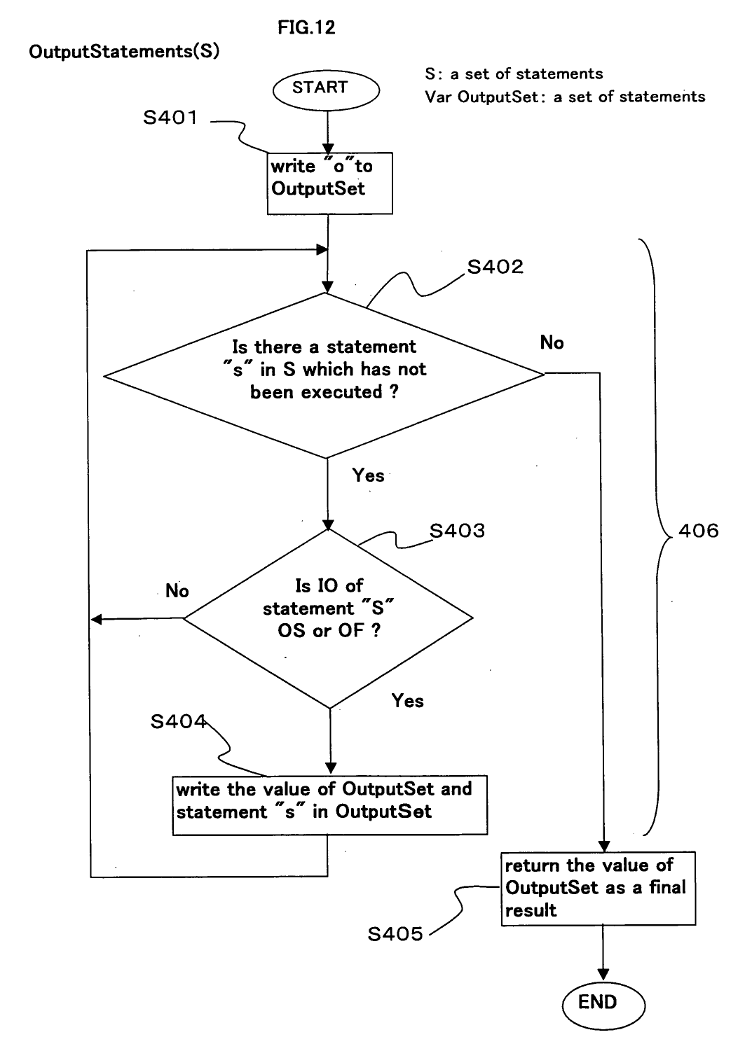

FIG. 12 is a flowchart showing the algorithm of the function OutputStatements (S). Processing steps of FIG. 12 are as follows. First, “0” is recorded in an area of the variable OutputSet (step 401). Next, in step 402, determination is made as to “whether there is a statement s unprocessed in step 403 or not in the set S of statements”. If a result of the determination of the step 402 is true, the process proceeds to the step 403 to determine “whether IO [input/output attribute] of the statement s is OS [an output onto the screen] or OF [an output to the file]”. If a result of the determination of the step 403 is true, the value of the variable OutputSet and the statement s are recorded in the area of the variable OutputSet, and the process returns to the step 402. If the result of the determination of the step 403 is false, the process directly returns to the step 402 to execute the determination again. As long as the determination result of the step 402 is true, restart processing (406) of the steps 402 to 404 is repeated.

When the result becomes false in the step 402, as a result of the function OutputStatement, a value (set of statements) of the OutputSet is returned.

(3-4-2) Formal Definition of Superfluous Statements

Formal definition of superfluous statements is now described. Let S be a set of statements. The superfluous statements in S, denoted by SuperfluousStatements(S), are formally defined as follows:

$$SuperfluousStatements ( S ) = S - ( {⋃}_{s ∈ OutputStatemen ts ( S )} ( {⋃}_{a ∈ UseDirectAndIndirect ( a , S )} Satement ( a , S ) ) )$$

The aforementioned formal representation means that a result of the function SuperfluousStatements (S) is “a set of words obtained by subtracting a set of statements of all the words belonging to direct and indirect Use of all the statements s of S, i.e. a set of statements which are statements of output words of S, from the set S of statements”.

The following function SuperfluousStatements(S) algorithm allows to deduce superfluous statements in a given Lyee requirement S.

```
SuperfluousStatements(S: set of statements)
  Var SuperfluousStatSet, ImportantStatSet, OutputStatSet:
                    set of statements
  Begin
    OutputStatSet [symbol] OutputStatements(S)
    ImportantStatSet [symbol] ∅
    For all s ∈ OutputStatSet do
      For all a ∈ UseDirectAndIndirect(s, S) do
        ImportantStatSet [symbol] ImportantStatSet ∪ {Satement(a, S)}
      EndFor
    EndFor
    SuperfluousStatSet [symbol] S - ImportantStatSet
    return SuperfluousStatSet
  End
```

The algorithm of the aforementioned function SuperfluousStatements (S) has the following meaning. S is a set of statements which are requirements. Variables SuperfluousStatSet, InmportantStatSet, and OutputStatSet are sets of statements.

```
<Begin>
Record a result of the function OutputStatements (S) [all
output statements belonging to the requirement S] in an area
of the variable OutputstatSet.
Record “0” in the variable ImportantStateSet.
  <Start of For sentence> Execute the followings for all the
statements s belonging to the OutputStatSet.
  <Start of For sentence> Execute the followings for all the
words a belonging to the UseDirectAndIndirect (s, S) [direct
and indirect Use of statement s in the requirement S].
Record a value of the variable ImpoartantStatSet and the
statement of the word a in an area of the variable
ImportantStatSet.
  <End of For sentence>
  <End of For sentence>
    Record a set of statements obtained by subtracting
the value of the variable ImportantStatSet from the
requirement S in the area of the variable SuperfluousSet.
As a result, return a value of the variable SuperfluousSet.
<End>
```

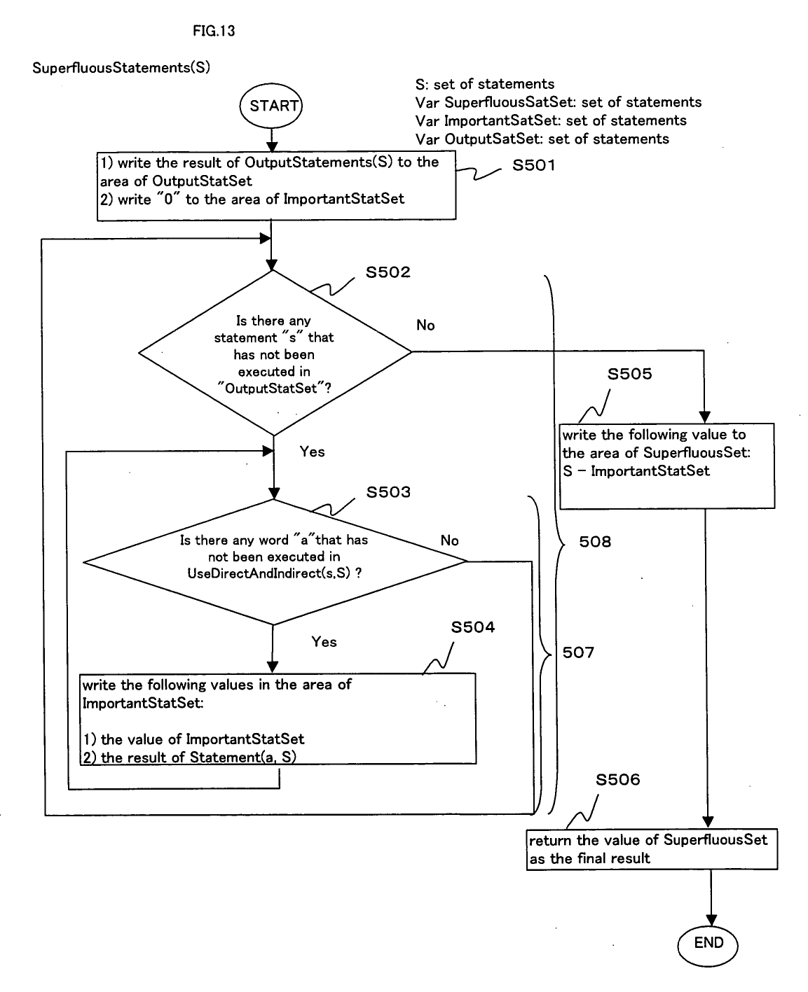

FIG. 13 is a flowchart showing the algorithm of the function SuperfluousStatements (S). Processing steps of FIG. 13 are as follows. First, a result of the function OutputStatements (S) [all output statements belonging to the requirement S] is recorded in the area of the variable OutputStatSet, and “0” is recorded in an area of the variable ImportantStatSet (step 501). Next, determination is made as to “whether there is a statement s unprocessed in step 503 or not in the variable OutputStatSet” (step 502). If a result of the step 502 is true, determination of the step 503 is made as to “whether there is a word a unprocessed in step 504 or not in the UseDirectAndIndirect (s, S) [direct and indirect Use of statement s]. If a result of the step 503 is true, the process proceeds to the step 504 to record the value of the variable ImportantStatSet and the result of the Statement (a, S) [statements of the word a] in the area of the variable ImportantStatSet. After the end of the step 504, the process returns to the step 503 to execute the determination again. As long as the determination result of the step 503 is true, the first restart processing of the steps 503 to 504 is repeated.

When the result becomes false in the step 503, the process returns to step 502 to execute again. As long as the result of step 503 is false, the second restart processing of the step 502 to the step 504 is repeated.

When the result becomes false in the step 503, the process proceeds to step 505 to record a set of statements obtained by subtracting the value of the variable ImportantStatSet from the requirement S in the area of the variable SuperfluousSet. In step 506, as a result of the function SupefluousStatements (S), a value of the variable SupefluousStatSet is returned.

4. Optimal Ordering of Statement Sequence

(4-1) Optimization by Ordering Predicate Vectors

As stated before, within the Lyee methodology the order in which the user enters the statements of his requirements has no effect on the semantics (the result of the execution) of the program associated to them. This fact is one of the big contributions of this methodology. Nevertheless, the order in which we create the predicate vectors associated to these statements may have a considerable impact on the efficiency (execution time) of the generated code. This issue will be further explained with a concrete example. Suppose that we have the requirements given in Table 13.

TABLE13

| Word | Definition | Condition | Input/Output | . . . |
|---|---|---|---|---|
| a | b + c + d | | output | . . . |
| b | d * c | | | . . . |
| c | d + 3 | | | . . . |
| D | 5 | | | . . . |

Suppose also that the generated predicate vectors of the W04 pallet associated to these requirements are ordered as shown in Table 14(a). (E.g., L4a is a predicate vector of the word a).

TABLE 14

| Pallet | Program | Pallet | Program |
|---|---|---|---|
| W04 | Call S4 | W04 | Call S4 |
| | Do | | Do |
| | Call L4_a | | Call L4_d |
| | Call L4_b | | Call L4_c |
| | Call L4_c | | Call L4_b |
| | Call L4_d | | Call L4_a |
| | while a fixed point is not | | while a fixed point is not |
| | reached | | reached |
| | Call O4 | | Call O4 |
| | Call R4 | | Call R4 |

| | |
|---|---|
| (a) Not-Sorted Predicate Vectors | (b) Sorted Predicate Vectors |

The execution time required by this program of (a) of the Table 14 is now briefly discussed. Once the initialization vector (S4) is executed, the program attempts, in the first iteration, to give a value to the word ‘a’. This attempt will fail since the calculation of the word ‘a’ depends on the word ‘b’ which has not yet been calculated. Therefore, in this first iteration, except the word ‘d’, the attempt of giving a value to any word will be unsuccessful. In the second iteration, the program will succeed to attribute a value to the word ‘c’. In the third iteration, the value of the word ‘b’ will be calculated and finally in the fourth iteration the value of the word ‘a’ will be found. To sum up, this program needs 4 iterations to calculate all the words.

However, if we replace the program given in Table 14 (a) by the one given in Table 14(b), the number of the iterations needed to attribute values to all the words will drastically decrease. In fact, in only a single iteration, the program will succeed to calculate all the specified words. Hence, we conclude that the execution order in which the predicate vectors are executed have a deep effect on the program execution time. Consequently, it will be beneficial to order the tool which generates code form Lyee requirements (e.g., LyeeAll) to arrange the predicate vectors to reduce the execution time. Fortunately, the best arrangement of the predicate vectors can be automatically and statically generated. That is, the statements sequence of the Lyee requirements is rearranged to an optimal order.

(4-2) Informal Definition of Optimal Ordering

In the following, the meaning of optimally-ordered statement sequence is informally defined. A sequence of statements S is considered as optimally-ordered if the definition of each word appears before its use in the statement sequence S. The condition of statements leads to that a statement defining a given word has to appear, in the sequence S, before all the statements that use the statement.

The Table 15 gives a concrete example of not-ordered statements.

TABLE 15
Not Ordered Statements.

| Word | Definition | Condition | IO | Type | Security |
|---|---|---|---|---|---|
| b | 2*a +j | | OS | int | public |
| j | 2*i | | | int | public |
| i | | | IS | int | public |
| a | i+1 | | OS | int | public |

On the other hand, the Table 16 shows the statement sequence after they are ordered.

TABLE 16
Ordered Statements.

| Word | Definition | Condition | IO | Type | Security |
|---|---|---|---|---|---|
| i | | | IS | int | public |
| j | 2 * i | | | int | public |
| a | i + 1 | | OS | int | public |
| b | 2 * a + j | | OS | int | public |

To formally define the ordering concept, we need to introduce the following notions:

1) First: given a sequence of statements <s₁ . . . , sₙ>, the function First returns s₁, the first element of this sequence.

2) AddFirst: given a sequence of statements <s₁ . . . , sₙ> and a statement s₀, the function AddFirst returns <s₀, s₁ . . . , sₙ>, i.e., it adds s₀ in the beginning of the sequence.

3) Remove: given a sequence of statements S and a statement s, the function Remove allows to remove from S the statement that is equal to s (on the assumption that S does not contain the same statement many times).

4) Lower: given two statements s and s′, it leads to that Lower(s, s′) is true, if Def(s) ∈ Use(s′). The algorithm of the following function Lower(s, s′) captures this Lower definition.

```
Lower(s, s′: statement)
  Begin
    If Def(s) ∈ Use(s′)
    Then return true
    Else return false
    EndIf
  End
```

The algorithm of the aforementioned function Lower (s, s′) has the following meaning.

```
<Begin>
  <Start of If sentence> If Def(S) [word of statement s]
belongs to Use(s′) [Use of statement s′], return true.
    If not, return false.
  <End of If sentence>
<End>
```

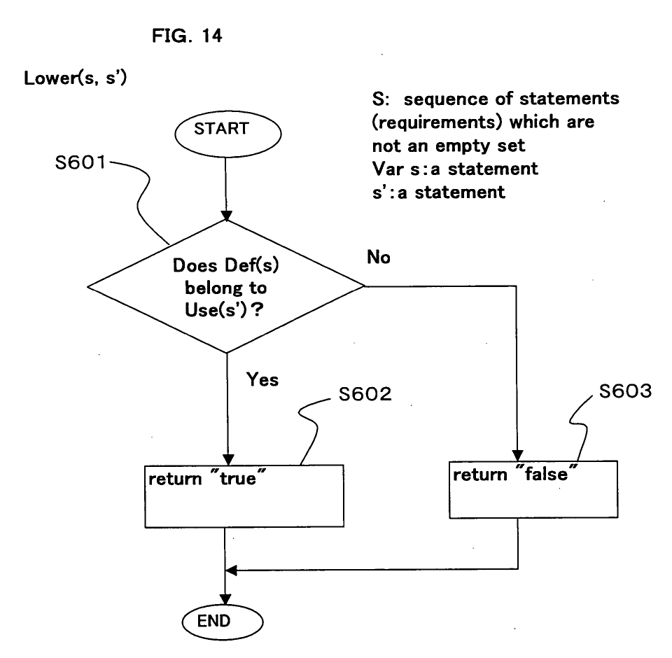

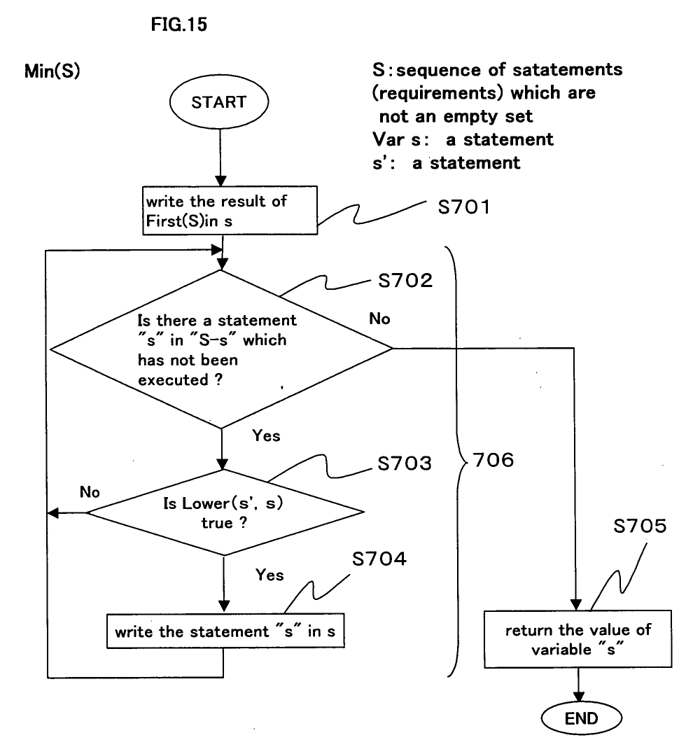

FIG. 14 shows a flowchart of the algorithm of the function Lower (s, s′). Processing steps of FIG. 14 are as follows. First, in step 601, determination is made as to “whether Def(s) [word of statement s] belongs to Use(s′) [Use of statement s′]”. If a result of the determination is true, “true” is returned as a result of the function (step 602). If the result of the determination is false, “false” is returned as a result of the function (step 603).

5) Min: given a sequence of statement S, the function Min returns a statement s which is a statement in S and which does not have another statement s′ in which Lower(s′, s) is true. The algorithm of the following function Min(S) captures this definition.

```
Min(S: not empty sequence of statements)
  Var s: a statement
  Begin
    s [symbol] First(S)
    For all s′ ∈ S - {s} do
      If Lower(s′,s)
      Then s [symbol] s′
      EndIf
    EndFor
    return s
  End
```

The algorithm of the aforementioned function Min(S) has the following meaning.

S is a statement sequence string which is not an empty set. A variable s is one statement.

```
<Begin>
  Record a result of a function FIRST (S) [return first
statement of the statement sequence] in the variable s.
  <Start of For sentence> Execute the followings for all the
statements s′ belonging to a statement sequence obtained by
subtracting a value (statement) of the variable s from the
statement sequence S.
  <Start of If sentence> If the function Lower (s′, s) is true
[word of statement s′ is used for defining statement of the
variable s], record the statement s′ in the variable s.
  <End of If sentence>
  <End of For sentence>
  Return the value of the variable s.
<End>
```

FIG. 15 is a flowchart showing the algorithm of the function Min (S). Processing steps of FIG. 15 will be sequentially described. First, a result of the function First (S) [return first statement of the statement sequence] is recorded in variable s (step 701). Next, in step 702, determination is made as to “whether there is a statement s′ unprocessed in step 703 or not in a statement sequence obtained by subtracting a value (statement) of the variable s from the statement sequence S”. If the determination result is truth, the process proceeds to the step 703 to determine “whether the function Lower (s′, s) is true [word of statement s′ is used or not for defining the statement of the variable s])”. If the determination result is truth, the statement s′ is recorded in the variable s (step 704), and the process returns to the step 702. If the result of the step 703 is False, the process directly returns to the step 702. As long as the result of the step 702 is true, restart processing (706) of the steps 702 to 704 is repeated.

When the result of the step 702 becomes false, the process proceeds to step 705 to return a value of the variable s as a result of the function Min (S).

By the aforementioned definition, it is easy to formally define an optimal ordering of a statement sequence.

(4-3) Formal Definition of Optimal Ordering

Optimal ordering of the statement sequence will be formally defined. Let S be a sequence of statements. A permutation of the ordered statement sequence belonging to S denoted by StatementOrdering(S), is formally defined as follows:

$$StatementOrdering ( S ) = \{ \begin{matrix} <> if S = <> \\ AddFirst ( Min ( S ) , StatementOrdering ( Remove ( S , Min ( S ) ) ) )\end{matrix}$$

The above formal definition means that a result of the function StatemetnsOrdering(S) is “blank if the sequence S of the statements is blank, and that a result of the function is a result of AddFirst(Min(S), Statementordering(Remove(S, Min(S)))) if not. The meaning of AddFirst(Min(S), StatementOrdering(Remove(S, Min(S)))) will be described in detail later in explanation on the flowchart of the function StatementsOrdering(S) (described later).

The algorithm of the following function StatementsOrdering(S) allows to optimally order a sequence of statements S.

```
StatementOrdering(S: sequence of statements)
  Var min: a statement
  Begin
    If S = ∅
    Then return < >
    Else min [symbol] Min(S)
      return AddFirst(min, StatementOrdering(Remove(S, min)))
    EndIf
  End
```

The algorithm of the aforementioned function StatementsOrdering (S) has the following meaning. S is a statement sequence. A variable min is one statement.

```
<Begin>
  <Start of If sentence> If the statement sequence S is an
empty set, return blank.
If not, record a statement of a result of the Min (S) [return
statement which is not using any other statements in its
definition in the statement sequence S] in the variable min,
and return a value of the function AddFirst (min,
StatementOrdering (Remove (S, min))).
  <End of If sentence>
  <End>
```

The function AddFirst (min, StatementOrdering (Remove (S, min))) will be described in detail with reference to the flowchart below.

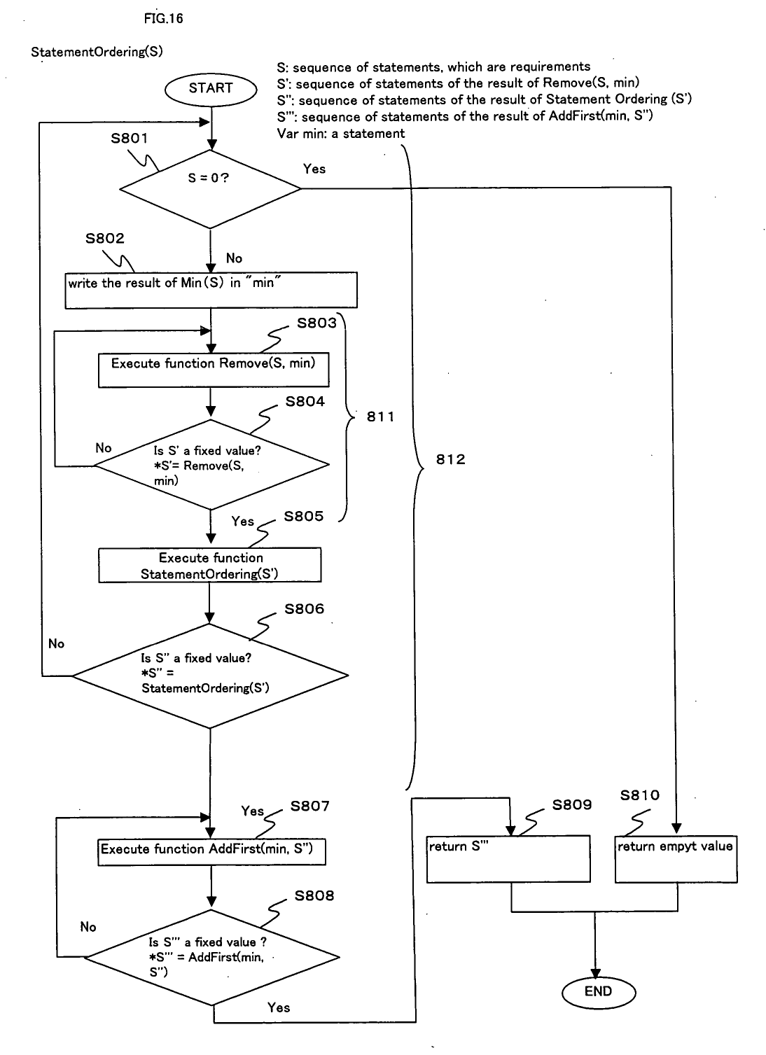

FIG. 16 is a flowchart showing the algorithm of the function Statemetsordering (S). Processing steps of FIG. 16 are as follows. First, in step 801, determination is made as to “whether the statement sequence S of the requirements is an empty set or not”. If a result of the determination is true, blank is returned as a result of the function StatementsOrdering (S) to finish the processing.

If the result of the determinantion of the step 801 is false, the process proceeds to step 802 to record a result of the function Min(S) [return statement which is not using any other statements in its definition in the statement sequence S] in the area of the variable min, and the process proceeds to step 803. In the step 803, the function Remove (S, min) [remove statement of the value of the variable min from the statement sequence S] is executed, and the process proceeds to step 804. In the step 804, determination is made as to “whether S′ which is a result of the function Remove (S, min) is a fixed value or not”. If a result of the determination is false, the process returns to the step 803 to execute the determination again. As long as the determination result of the step 804 is false, first restart processing (811) of the steps 803 to 804 is repeated.

When the determination result of the step 804 becomes true, the process proceeds to step 805. In the step 805, the function StatementOrdering (S′) is executed, and the process proceeds to step 806. In the step 806, determination is made as to “whether a result S″ of the function StatementOrdering (S′) is a fixed value or not”. If a result of the determination is false, the process returns to the step 801 to execute the step 801 again. As long as the result of the step 806 is false, the second restart processing (812) of the steps 801 to 806 is repeated.

When the result of the step 806 becomes true, the process proceeds to step 807 to execute the function AddFirst (min, S″), and the process proceeds to step 808. In the step 808, determination is made as to “whether a result S″′ of the function AddFirst (min, S″) has reached a fixed value or not”. If the determination result is false, the process returns to the step 807 to execute the determination again. As long as the result of the step 808 is false, third restart processing (813) of the steps 807 to 808 is repeated.

When the determination result of the step 808 becomes true, the process proceeds to step 809 to return a value of the statement sequence S″′ as a result of the function StatementOrdering (S), thereby finishing the function processing.

5. Slicing

Program slicing technique goes back to the Nonpatent document 12. It is considered as an extraction of a program that reduce the program to statements that are relevant to a particular computation. Within the traditional programming languages, slicing has long been used as a ‘divide and conquer’ approach to program comprehension and debugging (smaller program groups, i.e. slices, are better understood than a large one). It has also been successfully used to analyze many applications with respect to various goals including: measuring cohesion, algorithmic debugging, reverse engineering, component re-use, automatic parallelization, program integration, and assisted verification.

Within the Lyee requirements, slicing can be helpful to analyze requirements from a different perspective. Amongst others, slicing allows us to execute analysis from the following viewpoints.

1. What are the statements that contribute directly or indirectly to the definition of a given word?

2. What are the independent parts of requirements that may generate subprogram groups that can be made to run in parallel?

Having an automatic tool help us to execute the analysis from the first viewpoint is very useful to understand and maintain Lyee software (requirements). In fact, when the number of statements given in the requirement is huge (hundreds of lines), looking into what definition depends on what in order to understand and to maintain the software by overlooking the whole, becomes a hard task and error-prone if it is not done carefully.

(5-1) Single Slice

(5-1-1) Informal Definition of Single Slice

Given a word a and a set of statements S, Slice(a, S) is all the statements in S that contribute directly or indirectly to the definition of the word a. A concrete example is given to clarify the notion of slice.

The Table 17 shows Lyee requirements which are a set of statements.

TABLE 17
Lyee Requirements

| Word | Definition | Condition | IO | Type | Security |
|---|---|---|---|---|---|
| a | b + c | | OS | int | public |
| g | | | IS | int | public |
| c | | | IS | int | public |
| d | e * g | g ≠ 0 | | float | public |
| e | | | IS | int | public |
| b | 4 * c | | | int | public |

If S is the set of statements given in Table 17, then Slice(a, S) of the word a is as shown in Table 18.

TABLE 18
Slice (a, S)

| Word | Definition | Condition | IO | Type | Security |
|---|---|---|---|---|---|
| c | | | IS | int | public |
| b | 4 * c | | | int | public |
| a | b + c | | OS | int | public |

It is important to notice that a slice is by itself a complete set of requirements. This notion of slicing can be considered as a divide-and-conquer” technique which is very useful to understand or to maintain Lyee requirements especially when they contain a big number of statements.

(5-1-2) Formal Definition of Single Slice

Given a word “a” and a set of statements S, the slice associated to the word “a” in S, denoted by Slice(a, S), is defined as follows:

$$Slice ( a , S ) = Satement ( a , S ) ⋃ ( {⋃}_{b ∈ UseDirectAndIndirect ( Satement ( a , S ) , S )} \{ Satement ( b , S ) \} )$$

The aforementioned formal representation means that a result of the function Slice (a, S) is “a sum-set of statements of word a belonging to the set S of statements, and a set of statements of all words b belonging to direct and indirect Use of the statements of the word a”.

The algorithm of the following function Slice (a, S) allows to generate the slice associated to a given word in Lyee requirements (set of statements).

```
Slice(a: word, S: set of statements)
  Var slice_s : set of statements
    s : statement
  Begin
    s [symbol] Satement(a, S)
    slice_s [symbol] {s}
    For all b ∈ UseDirectAndIndirect(s, S) do
      slice_s [symbol] slices_s ∪ {Satement(b, S)}
    EndFor
    return slice_s
  End
```

The algorithm of the aforementioned function Slice (a, S) has the following meaning.

a is a word, and S is a set of statements which are requirements. A variable slice_s is a set of statements, and a variable s is one statement.

```
<Begin>
Record a result of the function Statements (a, S) [return
statements of word a belonging to the requirement S] in the
variable s.
Record a value of the variable s in the variable slice_s.
<Start of For statement> Execute the followings for all the
words b belonging to the result of the function
UseDirectAndIndirect (s, S) [return direct and indirect Use
of statements belonging to the requirement S].
Record the value of the variable slice_s and a result of the
function Statement (b, S) [return statements of the words b
belonging to the statement S] in the variable slice_s.
  <End of For sentence>
    Return a value of the variable slice_s.
<End>
```

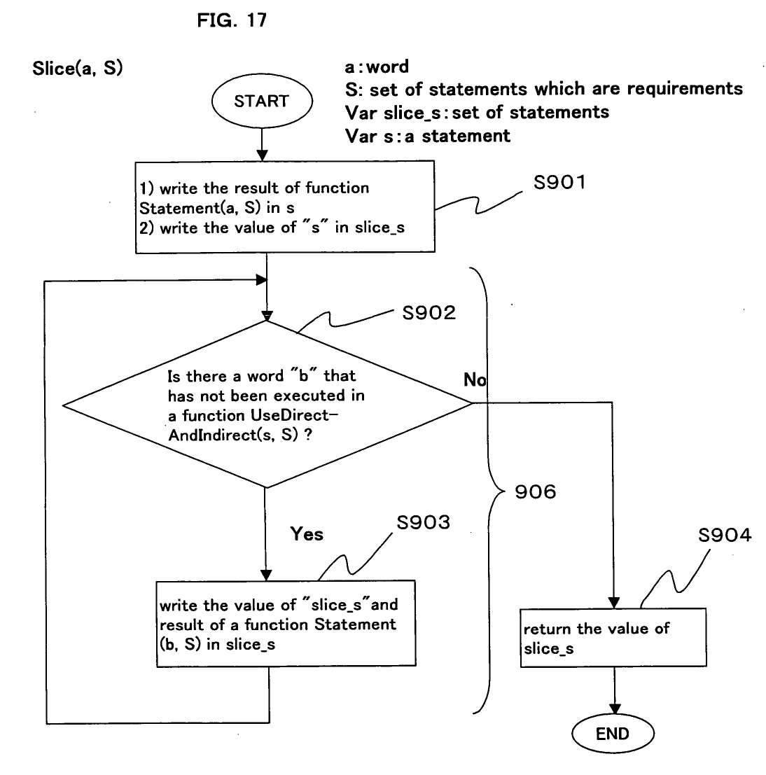

FIG. 17 is a flowchart showing the algorithm of this function Slice (a, S). Processing steps of FIG. 17 are explained as follows. First, in step 901, a result of the function Statement (a, S) [return statements of the word a belonging to the requirement S] is recorded, and a result of the function Statement (a, S) [return statements of the word a belonging to the requirement S] is recorded in the variable s. Next, the process proceeds to step 902 to determine “whether there is an unexecuted word b or not in the result of the function UseDirectAndIndirect (s, S) [return direct and indirect Use of statement s belonging to the requirement S]. If a result of the determination is true, the process proceeds to step 903 to record the value of the variable slice_s and statements of the result of the function Statement (b, S) [return statements of the words b belonging to the requirement S] in the variable slice_s, and the process returns to the step 902 to execute the determination again. As long as the step 902 is true, restart processing (905) of the steps 902 to 903 is repeated.

When the determination result of the step 902 becomes false, the process proceeds to step 904 to return the value of the variable slice_s as a result of the function slice (a, S).

The most important slices are generally those associated to output words. The algorithm of the following function AllOutputSlice(S) allows to generated the slices regarding each output word in a given Lyee requirements.

```
AllOutputSlices(S: set of statements)
  Var sliceSet : set of slices
  Begin
    sliceSet [symbol] ∅
    For all s ∈ OutputStatements(S) do
      sliceSet [symbol] sliceSet ∪ {Slice(Word(s), S))}
    EndFor
    return sliceSet
  End
```

The algorithm of the aforementioned AllOutputSlice (S) has the following meaning.

S is a set of statements which are requirements. A variable sliceSet is a set of slices.

```
<Begin>
  Record “0” in an area of the variable sliceSet.
  <Start of For sentence> Execute the followings for all the
statements s belonging to the function OutputStatements (S)
[return statements of all output words to the requirement S].
Record a value of the variable sliceSet and a result of a
function Slice (Word (s), S) [return slices of words of
statements s belonging to the requirement S] in the variable
sliceSet.
  <End of For sentence>
  Return the value of the variable sliceSet.
<End>
```

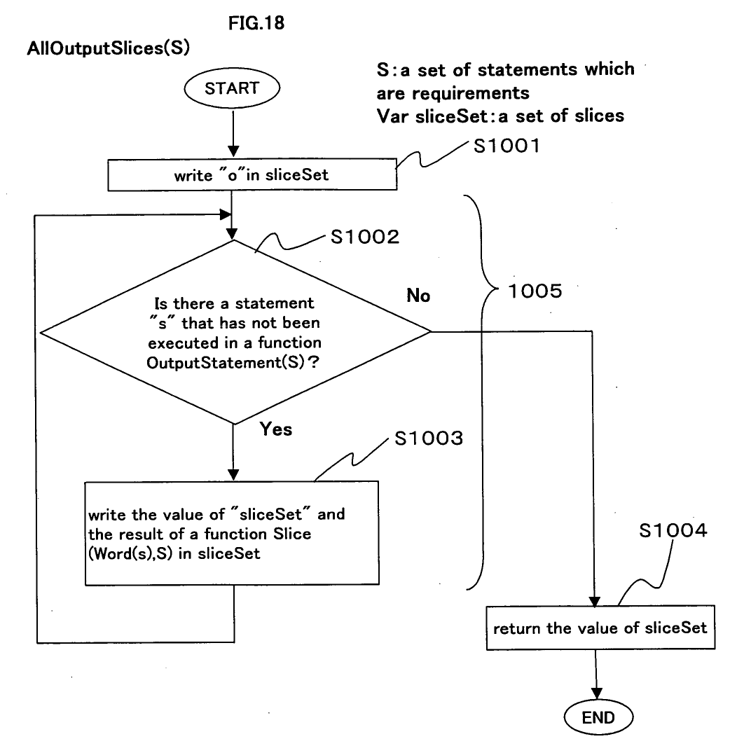

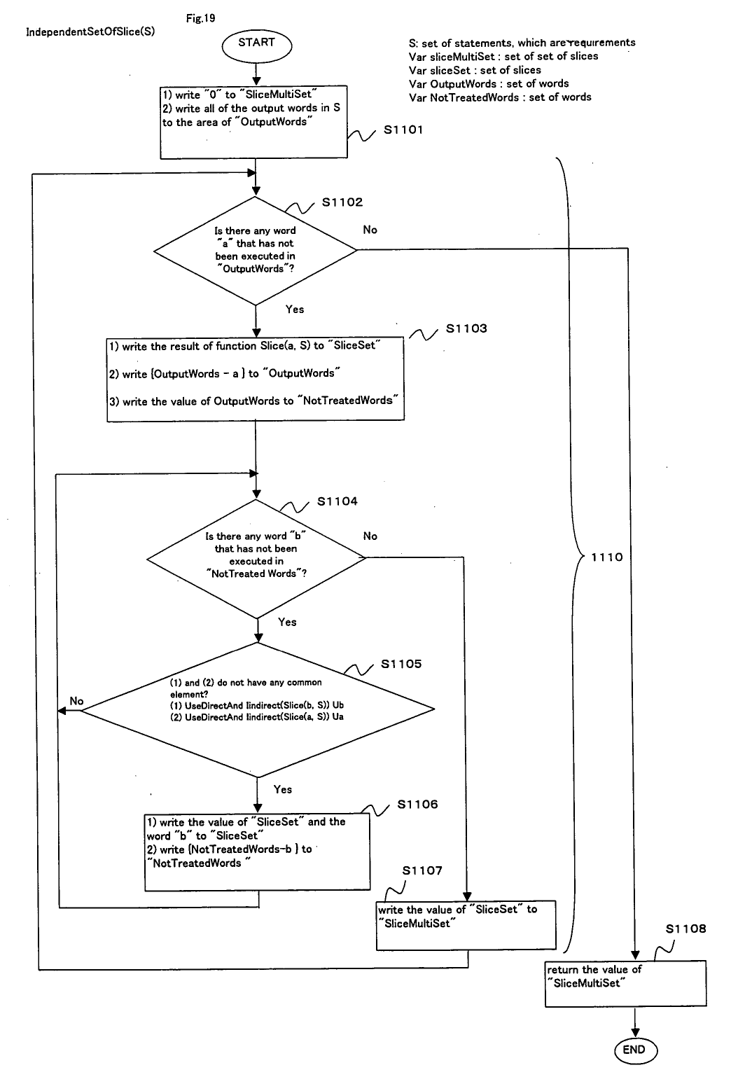

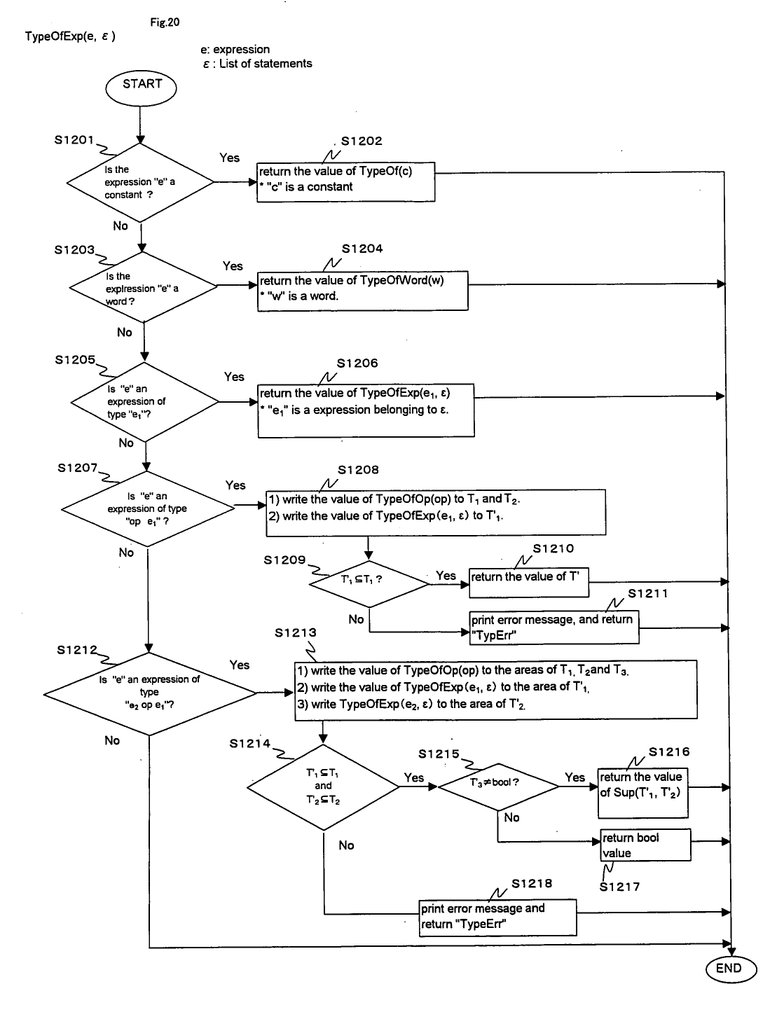

FIG. 18 is a flowchart showing the algorithm of the function AllOutputSlice (S). Processing steps of FIG. 18 will be sequentially described. First, “0” is recorded in an area of the variable sliceSet (step 1001). Next, in step 12, determination is made as to “whether there is an unexecuted statement s or not in the function OutputStatements (S) [return statements of all output words to the requirement S]”. If the determination result is truth, the process proceeds to step 1003 to record a value of the variable sliceSet and a result of the function Slice (Word (s), S) [return slices of words of the statements s belonging to the requirement S] in the area of the variable sliceSet. After an end of the step 1003, the process returns to the step 1002 to execute again. As long as the result of the step 1002 is true, restart processing (1005) of the steps 1002 to 1003 is repeated.

When the result of the step 1002 becomes false, the process proceeds to step 1004 to return the value of the variable sliceSet.

(5-2) Independent Slices

Slicing technique can be also easily used to know independent parts of requirement. Looking for those independent parts of a given requirements is another “divide-and-conquer” technique useful to both understanding the program and to its automatic parallelization.

(5-2-1) Informal Definition of Independent Slice

Two slice sets S₁ and S₂ are considered to be independent if there is not a statement which is involved in both S₁ and S₂. A concrete example of independent slices is given. Let S be a set of statements given in Table 17, then Slice(d, S) is as shown in Table 19.

TABLE 19
Slice(d, S), a slice of word d

| Word | Definition | Condition | IO | Type | Security |
|---|---|---|---|---|---|
| e | | | IS | int | public |
| g | | | IS | int | public |
| d | e*g | g≠0 | | int | public |

In this case, there are no statements related to both the Slice (a, S) of the Table 18 and the Slice (d, S) of the Table 19. Thus, it can be concluded that the two slices Slice (a, S) and Slice (d, S) are independent of each other and can be executed in parallel.

(5-2-2) Formal Definition of Independent Slice

Two slice sets S₁ and S₂ are independent if the following condition is established:
S₁∩S₂=∅

The above shows that there are no slices (set of statements) which are elements of S₁ and S₂.

Now suppose that we have a set of slices and we want to know which are the subsets of slices that are independent from each others. For instance, suppose that we have generated the slices associated to each output word and we want to detect the independent parts of these slices. First, some definitions that help to understand the concept of independent subset of slices are introduced.

Two Independent sets of slices:

Let S₁ and S₂ be two sets of slices. S₁ and S₂ are said to be independent if, for all slices S¹ ∈ S₁ (slice S¹ belonging to a slice set S₁) and S² ∈ S₂ (slice S² belonging to a slice set S₂), S¹ and S² are independent.

An Optimal Set of Slices:

Let S be a set of slices. S is an optimal set of slices if, for all S₁ ⊂ S (slice S₁ belong to a slice set S) and all S₂ ⊂ S (slice S₂ belongs to a slice set S) in which S₁≠Ø and S₂≠Ø, S₁ and S₂ are not independent.

Optimal and Independent Sets of Slices:

Let S₁ . . . Sₙ be n sets of slices. S₁ . . . Sₙ are optimal and independent sets of slices if, for all i, 1≦i≦n, all Sᵢ is optimal set of slices and, for all j, 1≦j≦n and i≠j, there is Sⱼ, and if all Sᵢ and Sⱼ are independent sets of slices.

The algorithm of the following function IndependentSetOfSlice(S) allows to extract the slices of output words and to separate them into optimal and independent sets of slices.

```
IndependentSetOfSlices(S: set of statements)
  Var sliceMultiSet : set of set of slices
    sliceSet : set of slices
    OutputWords : set of words
    NotTreatedWords : set of words
  Begin
    sliceMultiSet [symbol] ∅
    OutputWords [symbol] Word(OutputStatements(S))
    For all a ∈ OutputWords do
      sliceSet [symbol] Slice(a, S)
      OutputWords [symbol] OutputWords − {a}
      NotTreatedWords [symbol] OutputWords
      For all b ∈ NotTreatedWords do
        If (UseDirectAndIndirect(Slice(b, S)) ∪ {b})∩
              (UseDirectAndIndirect(Slice(a, S)) ∪ {a}) ≠ ∅
            sliceSet [symbol] sliceSet ∪ Slice(b, S)
          NotTreatedWords [symbol] NotTreatedWords − {b}
        EndIF
      EndFor
        sliceMultiSet [symbol] sliceSet
    EndFor
      return sliceMultiSet
  End
```

The algorithm of the aforementioned function IndependentSetOfSlice (S) has the following meaning. S is a set of statements which are requirements. A variable sliceMultiSet is a set of set of slices. The variable sliceSet is a set of slices. Variables OutputWords, NotThreatedWords are sets of words.

```
<Begin>
Record “0” in an area of the variable sliceSet.
Record a result of the function Word (OutputStatements (S))
[return words of statements of all output words of the
requirement S] in an area of the variable OutputWords.
  <Start of For sentence> Execute the followings for all the
words a belonging to the value of the variable OutputWords.
Record a result of the function Slice (a, S) [return slices
of the words a belonging to the requirement S] in the
variable sliceSet.
Record a set of words obtained by subtracting the words a
from the value of the variable OutputWords in the area of the
variable OutputWords.
Record the value of the variable OutputWords in an area of
the variable NotTreatedWords.
  <Start of For sentence> Execute the followings for all the
words b belonging to the variable NotTreatedWords.
  <Start of If sentence> If a product set of two sets, a sum-
set of the function UseDiurectAndIndirect (Slice (b, S))
[direct and indirect Use of slices of the words b [set of
statements of words used for defining the words b] and the
words b,
and a sum-set of the function UseDirectAndIndirect (Slice (a,
S)) [direct and indirect Use of slices of the words b [set of
statements of words used for defining the words a] and the
words a,
is not an empty, i.e., if there are common words which belong
to both the two sets,
record the value of the variable sliceSet and the function
Slice (b, S) in the area of the variable sliceSet,
and record a set of words obtained by subtracting the words b
from the value of the variable NotTreatedWords in the area of
the variable NotTreatedWords.
  <End of If sentence>
  <End of For sentence>
    Record the value of the variable sliceSet in the area
of the variable sliceMultiSet.
  <End of For sentence>
    Return the value of the variable sliceMultiSet.
  <End>
```

FIG. 19 is a flowchart showing the algorithm of the function IndependentSetOfSlice (S). Processing steps of FIG. 19 are explained as follows. First, “0” is recorded in an area of the variable sliceSet, and a result of the function Word(OutputStatements (S)) [return words of statements of all the output words of the requirement S] in the area of the variable OutputWords (step 1101). Next, in step 1102, determination is made as to “whether there is an unexecuted word a or not in the value of the variable OutputWords”. If a result of the determination is true, the process proceeds to step 1103. In the step 1103, a result of the function Slice (a, S) [return slices of words a belonging to the requirement S] is recorded in the variable sliceSet, a set of words obtained by subtracting the words a from the value of the variable OutputWords is recorded in the area of the variable OutputWords, and the value of the variable OutputWords is recorded in the area of the variable NotTreatedWords.

Next, in step 1104, determination is made as to “whether there is an unexecuted word b or not in the value of the variable NotTreatedWords”. If the result is true, the process proceeds to step 1105.

In the step 1105, determination is made as to “whether there is a product set of two sets or not (i.e., whether there are words which belong to both of two sets or not), a sum-set of the function UseDirectAndIndirect (Slice (b, S)) [direct and indirect Use of slices of words b [set of statements of words used for defining the words b] and words b, and a sum-set of the function UseDirectAndIndirect (Slice (a, S)) (direct and indirect Use of slices of words b [set of statements of words used for defining the words a] and word a. If the result of the determination is true, the process proceeds to step 1106 to record the value of the variable sliceSet and the function Slice (b, S) in the area of the variable sliceSet, and a set of words obtained by subtracting the words b from the value of the variable NotTreatedWords in the area of the variable NotTreatedWords. After an end of the step 1106, the process returns to the step 1104 to execute again. As long as the determination of the step 1104 is true, first restart processing (1109) of the steps 1104 to 1106 is repeated.

When the determination result of the step 1104 becomes false, the process proceeds to step 1107 to record the value of the variable sliceSet in the area of the variable sliceMultiSet. After an end of the step 1107, the process returns to the step 1102 to execute determination again. As long as the determination result of the step 1102 is true, second restart processing (1110) of the steps 1102 to 1107 is repeated.

When the determination result of the step 1102 becomes false, the process proceeds to step 1108 to return the value of the variable sliceMultiSet as a result of the function IndependentSetOfSlice (S).

(5-2-3) Example of set of Optimal Independent Slices

A concrete example of optimal and independent sets of slices is shown. The Table 20 gives a set of statements denoted by S.

TABLE 20
Requirements

| Word | Definition | Condition | IO | Type | Security |
|---|---|---|---|---|---|
| a | b | c = 3 | IS | int | public |
| b | c | c = 2 | OS | float | secret |
| c | 1 | 3 = 3 | OS | int | public |
| e | f | g = 3 | IS | int | public |
| f | g | 2 = 2 | OS | float | secret |
| g | 1 | 3 = 3 | OS | int | public |
| h | f | f = g | OS | int | public |

(1) Slices of Output Words

The set of slices corresponding to the output word of S, denoted by S, is as follows.
S={Slice(b, S),Slice(c, S),Slice(f, S),Slice(g, S),Slice(h, S)}

where the slices are as shown in the following tables:

TABLE 21
Slice(b, S), a slice of word b

| Word | Definition | Condition | IO | Type | Security |
|---|---|---|---|---|---|
| c | 1 | 3 = 3 | OS | int | public |
| b | c | c = 2 | OS | float | secret |

TABLE 22
Slice(c, S), a slice of word c

| Word | Definition | Condition | IO | Type | Security |
|---|---|---|---|---|---|
| c | 1 | 3 = 3 | OS | int | public |

TABLE 23
Slice(f, S), a slice of word f

| Word | Definition | Condition | IO | Type | Security |
|---|---|---|---|---|---|
| g | 1 | 3 = 3 | OS | int | public |
| f | g | 2 = 2 | OS | float | secret |

TABLE 24
Slice(g, S), a slice of word g

| Word | Definition | Condition | IO | Type | Security |
|---|---|---|---|---|---|
| g | 1 | 3 = 3 | OS | int | public |

TABLE 25
Slice(h, S), a slice of word h

| Word | Definition | Condition | IO | Type | Security |
|---|---|---|---|---|---|
| g | 1 | 3 = 3 | OS | int | public |
| f | g | 2 = 2 | OS | float | secret |
| h | f | f = g | OS | int | public |

(2) Optimal and Independent Set of Slices

The Optimal and independent set of slices that can be extracted from S are as follows.
S₁={Slice(b, S),Slice(c, S)}
and
S₂={Slice(f, S), Slice(g, S), Slice(h, S)}
6. Typing

Typing (see Nonpatent Documents 1 and 11) has mainly been used to statically guarantee some dynamic well-behavior properties of programs. Using Typing allows to detect at compile-time errors which happen frequently during the execution of program. Typing techniques has also successfully been used (see Nonpatent Document 11) to ensure that the developed software deal with some security issue.

In this section, it is shown how typing techniques can be used for analysis for detecting errors related to the types of words of Lyee requirements and for simplification of Lyee requirements (even if typing of an output words is not specified, the types of the intermediate word and of the output word are automatically generated from the types of the input ones). In addition, it is shown how the Lyee methodology can be easily extended to deal with security issue related to software development (e.g. some sensitive information will not be leaked caused by the software).

The aim of typing is to detect errors due to unsuited manipulation of types. Typing allows to correct types and to generate missing types, when it is possible. For instance, the user can only specify the types of input words then the types of all the words can be automatically generated. In order to detect type errors, to correct erroneous types or to generate missing types, we need first to clearly define the types of operand objects involved. It is important to notice that it is very helpful if the typing of a given Lyee requirement is done after various optimizations and analysis described before this section. In other word, we have to make sure that the given Lyee requirement does not contain cyclic statement, superfluous statements, or dead statements before we begin typing.

(6-1) Typing Rules

The typing technique involves generally the use of the following ingredients:

(6-1-1) Basic Types

This part defines the different kinds of types belonging to words, constants and operators that is contained in a given Lyee requirement.

<Value Types>

For the sake of simplicity, it is supposed that the types of a word and constants are boolean, int, or float (floating point number). Also, for the sake of convenience, these types are regrouped as follows:
Tᵥₐₗ::=Tₙᵤₘ|T_{bool}
Tₙᵤₘ::=int|float
T_{bool}::=bool

This previous definition can be read as follows: the Tᵥₐₗ (type of value) can be either Tₙᵤₘ (type of numerical value) or T_{bool} (type of bool value). Tₙᵤₘ can be either an int or a float. Finally, the type T_{bool} corresponds to bool.

<Operator Types>

Also, the types of boolean and arithmetic operators that can be involved in a given Lyee requirement have to be clarified. For each operator, the type of its operands (objects to be operated) and the type of its result have to be precise.

The type of a given operator has generally the following forms: T₁→T₂. Intuitively understood, this means that an operator is considered as a function that takes as input an element having a type T₁ and returns an element of type T₂.

Needless to say, some operators take more than one operand. Therefore, it is easy to take this fact into account if we consider that a type can be by itself a pair of types. To sum up, a type can be a Tᵥₐₗ (type of value), a pair of types T₁×T₂ or T₁→T₂. More formally put, it can be written as follows:
T::=Tᵥₐₗ|T₁×T₂|T₁→T₂

The above formal representation means that “any type T is among Tᵥₐₗ(type of value), a set of two types T₁×T₂, or T₁→T₂.

(6-1-2) Constant Typing

During the typing process of Lyee requirement, the types accorded to constants contained in statements are as follows:

| | |
|---|---|
| true, false | [symbol] bool, |
| num | [symbol] int, |
| num.num | [symbol] float, |

The above representation means that a true or false (true or false value) is a bool (bool type), a type of num (numerical value) is an int (integer type), and a type of num.num (floating point numerical value) is a float (floating type).

More precisely, as it will be shown later, the following function could be used to associate a type to given constant.

TypeOfCst(cst: constant)

Begin

Switch(cst)

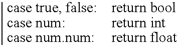

EndSwitch

End

The above function TypeOfCst(cst) has the following meaning.

15 An argument cst of the function is a constant.

```
<Begin>
Execute the function Switch(cst).
  When an argument constant cst is true or false (true/false
  value), return a value bool (bool type).
  When an argument constant cst is num (numerical value),
  return a value int (integral type).
  When an argument constant cst is num.num (floating point
  numerical value), return a value float (floating type).
End of the function Switch
<End>
```

The constant typing can be formalized by the following rule:

$$\frac{•}{ɛ ⊢ c \text{:} TypeOfCst ( c )}$$

This formalized constant typing rule states that the type of a constant c in a given Lyee requirement ε is, without any preconditions, simply the value returned by the function TypeOfCst(c). (notice that in the previous description S is denoted as a Lyee requirement, but that ε will be used in the typing technique since the notation ε is conventionally used.)
(6-1-3) Word Typing

For any input word, the user has necessarily to be precise about its type. For words other than input words, their types will be automatically computed and saved in the fields “type” of the statements defining these words. The function TypeOfWrd that returns the type of a word, when this word is already known, is defined as follows:

```
TypeOfWrd(w: word, ε: List of statements)
  Begin
    return Type(Statement(w,ε))
  End
```

The above function TypeOfWrd (w, ε) has the following meaning.

A function argument w is a word belonging to a statement list ε.

<Begin>
Calculate a statement of the word w (Statement(w, ε)), and
return a type (Type (s)) of the calculated statement (result
of the Statement(w, ε) is set as s).
<End>

The word typing can be formalized by the following rule:

$$\frac{•}{ɛ ⊢ w \text{:} TypeOfWrd ( w , ɛ )}$$

The word typing rule indicated by this formalized description states that the type of any word w whose typing environment is set by a given Lyee requirement ε, is without any preconditions, simply the value returned by the function TypeOfWrd(w, ε).

(6-1-4) Operator Typing

Now, more precision is needed for the type of each operator that can be used in a program. In fact, some of them need boolean arguments and return boolean result however others may need other type of arguments and return other type of results. A more precise type for each operator that can be involved in Lyee requirement can be formalized as follows:

| | |
|---|---|
| −ᵤ | [symbol] Tₙᵤₘ → Tₙᵤₘ, |
| not | [symbol] bool → bool, |
| +, −_{b}, * | [symbol] Tₙᵤₘ × Tₙᵤₘ → Tₙᵤₘ, |
| <, <=, >=, > | [symbol] Tₙᵤₘ × Tₙᵤₘ → bool, |
| or, and | [symbol] bool × bool → bool, |
| =, < > | [symbol] Tᵥₐₗ × Tᵥₐₗ → bool, |

The above formal definition has the following meaning. Operators of 1) and 2) take one value as an input and return one value. However, operators of 3) to 6) need two values as inputs to return one value as a result.

1) −u

A type of a single term operator −u is a function of returning Tₙᵤₘ (type of numerical value) when Tₙᵤₘ (type of numerical value) is given.

2) not

A type of not which is one of bool type operators is a function of returning a bool type (bool) when a bool type (bool) is given. For example, when true (bool type) is given to the operator not, a result of “not true” is false (bool type). When false (bool type) is given, a result of “not false” is true (bool type).

3) +, −b, *

Types of operators + (addition), −b (subtraction), * (multiplication) are functions of returning one Tₙᵤₘ (type of numerical value) when a set of Tₙᵤₘ (type of numerical value) and Tₙᵤₘ (type of numerical value) is given.

4) <, <=, >=, >

Types of operators < (left side is smaller than right side), <= (left side is smaller than or equal to right side), >= (left side is larger than or equal to right side), > (left side is larger than right side) are functions of returning one Tₙᵤₘ (type of numerical value) when a set of Tₙᵤₘ((type of numerical value) and Tₙᵤₘ (type of numerical value) is given.

5) or, and

Types of “or” (logical add operator) and “and” (logical product operator) which are bool type operators are functions of returning one bool (bool type) when a set of bool (bool type) and bool (bool type) is given. For example, when true (bool type) and true (bool type) are given to the logical add operator “or”, a result of “true or true” is true (bool type).

6) =, <>

Operators = (left side is equal to right side), and <> (left side is different from right side) are functions of returning one bool (bool type) when a set of Tᵥₐₗ (type of value) and Tᵥₐₗ (type of value) is given.

More specifically, a function TypeOfOp that returns the type of any given operator can be defined as follows:

TypeOfOp(op: operator)

Begin

Switch(op)

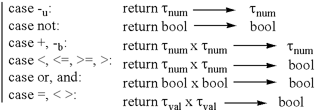

EndSwitch

End

The above function TypeOfOp(Op) has the following meaning.

An argument op is an operator.

```
<Begin>
Execute the function Switch(op)
  When the argument operator op is −u (single operator),
  return Tₙᵤₘ→Tₙᵤₘ(function type of taking a type of
  numerical value and returning a type of numerical value).
  When the argument operator op is not (logical operator),
  return bool→bool (function type of taking a bool type and
  returning a bool type).
  When the argument operator op is + or −b, return
  Tₙᵤₘ×Tₙᵤₘ→Tₙᵤₘ (function type of taking a set of two types
  of numerical values and returning type of numerical value).
  When the argument operators op are <, <=, >=, >, return
  Tₙᵤₘ×Tₙᵤₘ→bool (function type of taking a set of two types
  of numerical values and returning a bool type).
  The argument operator op returns bool×bool→bool (function
  type of taking a set of two bool types and returning bool
  types)
  The argument operator op returns Tᵥₐₗ×Tᵥₐₗ→Tᵥₐₗ (function
  type of taking a set of two types of values and returning
  types of values).
End of the function Switch
<End>
```

The operator typing can be formalized by the following rule:

$$\frac{•}{ɛ ⊢ Op \text{:} TypeOfOp ( Op )}$$

The above formalizing rule states that the type of an operator Op whose typing environment is set as a given Lyee requirement ε, is without any preconditions, simply the value returned by the function TypeOfOp(Op).

(6-1-5) Expression Typing

Hereafter, how to determine a type of each kind of expression will be presented. To simplify the explanation on the typing of expression, we need to introduce a partial ordering relation, denoted [symbol] , between types as follows:
T [symbol] T
int [symbol] float
float [symbol] Tₙᵤₘ
Tₙᵤₘ [symbol] Tᵥₐₗ
true [symbol] false
false [symbol] true
T_{bool} [symbol] Tᵥₐₗ

Notice that both true [symbol] false and false [symbol] true mean that true=false.

Now, using this previous ordering relation we can define the superior type (sup) of two types as follows:

$$Sup ( {τ}_{1} , {τ}_{2} ) = \{ \begin{matrix}{τ}_{2} & if {τ}_{1} ⊑ {τ}_{2} \\ {τ}_{1} & if {τ}_{2} ⊑ {τ}_{1}\end{matrix}$$

The above description means that “a superior type (Sup(T₁, T₂)) of “T₁ and T₂” is T₂ in the case of T₁ [symbol] T₂, and T₁ in the case of T₂ [symbol] T₁”.

The expression Exp is one of “val (value)”, “id (identifier)”, “(Exp) (bracketed expression)”, “op Exp (operator, expression)”, “Exp op Exp (expression, operator, expression)” as shown in the following definition:
Exp:=val|id||(Exp)|op Exp|Exp op Exp

The following function allows to associate a type to each kind of expression.

| TypeOfExp(e: expression, ε: List of statements ) | |
|---|---|
| Begin | |
| Switch(e) | |
| case c | : return TypeOfCst(c) |
| case w | : return TypeOfWrd(w) |
| case (e₁) | : return TypeOfExp(e₁, ε) |
| case op e₁ | : (T₁, T₂) [symbol] TypeOfOp(op) |
| | T′ [symbol] TypeOfExp(e₁,ε) |
| | if T′ [symbol] T₁ |
| | then return T′ |
| | else print ErrMsg, return TypErr |
| | EndIf |
| case e₁ op e₂ | : (T₁, T₂, T₃) [symbol] TypeOfOp(op) |
| | T′₁ [symbol] TypeOfExp(e₁, ε) |
| | T′₂ [symbol] TypeOfExp(e₂, ε) |
| | if T′₁ [symbol] T₁ and T′₂ [symbol] T₂ |
| | then if (T₃ ≠ bool) |
| | then return Sup(T′₁, T′₂) |
| | else return bool |
| | EndIf |
| | else print ErrMsg, return TypErr |
| | EndIf |
| EndSwitch | |
| End | |

The above function TypeOfExp(e, ε) has the following meaning. A function argument e is an expression belonging to a statement list ε.

```
<Begin>
Execute the function Switch(e)
  When the argument e is c (constant), return a value of
  TypeOfCst(c).
  When the argument e is w (word), return a value of
  TypeOfWrd(w).
  When the argument e is an expression of an “e₁” type
  (expression), return a value of TypeOfExp(e₁, ε).
  When the argument e is an “op e₁” type (single operator
  expression),
  record a value of TypeOfOp(op) in (T₁, T₂), and a value of
  TypeOfExp(e₁, ε) in T′.
    <Start of If processing> If a relation of T′ [symbol] T₁
    (T₁ is larger than T′) is established, return T₁.
    If not, print an error message (ErrMsg) and
    return TypErr.
    <End of If processing>
  When the argument e is a “e₁ op e₂” type (expression, two-
  term operator expression),
  record a value of TypeOfOp(op) in (T₁, T₂, T₃), a value of
  TypeOfExp(e₁, ε) in T′₁, and a value of TypeOfExp (e₂, ε)
  in T′₂.
    <Start of If processing> If relations of T′₁ [symbol] T₁
    (T₁ is lager than T′₁), and T′₂ [symbol] T₂ (T₂ is larger
    than T′₂) are established,
      <Start of If processing> and if T₃ is not a
      bool type, return Sup(T′₁, T′₂).
        If not, return bool.
        <End of If processing>
      If not, print an error message (ErrMsg) and
    return “TypErr”.
    <End of If processing>
End of the Switch.
<End>
```

FIG. 20 is a flowchart showing this function TypeOfExp(e, ε). FIG. 20 will be described in sequel. First, determination is made as to “whether an expression e is a constant or not” (step 1201). If the result is true, a result of the function TypeofCst(c) [return type of constant c] is returned (step 1202) to finish the processing.

If the result of the step 1201 is false, the process proceeds to step 1203 to determine “whether the expression e is a word or not”. If the determination result of is true, a result of the function TypeOfWord(w) [return a type of word w] is returned (step 1204) to finish the processing.

If the result of the step 1203 is false, the process proceeds to step 1205 to determine “whether the expression e is an expression of an “e₁” type (expression) or not”. If the result is true, a result of the function TypeOfExp(e₁, ε) [return a type of an expression e₁ belonging to a statement list ε] is returned (step 1206) to finish the processing.

If the result of the step 1205 is false, the process proceeds to step 1207 to determine “whether the expression e is “op e₁” type (single term operator, expression) or not”. If the result of the determination is true, a value of the function TypeOfOp(op) [return a type of the operator op] is recorded in (T₁, T₂), and a value of the function TypeOfExp(e₁, ε) [return a type of an expression e₁ belonging to the statement list ε] is recorded in T′ (step 1208). After an end of the step 1208, in step 1209, determination is made as to “whether T′ [symbol] T₁ [a type of T₁ is larger than a type of T′] is true or not”. If true, in step 1210, a value of T₁ is returned to finish the processing. If the result of the determination of the step 1209 is false, in step 1211, an error message (ErrMsg) is output to return “TypErr”, thereby finishing the processing.

If the result of the determination of the step 1207 is false, the process proceeds to step 1212. In the step 1212, determination is made as to “whether the expression e is an expression of an “e₁ op e₂” type (expression, two-term operator, expression) or not”. If the result of the determination is true, in step 1213, a value of the function TypeOfOp(op) [return a type of the operator op] is recorded in (T₁, T₂, T₃), a value of the function TypeOfExp(e₁, ε) [return a type of the expression e₁ belonging to the statement list ε] is recorded in T′₁, and a value of the function TypeOfExp(e₂, ε)) [return a type of an expression e₂ belonging to the statement list ε] is recorded in T′₂. After an end of the step 1213, in step 1214, determination is made as to “whether T′₁ [symbol] T₁ (a type of T₁ is larger than a type of T′₁), and T′₂ [symbol] T₂ (a type of T₂ is larger than a type of T′₂) is true or not”. If the result of the determination is true, the process proceeds to step 1215 to determine “whether that a type of T′₃ is not a bool type is true or not”. If the result of the determination is true, in step 1216, Sup(T′₁, T′₂) [return an uppermost type of the two types of T′₁ and T′₂] is returned (step 1216) to finish the processing. If the result of the step 1215 is false, in step 1217, a bool type is returned to finish the processing. If the result is false in the step 1214, in step 1218, an error message (ErrMsg) is output to return “TypErr”, thereby finishing the processing.

If the result of the step 1212 is false, the processing is finished.

A concrete example is taken to explain how this function works.

Suppose that an expression is “a+b”, and “a” and “b” are two input words having the integer type (int). Thus this expression has the form “e₁ op e₂ (expression 1, operator, expression 2)”, where “e₁=a”, “op=+” and “e₂=b”.

Therefore,

TypeOfOp(+)=Tₙᵤₘ×Tₙᵤₘ→Tₙᵤₘ (a type of the operator + is a function type of taking a set of two numerical value types and returning numerical values types), and thus, (T₁, T₂, T3)=(Tₙᵤₘ, Tₙᵤₘ, Tₙᵤₘ) is established,

TypeOfExp(a)=TypeOfExp(b)=int (expressions a, b are words whose types are integer types int, and thus TypeOfExp(a)=TypeOfWrd(a)=int, TypeOfExp(b)=TypeOfWrd(b)=int is set), thereby establishing T′₁=int, T′₂=int. From the aforementioned partial-order definition of the types, int [symbol] Tₙᵤₘ (numerical value type is higher than the integral type) can be derived, thus conditions of T′₁ [symbol] T₁ (T′₁=int, T₁=Tₙᵤₘ) and T′₂ [symbol] T₂(T′₂=int, T₂=Tₙᵤₘ) are established, and as T₃=Tₙᵤₘ, then T₃ ≠bool is also established.

Accordingly, Sup(T′₁, T′₂) which is returned as a last result of the function TypeOfExp(a+b) becomes Sup(int, int)=int (the largest type of the integer type and the integer type is the integer type). Thus, the following final result is obtained:

TypeOfExp(a+b)=int (type of an expression “a+b” is an integer type “int”).

As one more example, if the type of “a” is float (floating point number) type, then the type of “a+b” will be float type. It is because,

in TypeOfExp(a+b), in the case of a=float, b=int, (T₁, T₂, T₃)=(Tₙᵤₘ, Tₙᵤₘ, Tₙᵤₘ) is established, TypeOfExp(a)=float, TypeOfExp(b)=int (as an expressing a is a word whose type is a floating type float, and an expression b is a word whose type is an integer type int, TypeOfExp(a)=TypeOfWrd(a)=float, and TypeOfExp(b)=TypeOfWrd(b)=int are established), T′₁=float, T′₂=int are established.

From the aforementioned partial order definition of the types, because of int [symbol] float and float [symbol] Tₙᵤₘ (numerical value type is higher than the integer type), conditions of T′₁ [symbol] T₁ (T′₁=float, T₁=Tₙᵤₘ) and T′₂ [symbol] T₂ (T′₂=int, T₂=Tₙᵤₘ) are established, and because of T₃=Tₙᵤₘ, T₃≠bool is also established.

Thus, Sup(T′₁, T′₂) which is returned as the final result of the function TypeOfExp(a+b) becomes Sup(float, int)=float (higher type of the float type and the integer type is the float type).

More formally, the type of an expression can be captured by the following typing rules:

$$\begin{matrix} ( Cst ) & \frac{•}{ɛ ⊢ c \text{:} TypeOfCst ( c )} ( Wrd ) \frac{•}{ɛ ⊢ w \text{:} TypeOfWrd ( c , ɛ )} \\ ( Op ) & \frac{•}{ɛ ⊢ Op \text{:} TypeOfOp ( Op )} \\ ( {Exp}_{P} ) & \frac{ɛ ⊢ Exp \text{:} τ}{ɛ ⊢ ( Exp ) \text{:} τ} \\ ( {Exp}_{U} ) & \frac{ɛ ⊢ Op \text{:} {τ}_{1} -> {τ}_{2} ɛ ⊢ Exp \text{:} {τ}_{1}^{′} {τ}_{1}^{′} ⊑ {τ}_{1}}{ɛ ⊢ Op Exp \text{:} {τ}_{1}^{′}} \\ ( {Exp}_{BA} ) & \frac{ɛ ⊢ Op \text{:} {τ}_{1} \times {τ}_{2} -> {τ}_{3} ɛ ⊢ {Exp}_{1} \text{:} {τ}_{1}^{′} ɛ ⊢ {Exp}_{2} \text{:} {τ}_{2}^{′} {τ}_{1}^{′} ⊑ {τ}_{1} {τ}_{2}^{′} ⊑ {τ}_{2} {τ}_{3} \neq bool}{ɛ ⊢ {Exp}_{1} Op {Exp}_{2} \text{:} Sup ( {τ}_{1}^{′} , {τ}_{2}^{′} )} \\ ( {Exp}_{BB} ) & \frac{ɛ ⊢ Op \text{:} {τ}_{1} \times {τ}_{2} -> bool ɛ ⊢ {Exp}_{1} \text{:} {τ}_{1}^{′} ɛ ⊢ {Exp}_{2} \text{:} {τ}_{2}^{′} {τ}_{1}^{′} ⊑ {τ}_{1} {τ}_{2}^{′} ⊑ {τ}_{2}}{ɛ ⊢ {Exp}_{1} Op {Exp}_{2} \text{:} bool}\end{matrix}$$

The above formalizing rules are as follows:

(Cst) Rule when an expression is a constant:

A type of a constant c in which any given Lyee requirement ε is set as a typing environment is a value returned by the function TypeOfCst(C) without any preconditions.

(Wrd) Rule when an expression is a word:

A type of a word w in which any given Lyee requirement ε is set as a typing environment is a value returned by the function TypeOfWrd(w, ε) without any preconditions.

(Op) Rule when an expression is an operator:

A type of an operator op in which any given Lyee requirement ε is set as a typing environment is a value returned by the function TypeOfOp(Op) without any preconditions.

(Exp_{P}) Rule when an expression is a bracketed expression:

A type of an expression (Exp) in which any given Lyee requirement ε is set as a typing environment is T when a precondition “a type of an expression Exp in which any given Lyee requirement ε is set as a typing environment is T” is established.

(Exp_{U}) Rule when an expression is “op Exp”:

A type of an expression “op Exp” in which any given Lyee requirement ε is set as a typing environment is T′₁ when preconditions “if a type of an operator op in which any given Lyee requirement ε is set as a typing environment is T₁→T₂, if a type of an expression Exp is T′₁, and if T′₁ [symbol] ₁ is established, then the type is T” are established. (ExpBA) Rule when an expression is “Exp op Exp”, and an operation result is not a bool type:

A type of an expression “Exp₁ op Exp₂” in which any given Lyee requirement ε is set as a typing environment is Sup(T′₁, T′₂) when preconditions “a type of an operator op in which any given Lyee requirement ε is set as a typing environment is T₁×T₂→T₃, a type of an expression Exp₁ is T′₁, a type of an expression Exp₂ is T′₂, and T′₁ [symbol] T1, T′₂ [symbol] T₂, and T₃≠bool are true” are established.

(EXP_{BB}) Rule when an expression is “Exp op Exp”, and an operation result is a bool type:

A type of an expression “Exp₁ op Exp₂” in which any given Lyee requirement ε is set as a typing environment is bool when preconditions “a type of an operator op in which any given Lyee requirement ε is set as a typing environment is T₁×T₂→bool, a type of an expression Exp₁ is T′₁, a type of an expression Exp₂ is T′₂, and T′₁ [symbol] T1 and T′₂ [symbol] T₂ are true” are established.

(6-1-6) Statement Typing

Once a type determination method of a type is identified, it is quite easy to carry out typing of any given statement of Lyee requirements. The following function determines a type of any given statement s of the Lyee requirement ε.

```
TypeOfStat((Id, Exp, Cond, io, T, T_{sec}): statement, ε: List of statements)
  Begin
    If(io = IF) or (io = IS) and (T = ””)
    Then print ErrMsg
      return 0
    Else If(TypeOfExp(Exp)! =TypErr ) and (TypeOfExp(Cond) = bool)
      return (Id, Exp, Cond, io, TypeOfExp(Exp), T_{sec})
      EndIf
    EndIf
End
```

The above function TypOfStat((Id, Exp, Cond, io, T, T_{sec}), ε) has the following meaning. Function arguments (Id, Exp, Cond, io, T, T_{sec}) are values of items constituting any given statement in which a statement list ε being any given Lyee requirement is set as a typing environment(id=identifier of word, Exp=definition expression, Cond=definition expression execution condition expression, i=input/output attributes, T=type of value of word, and T_{sec}=type indicating security level of word value).

```
<Begin>
  <Start of If processing>
  If oi=If or io=IS and T is empty [that is, if a statement
  is of an input word and does not have type information],
  print an error message, and return “0” [that is, type
  determination is impossible].
  If not [that is, if statement is of an output word],
    <Start of If processing> if a result of the function
    TypeOfExp(Exp) [return type of definition expression
    Exp] is TypErr[type of the definition expression is
    TypErr, i.e., type determination is impossible], and a
    value of the function TypeOfExp(Cond) [return type of
    condition expression Cond] is a bool type,
    return (Id, Exp, Cond, io, TypeOfExp(Exp), T_{sec}) as a
    result.
    <End of If processing>
  <End of If processing>
<End>
```

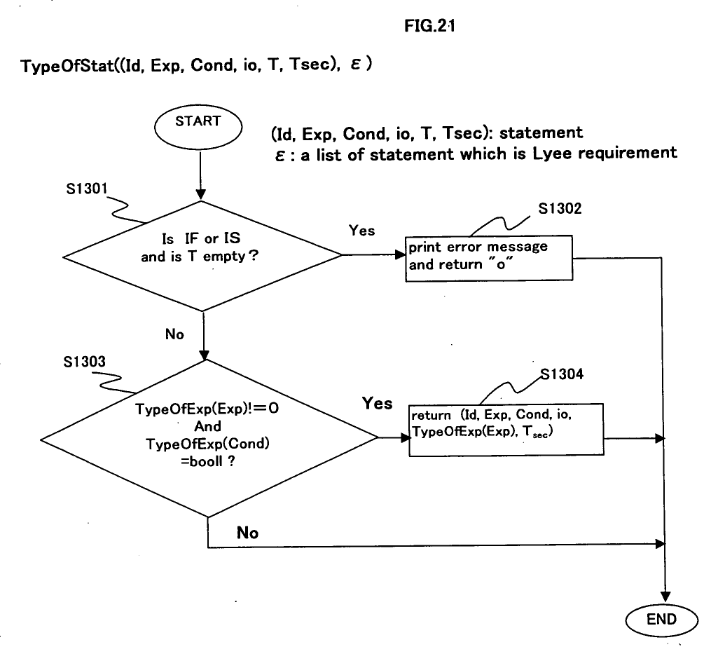

FIG. 21 is a flowchart showing the function TypeOfStat((Id, Exp, Cond, io, T, T_{sec}), ε). FIG. 21 will be described in sequel. First, determination is made as to “whether an io item of a statement is IF[input to a file] or IS[input to screen], and an item T is empty [there is no type information] or not” (step 1301). If the result of the determination is true, the process proceeds to step 1302 to print an error message (ErrMsg) and to return “0”, thereby finishing the processing.

If the result of the determination is false, the process proceeds to step 1303 to determine “whether a result of the function TypeOfExp(Exp) [return type of definition expression Exp] is TypErr[i.e., type determination is impossible], and a value of the function

TypeOfExp(Cond) [return type of condition expression Cond] is a bool type or not”. If the result of the determination is true, in step 1304, values of (Id, Exp, Cond, io, TypeOfExp(Exp), T_{sec}) are retuned to finish the processing. If the result of the determination is false, the processing is finished.

Formally put, the typing rule associated to this function is as follows:

$$\frac{ɛ ⊢ Exp \text{:} {τ}_{1} ɛ ⊢ Cond \text{:} bool io \neq IS io \neq IF}{ɛ ⊢ ( Id , Exp , Cond , io , τ , {τ}_{sec} ) \text{:} ( Id , Exp , Cond , io , {τ}_{1} , {τ}_{sec} )}$$

The rule indicated by the above formalizing description states that types of statements (Id, Exp, Cond, io, T, T_{sec}) in which a statement list ε of any given Lyee requirement is set as a typing environment are (Id, Exp, Cond, io, T₁, T_{sec}) when “preconditions ‘a type of a definition expression Exp is T₁, similarly a type of a definition expression execution condition expression is a bool type, and input/output attributes are neither IS nor IF in which the statement list ε of any given Lyee requirement is set as a typing environment’ are established”.

(6-1-7) Lyee Requirement Typing

Given an ordered list ε of any statement, then type determination is as follows:

TypeOfLyee(<s₁, . . . , sₙ>: list of statements)

Var ε₀: list of statements

Begin

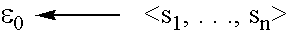

For i=1 to n

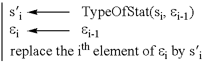

EndFor
return εₙ

End

The above function TypeOfLyee(<s₁, . . . , sₙ>) has the following meaning.

Arguments <s₁, . . . , sₙ> are lists of statements which are Lyee requirements, and a variable ε₀ is a statement list.

```
<Begin>
    Record statement lists <s₁, ..., sₙ> in an area of the
    variable ε₀.
    <Start of For processing> Substitute i with 1 to n, and
    execute the followings.
      Record a result of TypeOfStat(sᵢ, εᵢ₋₁) in s′ᵢ.
      Record a result of εᵢ₋₁ in εᵢ.
      Replace i-th element of εᵢ with s′ᵢ.
    <End of For processing>
    Return value of εₙ
<End>
```

For example, the function TypeOfLyee (<s₁, s₂, s₃>) of N=3 is as follows.

Record statement list <s₁, s₂, s₃> in the area of the variable ε₀

```
  <Start of For processing> in the case of i=1
      record a result of TypeOfStat(s₁, ε₀) in s′₁
      record a result of ε₀ in ε₁
      replace 1st element s₁ of ε₁ with a value of s′₁
              In the case of i=2,
      record a result of TypeOfStat(s₂, ε₁) in s′₂
      record a result of ε₁ in ε₂
      replace 2nd element s₂ of ε₂ with a value of s′₂
              In the case of i=3,
      record a result of TypeOfStat(s₃, ε₂) in s′₃
      record a result of ε₂ in ε₃
      replace 3rd element s₃ of ε₃ with a value of s′₃
    <End of For processing>
Return values <s′₁, s′₂, s′₃> of ε₃ as a result
<End>
```

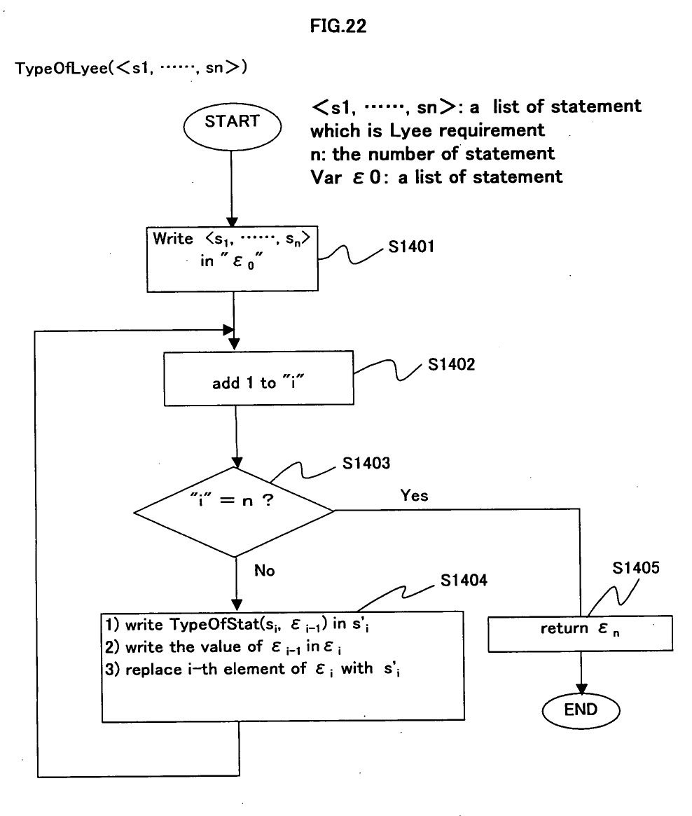

FIG. 22 is a flowchart showing the function TypeOfLyee (<s₁, . . . , sₙ>). FIG. 22 will be described in sequel. First, a statement list <s₁, . . . , sₙ> is recorded in the area of the variable ε₀ (step 1401). Next, 1 is added to i (step 1402), and the process proceeds to step 1403. In the step 1403, determination is made as to “whether a value of i is n or not”. If the result is false, a result of TypeOfStat (sᵢ, εᵢ₋₁) is recorded in s′ᵢ, a result of εᵢ₋₁ is recorded in εᵢ, and an i-th element of ε_{I} is replaced by s′ᵢ (step 1404). After an end of the step 1404, the process returns to the step 1402 to execute again. As long as the result of the step 1403 is false, restart processing (1406) of the steps 1402 to 1404 is repeated.

When the result of the step 1403 becomes true, in step 1405, a value of εₙ is returned to finish the processing. In this case, a value of εₙ is <s′₁, . . . , s′ₙ>.

Formally put, the typing rule associated to this function is as follows:

$$\frac{ɛ ⊢ {s}_{1} \text{:} {s}_{1}^{′} ɛ† [ {s}_{1} ← {s}_{1}^{′} ] ⊢ < {s}_{2} , … , {s}_{n} > : < {s}_{2}^{′} , … , {s}_{n}^{′} >}{ɛ ⊢ < {s}_{1} , … , {s}_{n} > \text{:} < {s}_{1} , … , {s}_{n} >}$$

The rule indicated by the above formalizing description states that “type of a statement list <s₁, . . . , sₙ> in which a statement list ε of Lyee requirement is set as a typing environment is <s′₁, . . . ,s′ₙ> when preconditions “type of a statement s₁ in which the statement list ε of the Lyee requirements is set as a typing environment is s′₁, and types of <s₂, . . . , s′ₙ> in which a statement list ε is set as a typing environment after s₁ is substituted with s′₁, are <s′₂, . . . , s′ₙ>” are established”.

Finally, the complete type determination system associated with an ordered Lyee requirement is as follows:

$$\begin{matrix} ( Cst ) & \frac{•}{ɛ ⊢ c \text{:} TypeOfCst ( c )} ( Wrd ) \frac{•}{ɛ ⊢ w \text{:} TypeOfWrd ( c , ɛ )} \\ ( Op ) & \frac{•}{ɛ ⊢ Op \text{:} TypeOfOp ( Op )} \\ ( {Exp}_{P} ) & \frac{ɛ ⊢ Exp \text{:} τ}{ɛ ⊢ ( Exp ) \text{:} τ} \\ ( {Exp}_{U} ) & \frac{ɛ ⊢ Op \text{:} {τ}_{1} -> {τ}_{2} ɛ ⊢ Exp \text{:} {τ}_{1}^{′} {τ}_{1}^{′} ⊑ {τ}_{1}}{ɛ ⊢ OpExp \text{:} {τ}_{1}^{′}} \\ ( {Exp}_{BA} ) & \frac{ɛ ⊢ Op \text{:} {τ}_{1} \times {τ}_{2} -> {τ}_{3} ɛ ⊢ {Exp}_{1} \text{:} {τ}_{1}^{′} ɛ ⊢ {Exp}_{2} \text{:} {τ}_{2}^{′} {τ}_{1}^{′} ⊑ {τ}_{1} {τ}_{2}^{′} ⊑ {τ}_{2} {τ}_{3} \neq bool}{ɛ ⊢ {Exp}_{1} Op {Exp}_{2} \text{:} Sup ( {τ}_{2}^{′} , {τ}_{2}^{′} )} \\ ( {Exp}_{BB} ) & \frac{ɛ ⊢ Op \text{:} {τ}_{1} \times {τ}_{2} -> bool ɛ ⊢ {Exp}_{1} \text{:} {τ}_{1}^{′} ɛ ⊢ {Exp}_{2} \text{:} {τ}_{2}^{′} {τ}_{1}^{′} ⊑ {τ}_{1} {τ}_{2}^{′} ⊑ {τ}_{2}}{ɛ ⊢ {Exp}_{1} Op {Exp}_{2} \text{:} bool} \\ ( Stat ) & \frac{ɛ ⊢ {s}_{1} \text{:} {s}_{1}^{′} ɛ† [ {s}_{1} ← {s}_{1}^{′} ] ⊢ < {s}_{2} , … , {s}_{n} > \text{:} < {s}_{2}^{′} , … , {s}_{n}^{′} >}{ɛ ⊢ < {s}_{1} , … , {s}_{n} > : < {s}_{1}^{′} , … , {s}_{n}^{′} >} \\ ( Req ) & \frac{ɛ ⊢ {s}_{1} \text{:} {s}_{1}^{′} ɛ† [ {s}_{1} ← {s}_{1}^{′} ] ⊢ < {s}_{2} , … , {s}_{n} > \text{:} < {s}_{2}^{′} , … , {s}_{n}^{′} >}{ɛ ⊢ < {s}_{1} , … , {s}_{n} > : < {s}_{1}^{′} , … , {s}_{n}^{′} >}\end{matrix}$$

The rule indicated by the above formalizing description are as follows.

(Cst) Rule when an expression is a constant:

A type of a constant c in which a statement list ε being Lyee requirement is set as a typing environment is a value returned by the function TypeOfCst(C) without any preconditions.

(Wrd) Rule when an expression is a word:

A type of a word w in which a statement list ε being Lyee requirement is set as a typing environment is a value returned by the function TypeOfWrd(w, ε) without any preconditions.

(Op) Rule when an expression is an operator:

A type of an operator op in which a statement list ε being Lyee requirement is set as a typing environment is a value returned by the function TypeOfOp(Op) without any preconditions.

(Exp_{P}) Rule when an expression is a bracketed expression:

A type of an expression (Exp) in which a statement list ε being Lyee requirement is set as a typing environment is T when a precondition “a type an expression Exp in which a statement list ε being Lyee requirement is set as a typing environment is T” is established.

(Exp_{U}) Rule when an expression is “op Exp”:

A type of an expression “op Exp” in which a statement list ε being Lyee requirement is set as a typing environment is T′₁ when preconditions “a type of an operator op in which an a statement list ε being Lyee requirement is set as a typing environment is T₁→T₂, a type of an expression Exp is T′₁, and T′₁ [symbol] ₁ is true” are established.

(EXP_{BA}) Rule when an expression is “Exp op Exp”, and an operation result is not a bool type:

A type of an expression “Exp₁ op Exp₂” in which a statement list ε being Lyee requirement is set as a typing environment is Sup(T′₁, T′₂) when preconditions “a type of an operator op in which a statement list 8 being Lyee requirement is a typing environment is T₁×T₂→T₃, a type of an expression Exp₁ is T′₁, a type of an expression Exp₂ is T′₂, and T′₁ [symbol] T1, T′₂ [symbol] T₂, and T₃≠bool are true” are established.

(EXP_{BB}) Rule when an expression is “Exp op Exp”, and an operation result is a bool type:

A type of an expression “Exp₁ op Exp₂” in which a statement list ε being Lyee requirement is set as a typing environment is bool when preconditions “a type of an operator op in which a statement list ε being Lyee requirement is set as a typing environment is T₁×T₂→bool, a type of an expression Exp₁ is T′₁, a type of an expression Exp₂ is T′₂, and T′₁ [symbol] T1 and T′₂ [symbol] T₂ are true” are established.

(6-2) Case Study

In the following, two examples showing the importance of the application of type checking on Lyee requirement are presented. The first example shows how a typing system can rightly detect errors related to violation of types. The second example shows the automatic generation of types by the typing system.

### EXAMPLE I

Suppose the requirements are given as in Table 26. As stated above, we need first to optimally order the statement before the verification of types. Therefore, the type verification will be applied on the ordered version of requirements shown in Table 27.

TABLE 26
Initial Requirements

| Word | Definition | Condition | IO | Type | Security |
|---|---|---|---|---|---|
| a | | true | IS | int | secret |
| b | c | 2 = 2 | OS | bool | public |
| c | a = 6 | 2 = 3 | | int | public |
| e | | true | IS | int | public |
| f | g | true | OS | float | secret |
| d | true + 6 | true | | int | public |
| g | d = 9 | 2 = 3 | OS | int | public |
| h | f | f = g | OS | int | public |

TABLE 27
Ordered Requirements

| Word | Definition | Condition | IO | Type | Security |
|---|---|---|---|---|---|
| a | | true | IS | int | secret |
| c | a = 6 | 2 = 3 | | int | public |
| b | c | 2 = 2 | OS | bool | public |
| e | | true | IS | int | public |
| d | true + 6 | true | | int | public |
| g | d = 9 | 2 = 3 | OS | int | public |
| f | g | true | OS | float | secret |
| h | f | f = g | OS | int | public |

If Typing analysis is done on ordered requirement of the Table 27, the results returned shows that there are some type errors in requirements as follows:
Error in Statement d: The expression (true) is not numeric (int or float).
Warning in Statement c: The type (int) have been amended to (bool).
Warning in Statement g: The type (int) have been amended to (bool).
Warning in Statement f: The type (float) have been amended to (bool).
Warning in Statement h: The type (int) have been amended to (bool).

The requirements in which proper types are newly generated by typing are those given in Table 28.

TABLE 28
Requirements after typing

| Word | Definition | Condition | IO | Type | Security |
|---|---|---|---|---|---|
| a | | true | IS | int | secret |
| c | a = 6 | 2 = 3 | | bool | public |
| b | c | 2 = 2 | OS | bool | public |
| e | | true | IS | int | public |
| d | true + 6 | true | | int | public |
| g | d = 9 | 2 = 3 | OS | bool | public |
| f | g | true | OS | bool | secret |
| h | f | f = g | OS | bool | public |

### EXAMPLE II

As mentioned above, the type system is also able to automatically generate the types of all words except the input ones. This characteristics will be shown by a concrete example.

As shown in the requirement given in Table 29, the given types are those of the input words. The type checking system applied to requirement (Table 30) which has been ordered, gives the results given in Table 31.

TABLE 29
Initial Requirements

| Word | Definition | Condition | IO | Type | Security |
|---|---|---|---|---|---|
| a | | true | IS | int | secret |
| b | c | 2 = 2 | OS | | public |
| c | a = 6 | 2 = 3 | | | public |
| e | | true | IS | int | public |
| f | g | true | OS | | secret |
| d | a + 6 | true | | | public |
| g | d = 9 | 2 = 3 | OS | | public |
| h | f | f = g | OS | | public |

TABLE 30
Requirements after ordered

| Word | Definition | Condition | IO | Type | Security |
|---|---|---|---|---|---|
| a | | true | IS | int | secret |
| c | a = 6 | 2 = 3 | | | public |
| b | c | 2 = 2 | OS | | public |
| e | | true | IS | int | public |
| d | a + 6 | true | | | public |
| g | d = 9 | 2 = 3 | OS | | public |
| f | g | true | OS | | secret |
| h | f | f = g | OS | | public |

TABLE 31
Requirements after typing

| Word | Definition | Condition | IO | Type | Security |
|---|---|---|---|---|---|
| a | | true | IS | int | secret |
| c | a = 6 | 2 = 3 | | bool | public |
| b | c | 2 = 2 | OS | bool | public |
| e | | true | IS | int | public |
| d | a + 6 | true | | int | public |
| g | d = 9 | 2 = 3 | OS | bool | public |
| f | g | true | OS | bool | secret |
| h | f | f = g | OS | bool | public |

7. Security Typing

In the sequel, how suitable Lyee methodology is for dealing with many other aspects of software development such as security is presented. In fact, typing technique presented above could be easily extended and applied to attest that a generated code satisfies some security policy such as data confidentiality and integrity when the program is executed in a hostile environment. The idea is to allow users to explicitly attach a security label (public, secret, etc.), which indicates security requirements, to each defined word, together with a security policy (e.g. the value of a secret word can not be stored in a public word). From these given information, we can use type checking techniques to automatically verify a program in order to reveal subtle design flaws that has a room for causing security violations.

For instance, suppose that we extend the requirement is extended by security label as shown within the statements given in Table 32.

TABLE 32

| Word | Definition | Condition | IO | Security | . . . |
|---|---|---|---|---|---|
| a | b + c | b > 2 | Output | public | . . . |
| c | | | Input | public | . . . |
| b | c + 5 | c > 0 | Output | secret | . . . |

Suppose that the security policy forbids to affect the value of a secret word on that of a public one. Suppose also that the result of the addition of a secret value to another value (secret or public) has to be considered as secret. Thus, it is clear that the requirement shown in Table 32 does not comply with the security policy since the public word “a” has received a secret value.

(7-1) Security Typing Rules

Similarly to the typing verification, security verification makes also use of the following ingredients. This section defines the different types that could belong to words, constants and operators that can be present in a given Lyee requirement.

(7-1-1) Basic Security Types

<Security Type of Value>

For the sake of simplicity, it is here supposed that a security type of word and constants can be public or secret.
τSᵥₐₗ::=public|secret
The above definition means that “the value security type (Tsᵥₐₗ) is public or secret”.
<Security Type of Operator>

We have also to clarify the security types of boolean operator and arithmetic operator that can be involved in Lyee requirement. For each operator, the security types of its operands and the type of its result need to be clarified. The Security types of a given operator has generally the following forms: TS₁→TS₂.

Intuitively understood, this formal description means that an operator can be considered as a function that takes as input an element having a security type TS₁ and returns an element having a security type TS₂. Needless to say, some operators take more than one operand. Therefore, it is easy to explain this kind of case if we consider that a security type can be by itself a pair of security types.

To sum up, a security type can be a TSᵥₐₗ (security type of one value), a pair of security types TS₁×TS₂, or TS₁→TS₂.

More formally put, we can write as in the followings:
τS::τSᵥₐₗ|τS₁×τS₂|τS₁→τS₂

The above formal description means that “the security type (T_{S}) is Tsᵥₐₗ, or Ts₁×Ts₂, or Ts₁→Ts₂”.

(7-1-2) Security Typing of Constants

During the security checking of Lyee requirement, the security type of the constants found in statements is simply a public as shown in the following:

| | |
|---|---|
| true, false | [symbol] public, |
| num | [symbol] public, |
| num.num | [symbol] public, |

That is to say that in the case in which the constant is true or false, and in the cases of num (numerical value) and num.num (floating point value), the security types are public. Similarly to the typing verification, the following function will be used to determine a security type of any given constant.

```
SecTypeOfCst(cst: constant)
  Begin
      return public
  End
```

The above function SecTypeOfCst(cst) has the following meaning.

A function argument cst means a constant.

<Begin>
Return a value public
<End>

The security typing of constants can be formalized by the following rule:

$$\frac{•}{ɛ ⊢ c \text{:} SecTypeOfCst ( c )}$$

The above formal description means that “a security type of the constant c in which a statement list ε being Lyee requirement is set as a security typing environment is a value of a result of SecTypeOfCst(c) without any preconditions”.
(7-1-3) Security Typing of Words

For any input word, the user has to be absolutely precise about its security type. For the remaining words, their security types will be automatically computed and saved in the fields “Security” of the statements defining these words. When there is an already known word, the function SecTypeOfWrd that returns the security type of a word is defined as follows:

SecTypeOfWrd(w: word, ε: List of statements)
Begin
return Security(Statement(w,ε))
End

The above function SecTypeOfWord(w, ε) has the following meaning.

The function argument w means any given word belonging to the requirement ε.

<Begin>
Return a value of a security type (Security (*), * is
a statement obtained by Statement(w, ε)) of a
statement(Statement(w, ε)) of a word w belonging to the
requirement ε.
<End>

The security typing of words can be formalized by the following rule:

$$\frac{•}{ɛ ⊢ w \text{:} SecTypeOfWrd ( w , ɛ )}$$

The above formal description means that “a security type of the word w in which a statement list ε being Lyee requirement is set as a security typing environment is a value of a result of SecTypeOfWrd(w, ε) without any preconditions”.

(7-1-4) Security Typing of Expressions

Hereafter, how to determine a security type of each kind of expression is explained.

To simplify the explanation on the security typing of expression, we need first to introduce a partial ordered relation, denoted [symbol] S, between security types:
τ_{S} [symbol] S τ_{S}
public [symbol] S secret

Using this partial ordered relation upper level of two security types can be defined as shown hereafter:

$$SecSup ( {τ}_{{S}_{1}} , {τ}_{{S}_{2}} ) = \{ \begin{matrix}τ {S}_{2} & if {τ}_{{S}_{1}} {⊑}_{S} {τ}_{{S}_{2}} \\ τ {S}_{1} & if {τ}_{{S}_{2}} {⊑}_{S} {τ}_{{S}_{1}}\end{matrix}$$

The above description means that “upper type (Sup(Ts₁, Ts₂)) of Ts₁ and Ts₂ is Ts₁ in the case of Ts₁ [symbol] sTs₂, and Ts₂ in the case of Ts₂ [symbol] sTs₁”.

As an expression is one of the followings, i.e., val (value), id (identifier of word), or (Exp) (bracketed expression), op Exp(operator, expression), or Exp op Exp (expression, operator, expression),
Exp:=val|id|(Exp)|op Exp|Exp op Exp

The following function allows to associate a security type to each kind of expression.

| SecTypeOfExp(e: expression, ε: List of statements) | |
|---|---|
| Begin | |
| Switch(e) | |
| case c | : return SecTypeOfCst(c) |
| case w | : return SecTypeOfWrd(w) |
| case (e₁) | : return SecTypeOfExp(e₁, ε) |
| case op e₁ | : return SecTypeOfOp(e₁) |
| case e₁ op e₂ | : T_{S}₁ [symbol] SecTypeOfExp(e₁, ε) |
| | T_{S}₂ [symbol] SecTypeOfExp(e₂, ε) |
| | return SecSup(T_{S}₁, T_{S}₂) |
| EndSwitch | |
| End | |

The above function SecTypOfExp(e, ε) has the following meaning.

A function argument e is any given expression belonging to the requirement ε.

```
<Begin>
Execute the function Switch(e)
  Return a value of a result of SecTypeOfCst(c) when the
  argument e of a result of SecTypeOfWrd(w) when the
  argument e is w (word)
  Return a value of a result of SecTypeOfExp(e₁, ε) when the
  argument e is e₁ (expression)
  Return a value of a result of SecTypeOfExp(e₁) when the
  argument e is op e₁ (operator expression)
  When the argument e is e₁ op e₂ (expression, operator,
  expression),
      record SecTypeOfExp(e₁, ε) in Ts₁
      record SecTypeOfExp(e₂, ε) in Ts₂
      return SecSup(Ts₁, Ts₂)
  Finish the function Switch
  <End>
```

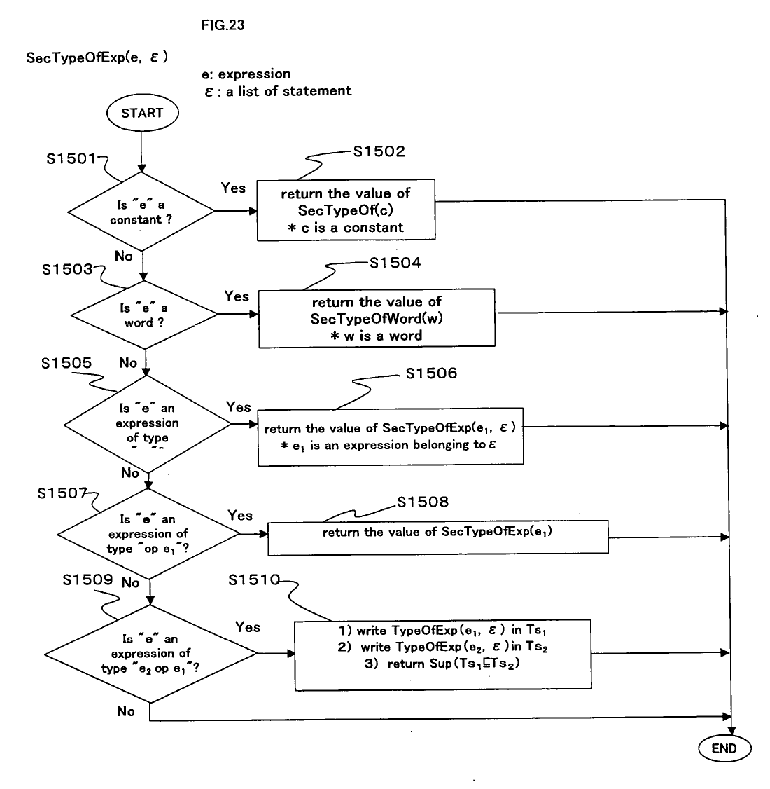

FIG. 23 is a flowchart showing the function SecTypeOfExp(e, ε). FIG. 23 will be described in sequel. First, determination is made as to “whether an expression e is a constant or not” (step 1501). If the result is true, a result of the function SecTypeOfCst(c) [return a security type of a constant c] is returned (step 1502) to finish the processing.

If the result of the step 1501 is false, the process proceeds to step 1503 to determine “whether the expression e is a word or not”. If the result of the determination is true, a result of the function SecTypeOfWord(w) [return a security type of a word w] is retuned (step 1504) to finish the processing.

If the result of the step 1503 is false, the process proceeds to step 1505 to determine “whether the expression e is an expression of “e₁” type (expression) or not”. If the result is true, a result of the function SecTypeOfExp(e₁, ε) [return a security type of an expression e₁ belonging to a statement list ε] is returned (step 1506) to finish the processing.

If the result of the step 1505 is false, the process proceeds to step 1507 to determine “whether the expression e is an expression of an “op e₁” type (single term operator, expression) or not”. If the result of the determination is true, a result of the function SecTypeOfExp(e₁) [return a security type of an expression e₁] is returned (step 1508).

If the result of the step 1507 is false, the process proceeds to step 1509. In the step 1509, determination is made as to “whether the expression e is an expression of an “e₁ op e₂” type (expression, two-term operator, expression) or not”. If the result of the determination is true, in step 1510, SecTypeOfExp(e₁, ε) is recorded in Ts₁, SecTypeOfExp(e₂, ε) is recorded in Ts₂, and SecSup(Ts₁, Ts₂) is returned to finish the processing.

If the result of the step 1509 is false, the processing is finished.

More formally, the security typing of an expression can be captured by the following rules:

$$\begin{matrix} ( Cst ) & \frac{•}{ɛ ⊢ c \text{:} SecTypeOfCst ( c )} ( Wrd ) \frac{•}{ɛ ⊢ w \text{:} SecTypeOfWrd ( w , ɛ )} \\ ( {Exp}_{P} ) & \frac{ɛ ⊢ Exp \text{:} {τ}_{S}}{ɛ ⊢ ( Exp ) \text{:} {τ}_{S}} \\ ( {Exp}_{U} ) & \frac{ɛ ⊢ Exp \text{:} {τ}_{S}}{ɛ ⊢ Op Exp \text{:} {τ}_{S}} \\ ( {Exp}_{B} ) & \frac{ɛ ⊢ {Exp}_{1} \text{:} {τ}_{{S}_{1}} ɛ ⊢ {Exp}_{2} \text{:} {τ}_{{S}_{2}}}{ɛ ⊢ {Exp}_{1} Op {Exp}_{2} \text{:} SecSup ( {τ}_{{S}_{1}} , {τ}_{{S}_{2}} )}\end{matrix}$$

The above formalizing rules are as follows.

(Cst) Rule when an expression is a constant: A type of a constant c in which a statement list ε being Lyee requirement is set as a security typing environment is a value returned by the function SecTypeOfCst(C) without any preconditions.

(Wrd) Rule when an expression is a word:

A type of a word w in which a statement list ε being Lyee requirement is set as a security typing environment is a value returned by the function SecTypeOfWrd(w,ε) without any preconditions.

(Exp_{P}) Rule when an expression is a bracketed expression:

A type of an expression (Exp) in which a statement list ε being Lyee requirement is set as a security typing environment is Ts when a precondition “a type of an expression Exp in which a statement list ε being Lyee requirement is set as a security typing environment is Ts” is established.

(Exp_{U}) Rule when an expression is “op Exp”:

A type of “Op Exp” in which a statement list ε being Lyee requirement is set as a security typing environment is Ts when preconditions “a type of an Exp (expression) in which a statement list ε being Lyee requirement is set as a security typing environment is Ts” is established.

(Exp_{B}) Rule when an expression is “Exp op Exp”:

A type of an expression “Exp₁ op Exp₂” in which a statement list ε being Lyee requirement is set as a security typing environment is Sup(TS₁, TS₂) when preconditions “a type of an expression Exp₁ is Ts₁, and a type of an expression Exp₂ is Ts₂ in which a statement list ε being Lyee requirement is set as a security typing environment” are established.

(7-1-5) Security Typing of Statements

The following function associates a security type to a given statement s in Lyee requirement ε:

```
SecTypeOfStat((Id, Exp, Cond, io, T, T_{sec}):  statement,
                            ε: List of statements)
  Begin
    If(io = IF) or (io = IS) and (Tₛec = ” ”)
    Then print ErrMsg
      return 0
    Else If(SecTypeOfExp(Exp) [symbol] _{S} T_{sec}) and (io ≠ OS) and (io ≠ OF)
      Then return (Id, Exp, Cond, io, T, T_{sec})
      EndIf
      If(SecTypeOfExp(Exp) [symbol] _{S} T_{sec} ≠ secret) and ((io = OS)
                                  or (io ≠ OF))
      Then return (Id, Exp, Cond, io, T, T_{sec})
      Else return ErrMsg
      EndIf
    EndIf
  End
```

The above function SecTypOfStat((Id, Exp, Cond, io, T, T_{sec}), ε) has the following meaning. The function arguments (Id, Exp, Cond, io, T, T_{sec}) are values of items constituting any given statement belonging to Lyee requirement ε (Id=identifier of word, Exp=definition expression, Cond=definition expression execution conditions, io=input/output attributes, T=type of value of word, and T_{sec}=type indicating security level of word).

```
<Begin>
  <start of If sentence> If io=IF or io=IS is set and T_{sec} is
  empty [that is, input/output attributes io are inputs but
  information on a security type is not supplied], print
  ErrMsg, and return “0” [as the security type cannot be
  determined, print an error message, and return 0]
  If not,
    <Start of If sentence> if SecTypeOfExp(Exp) [symbol] s T_{sec}[a
    security type of a statement is higher than a security
    type of a definition expression] and oi≠OS and oi≠OF
    [io is not an output, i.e., it is an input] are
    established, return (Id, Exp, Cond, io, T, T_{sec}).
    <End of If processing>
    <Start of If sentence> If SecTypeOfExp(Exp) [symbol] s T_{sec} ≠
    secret [a security type (not secret) of a statement is
    higher than a security type of a definition expression],
    and oi = OS and oi ≠ OF [io is an output to a screen or
    an output to a file] are established, return (Id, Exp,
    Cond, io, T, T_{sec}).
    If not, return ErrMsg (error message).
    <End of If processing>
  <End of If processing>
<End>
```

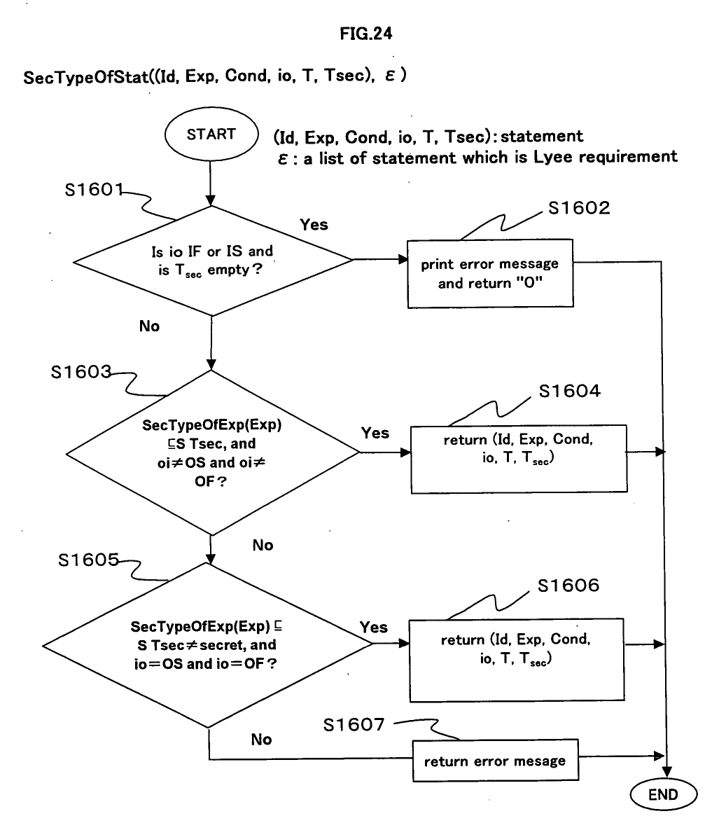

FIG. 24 is a flowchart showing the function SecTypeOfStat ((Id, Exp, Cond, io, T, T_{sec}), ε). FIG. 24 will be described in sequel. First, determination is made as to “whether an io item of a statement is IF [an input to a file] or IS [an input to a screen], and an item T is empty [there is no type information] or not” (step 1601). If the result of the determination is true, the process proceeds to step 1602 to print an error message (ErrMsg) and to return “0”, thereby finishing the processing.

If the result of the determination is false, the process proceeds to step 1503 to determine “whether SecTypeOfExp (Exp) [symbol] s T_{sec} [the security type of the statement is higher than the security type of the definition equation], and oi≠OS and oi≠OF [io is not an output, i.e., it is an input] are established or not”. If the result of the determination is true, in step 1504, (Id, Exp, Cond, io, T, T_{sec}) is returned to finish the processing.

If the result of the determination of the step 1503 is false, the process proceeds to step 1505 to determine “whether SecTypeOfExp (Exp) [symbol] s T_{sec}≠secret [the security type (not secrete) of the statement is higher than the security type of the definition expression], and io=OS or io≠OF [io is an output to a screen or an output to a file] are established or not”. If the result is true, in step 1506, values of (Id, Exp, Cond, io, T, T_{sec}) are returned to finish the processing.

If the result of the step 1505 is false, an error message (ErrMsg) is returned (step 1507) to finish the processing.

Formally put, the typing rule associated to this function is as follows.

$$\begin{matrix}( {Stat}_{1} ) & \frac{ɛ ⊢ Exp \text{:} {τ}_{{S}_{1}} io \neq IS io \neq IF}{ɛ ⊢ ( Id , Exp , Cond , io , τ , ” ” ) \text{:} ( Id , Exp , Cond , io , τ , {τ}_{{S}_{1}} )} \\ ( {Stat}_{2} ) & \frac{ɛ ⊢ Exp : {τ}_{{S}_{1}} {τ}_{{S}_{1}} {⊑}_{S} {τ}_{sec} io \neq IS io \neq IF}{ɛ ⊢ ( Id , Exp , Cond , io , τ , {τ}_{sec} ) \text{:} ( Id , Exp , Cond , io , τ , {τ}_{{S}_{1}} )}\end{matrix}$$

That is, the above formal description has the following meaning.

(Stat₁) in case of generating security type information in which output word is omitted:

When preconditions “a type of a definition expression Exp in which a statement list ε being Lyee requirements is set as a security typing environment is Ts₁, and statement input/output attributes are not inputs (io≠IS and io≠IF)” are established, a type of a statement (Id, Exp, Cond, io, T, “”) in which a statement list ε of Lyee requirements is set as a security typing environment is (Id, Exp, Cond, io, T, Ts₁). (Stat₂) in case of checking and correcting security type information of output word:

When preconditions “a type of a definition expression Exp in which a statement list ε being Lyee requirements is set as a security typing environment is Ts₁, the Ts₁ is higher than a value T_{sec} of a security type of a statement (Ts₁ [symbol] s T_{sec}), and input/output attributes are not inputs (io≠IS and io≠IF)” are established, a type of a statement (Id, Exp, Cond, io, T, T_{sec}) in which a statement list ε being Lyee requirements is set as a security typing environment is (Id, Exp, Cond, io, T, Ts₁).

(7-1-6) Security Typing of Lyee Requirements

Given an ordered statement list ε, then a security 10 type can be associated to each of its statements by the following function:

SecTypeOfLyee(<s₁, . . . , sₙ>: list of statements)

Var ε₀: list of statements

Begin

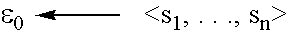

For i=1 to n

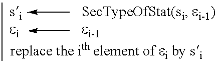

EndFor
return εₙ

End

The above function SecTypeOfLyee (<s₁, . . . , sₙ>) has the 15 following meaning.

A function argument <s₁, . . . , sₙ> is a list of any given statements. A value of a variable ε₀ is a statement list.

```
<Begin>
Record a statement list <s₁, ..., sₙ> in ε₀.
When i takes 1 to n, the following is executed.
    Record a value of SecTypeOfStat(sᵢ, εᵢ₋₁) in s′ᵢ
    Record a value of εᵢ₋₁ in εᵢ
    Replace i-th element of εᵢ with s′ᵢ.
<End of For processing>
Return εₙ
<End>
```

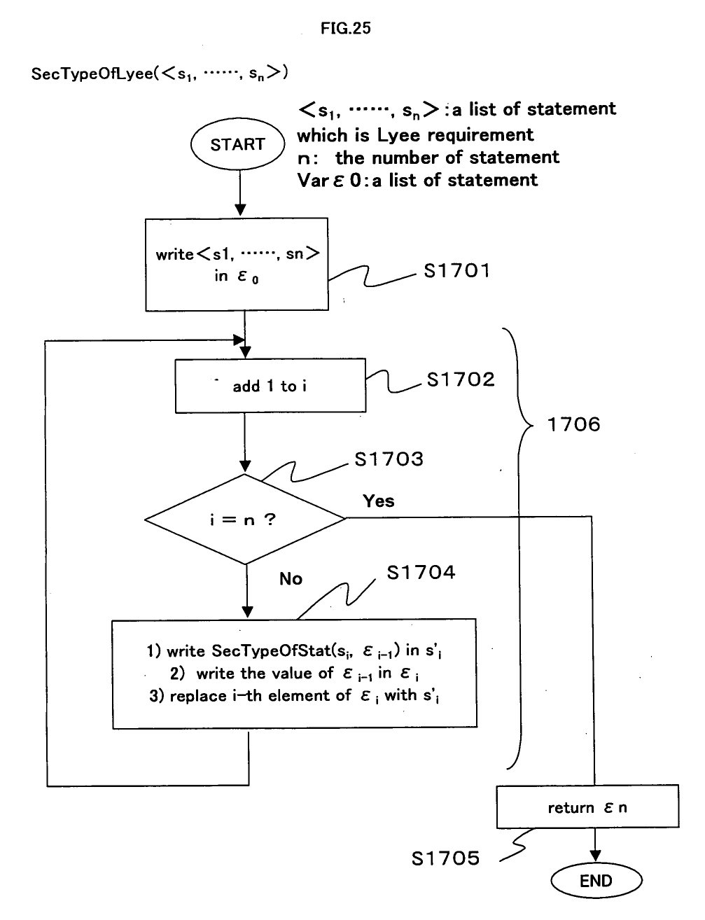

FIG. 25 is a flowchart of the function SecTypeOfLyee (<s₁, . . . , sₙ>). FIG. 25 will be described in sequel. First, the statement list <s₁, . . . , sₙ> is recorded in an area of the variable ε₀ (step 1701). Next, 1 is added to i (step 1702). The process proceeds to step 1703. In the step 1403, determination is made as to “whether a value of i is n or not”. If the result is false, a result of SecTypeOfStat (s₁, εᵢ₋₁) is recorded in s′ᵢ, a result of εᵢ₋₁ is recorded in ε_{i,}and i-th element of εᵢ is replaced by s′ᵢ (step 1704). After an end of the step 1704, the process returns to the step 1702 to execute again. As long as the result of the step 1403 is false, restart processing (1706) of the steps 1702 to 1704 is repeated.

When the result of the step 1703 becomes true, in step 1705, a value of εₙ is returned to finish the processing. In this case, the value of εₙ is <s′₁, . . . , s′ₙ>.

Formally put, the security typing rule associated to the above function is as follows.

$$\frac{ɛ ⊢ {s}_{1} \text{:} {s}_{1}^{′} ɛ† [ {s}_{1} ← {s}_{1}^{′} ] ⊢ < {s}_{2} , … , {s}_{n} > : < {s}_{2}^{′} , … , {s}_{n}^{′} >}{ɛ ⊢ < {s}_{1} , … , {s}_{n} > \text{:} < {s}_{1}^{′} , … , {s}_{n}^{′} >}$$

The rule indicated by the above formalizing description states that “when preconditions ‘a security type of a statement s₁ in which a statement list ε being Lyee requirements is set as a security typing environment is s′₁, and a security type of statements <s₂, . . . , s′ₙ> in which a statement list ε is set as a security typing environment after s₁ is substituted with s′₁ is <s′₂, . . . , s′ₙ>’ are established, a security type of the statement list <s₁, . . . , sₙ> in which the statement list ε being Lyee requirements is set as a security typing environment is <s′₁, . . . , s′ₙ>”.

$$\begin{matrix} ( Cst ) & \frac{•}{ɛ ⊢ c \text{:} SecTypeOfCst ( c )} ( Wrd ) \frac{•}{ɛ ⊢ w \text{:} SecTypeOfWrd ( w , ɛ )} \\ ( {Exp}_{P} ) & \frac{ɛ ⊢ Exp \text{:} {τ}_{S}}{ɛ ⊢ ( Exp ) \text{:} {τ}_{S}} \\ ( {Exp}_{U} ) & \frac{ɛ ⊢ Exp \text{:} {τ}_{S}}{ɛ ⊢ Op Exp \text{:} {τ}_{S}} \\ ( {Exp}_{ B} ) & \frac{ɛ ⊢ {Exp}_{1} \text{:} {τ}_{{S}_{1}} ɛ ⊢ {Exp}_{2} \text{:} {τ}_{{S}_{2}}}{ɛ ⊢ {Exp}_{1} Op {Exp}_{2} \text{:} SecSup ( {τ}_{{S}_{1}} , {τ}_{{S}_{2}} )} \\ ( {Stat}_{1} ) & \frac{ɛ ⊢ \text{:} {τ}_{{S}_{1}} io \neq IS io \neq IF}{ɛ ⊢ ( Id , Exp , Cond , io , τ , ” ” ) \text{:} ( Id , Exp , Cond , io , τ , {τ}_{{S}_{1}} )} \\ ( {Stat}_{2} ) & \frac{ɛ ⊢ Exp \text{:} {τ}_{{S}_{1}} {τ}_{{S}_{1}} {⊑}_{S} {τ}_{sec} io \neq IS io \neq IF}{ɛ ⊢ ( Id , Exp , Cond , io , τ , {τ}_{sec} ) \text{:} ( Id , Exp , Cond , io , τ , {τ}_{{S}_{1}} )} \\ ( Req ) & \frac{ɛ ⊢ {s}_{1} \text{:} {s}_{1}^{′} ɛ† [ {s}_{1} ← {s}_{1}^{′} ] ⊢ < {s}_{2} , … , {s}_{n} > : < {s}_{2}^{′} , … , {s}_{n}^{′} >}{ɛ ⊢ < {s}_{1} , … , {s}_{n} > \text{:} < {s}_{1}^{′} , … , {s}_{n}^{′} >}\end{matrix}$$

Finally, the complete security type system associated to an ordered Lyee requirement is as follows:

(Cst) Security type when an expression is a constant: A type of a constant c in which a statement list e being Lyee requirement is set as a security typing environment is a value returned by the function SecTypeOfCst(C) without any preconditions.

(Wrd) Security type when an expression is a word: A type of a word w in which a statement list ε being Lyee requirement is set as a security typing environment is a value returned by the function SecTypeOfWrd(w, ε) without any preconditions.

(Exp_{P}) Security type when an expression is a bracketed expression:

A type of an expression (Exp) in which a statement list ε being Lyee requirement is set as a security typing environment is Ts when a precondition “a type of an expression (Exp) in which a statement list ε being Lyee requirement is set as a security typing environment is Ts” is established.

(Exp_{U}) Security type when an expression is “op Exp”: A type of an expression “op Exp” (operator, expression) in which a statement list ε being Lyee requirement is set as a security typing environment is Ts when a precondition “a type of an Exp (expression) in which a statement list ε being Lyee requirement is set as a security typing environment is Ts” is established.

(Exp_{B}) Security type when an expression is “Exp op Exp¹: A type of an expression “Exp₁ op Exp₂” in which a statement list ε being Lyee requirement is set as a security typing environment is Sup (TS₁, TS₂), when preconditions “a type of an expression Exp₁ is Ts₁, and a type of an expression Exp₂ is Ts₂ in which a statement list ε being Lyee requirement is set as a security typing environment” are established.

(Stat₁) in case of generating security type information in which output word is omitted:

When preconditions “a type of a definition expression Exp in which a statement list ε being Lyee requirement is set as a security typing environment is Ts₁, and statement input/output attributes are not inputs (io≠IS and io≠IF)” are established, a type of a statement (Id, Exp, Cond, io, T, “”) in which a statement list ε being Lyee requirement is set as a security typing environment is (Id, Exp, Cond, io, T, Ts₁) (Stat₂) in case of checking and correcting security type information of output word:

When preconditions “a type of a definition expression Exp in which a statement list ε being Lyee requirement is set as a security typing environment is Ts₁, the Ts₁ is higher than a value T_{sec} of a security type of a statement (Ts₁ [symbol] s T_{sec}), and input/output attributes are not inputs (io≠IS and io≠IF)” are established, a type of a statement (Id, Exp, Cond, io, T, T_{sec}) in which a statement list ε being Lyee requirements is set as a security typing environment is (Id, Exp, Cond, io, T, Ts₁).

(Req) Security type of ordered Lyee requirements:

When preconditions “a security type of a statement s₁ in which a statement list ε being Lyee requirements is set as a security typing environment is s′₁, and a security type of <s₂, . . . , s′ₙ> in which the statement list ε is set as a security typing environment after s₁ is substituted with s′₁ is <s′₂, . . . , s′ₙ>” are established, a security type of the statement list <s₁, . . . , sₙ> in which the statement list ε being Lyee requirements is set as a security typing environment is <s′₁, . . . , s′ₙ>.

(7-2). Case Study

When security typing is executed for the aforementioned Lyee requirements given in Table 31, the following errors are detected:
Error in Statement c: A type of the word c is public, however, as its definition expression contains secret words(word “a” of definition expression “a=6” is secret) and gets effected by the secret word, it is contradictory.
Error in Statement b: A type of the word b is public, however, as its definition expression indirectly contains secret words(word “a” of definition expression “a=6” of word “c” of definition expression “c” is secret) and gets effected by the secret word, it is contradictory.
Error in Statement d: A type of the word d is public, however, as its definition expression contains secret words (word “a” of definition expression “a+6” is secret) and gets effected by the secret word, it is contradictory.
Error in Statement g: A type of the word g is public, however, as its definition expression indirectly contains secret words (word “a” of definition expression “a+6” of word “d” of definition expression “d=9” is secret) and gets effected by the secret word, it is contradictory.
Error in Statement f: A type of the word f is secret, however, as it is one of outputs, it is contradictory (because of a policy not to output a value whose security type is secret).
Error in Statement h: A type of the word h is public, however, as its definition expression indirectly contains secret words (definition expression of word “f” of definition expression “f” is “g”, definition expression of word “g” is “d=9”, and a definition expression of word “d” is “a+6”, and word “a” is secret) and gets effected by the secret word, it is contradictory.
   8. Lyee Requirement Analyzer

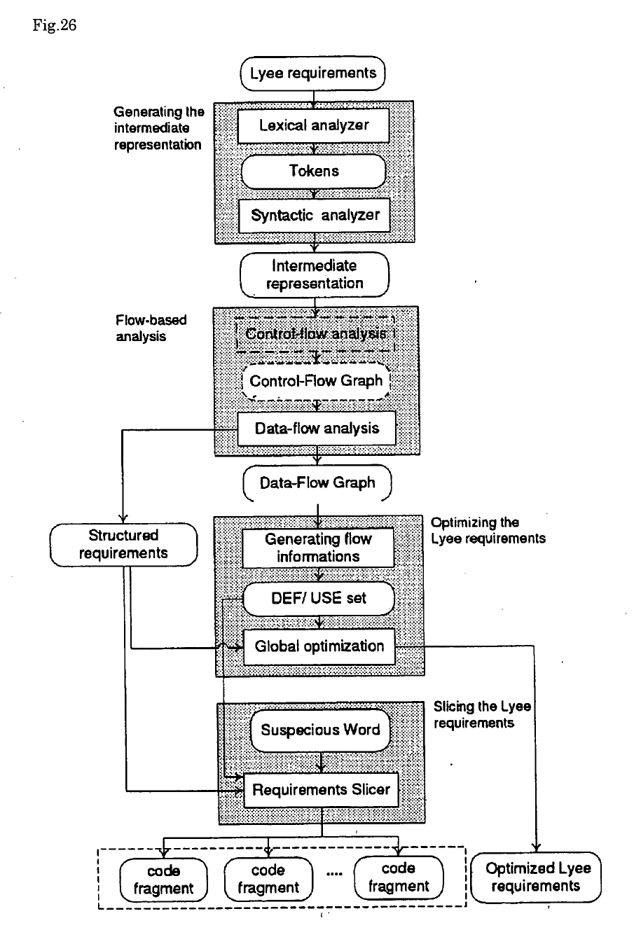

The Lyee Requirement Analyzer is a prototype that we have developed to partly implement static analysis techniques previously discussed. It takes as input Lyee requirements and can give as output slices and ordered requirements suitable for the generation of optimized code by the LyeeAll tool. Besides, it can perform other requirement optimizations such as constant propagation. As shown in FIG. 26, the basic components of this prototype are the followings:
Lexical and Syntactic Analyzers: This part takes as input Lyee requirements and gives as output a syntactic tree commonly called intermediate representation. This new representation method of requirements is the starting point of all the static analysis techniques that we are willing to do. Furthermore, when parsing the Lyee requirements, lexical or syntactic error can be detected and communicated to the user.
Flow-Based Analyzer: Starting form the intermediate representation generated by the previous part, the flow-based analysis component generates all information related to the circulation of data flow control from one requirement point to another. The results of these analysis consist of Control Flow Graph (CFG) and Data-Flow Graph (DFG).
Optimizer: Amongst others, this component implements the constant propagation techniques and generates an properly ordered and simplified sequence of statements suitable for the LyeeAll tool to produce a program that can run faster and consume less memory.
Slicer: This component takes as input flow related information (such as the Def/Use associated to each word) generated by the Flow-Based Analysis component and slicing evaluation criterion, and gives as output slices that correspond to these given evaluation criterion.
   9. Conclusion and FutureWorks

We have reported in this description the use of static analysis techniques on the Lyee requirements and their impact influences. First, we have presented how classical optimization techniques such as constant propagation and pattern detection can improve the execution time of the Lyee programs. We have also shown how to discover errors in requirements (dead definition, cyclic definition, incomplete or superfluous definitions). Second, we have discussed how slicing techniques can improve the understanding and the maintenance of Lyee systems. On top of that, we have shown how to find out independent part of Lyee systems that can be executed in parallel, by using this slicing techniques. Third, we have proposed a type system allowing both the detection of typing errors and the automatic generation of types of the intermediate and output words. Fourth, we have illustrated how Lyee methodology is suitable for some extension such as security aspects. Some of the presented static analysis techniques are now implemented in a prototype called Lyee Requirement Analyzer.

As a future work, we want first to complete the Lyee Requirement Analyzer tool and more investigate on the other static and dynamic analysis techniques to improve some other aspects of Lyee methodology.

10.

As described above in detail, according to the static analysis method of the embodiment of the present invention, since the static analysis method is used for the Lyee requirements, the Lyee requirements and the code string generated by Lyee can both be improved in terms of quality, whereby allowing to generate codes better of better quality (less consumption of memory and shorter execution time) than the conventional Lyee methodology.

(7) As developed forms, by using the aforementioned static analysis method or static analyzer for the Lyee requirements (request definition), more improved Lyee requirements can be obtained. These are input by the method described above in the “Overview of Lyee invention”, or the Lyee software generation method described in the Patent Documents 1, 2 and 4 to 6, further to the software generator described in the Patent Document 3. Thus, it is possible to realize a method or a device for generating desired software by Lyee with smaller memory space and shorter processing time.

That is, if efficiency is realized at the stage of the Lyee requirements (request definition) which is an upper stage of the software generation by Lyee, by applying the existing Lyee methodology to the processing thereafter, it is possible to obtain software which is a much higher quality end product.

The method or the device in the stage after the Lyee requirements (request definition) are obtained are to be according to the contents described above in the “Overview of the Lyee invention” or the methods described in the Patent Documents 1 to 6, and thus detailed description thereof will be omitted here.

According to the present invention, by using the classical static analyzing technique, the Lyee methodology can be enhanced more.

According to the static analyzer concerning the Lyee-oriented software of the present invention, the Lyee requirements are received, and slices suited for optimal code generation by the LyeeAll tool and the ordered requirements can be provided as outputs. Besides, it is possible to execute other requirement optimizations such as constant propagation.

Many features and advantages of the present invention are apparent from the detailed description. Moreover, as those who have usual knowledge in the technical field can easily make many modifications and changes, it is not desirable to limit the present invention to configurations or operations not even slightly different from the shown and described configurations or operations. Thus, all proper changes and equivalents can be within the scope of the present invention. The present invention has been described in detail by way of embodiments and examples. However, many modifications, substitutions, and changes can be made to the present invention without departing from the scope of the invention defined not only in the appended claims but also in all the disclosed items of the present invention.

Application of the present invention is not limited to the detailed understanding of elements or combination thereof disclosed in the foregoing description or the figures. The present invention can be implemented by other embodiments and can be put into practical use by various methods. The phrases and the terms used in the description are only descriptive but not limitative.

Thus, those who have usual knowledge in the technical field can understand that the basic concept of the disclosure can be easily used as a basis for designing other structures, methods, and systems to carry out some purposes of the invention. Accordingly, such equivalent understanding can be within the scope of the claims without departing from the spirit and scope of the present invention.

The software static analysis method and the static analyzer based on Lyee methodology have mainly been described above. Needless to say, the technical idea of the present invention can be realized and used as, e.g., an automatic development device of computer software; an automatic development program; a recording medium, a transmission medium or a paper medium on which the automatic development program is recorded; or in a category of a computer/device in which the automatic development program is installed; or a client/server form for executing the automatic development program, etc.

Not limited to the computer system that comprises a single processor, a single hard disk drive, and a signal local memory, the present invention is suited when a plurality of or a combination of optional processors or memory devices are installed as options of the system. The computer system includes a sophisticated computer, a palm-top type computer, a laptop/notebook computer, a minicomputer, a mainframe computer, a supercomputer, and a processing system network combination of these. The computer system can be replaced by an optional proper processing system operated in accordance with a principle of the present invention, and can be used in combination therewith.

The technical idea of the present invention can be applied to all kinds of programming languages. Additionally, the technical idea of the present invention can be applied to application software of all kinds and functions.

Furthermore, the present invention permits various changes, additions, substitutions, enlargement, reduction and the like within the scope of identical configurations and equivalents thereof of the technical idea. Even when software produced by using the present invention is mounted on a secondary product to be commercialized, a value of the invention is not reduced.

### INDUSTRIAL APPLICABILITY

According to the present invention, as the static analysis method is used for Lyee requirements, the Lyee requirements and the code string generated by Lyee can both be improved in quality. Thus, by enabling generation of codes having better quality (less consumption of memory and shorter execution time) than the conventional Lyee methodology, great effects can be provided in a software industry, such as great increases in efficiency, productivity, quality and the like of software production.

1. A static analysis method regarding Lyee-oriented software, characterized by comprising:
a step of obtaining a requirement definition including a definition expression of each word to produce software in accordance with Lyee methodology;
a step of using the word as a key to detect a constant of the obtained requirement definition; and
a step of propagating the constant in accordance with the definition expression which uses the detected constant.

2. A static analysis method regarding Lyee-oriented software, characterized by comprising:
a step of obtaining a requirement definition including a definition expression of each word to produce software in accordance with Lyee methodology;
a step of detecting a pattern from the definition expression of the obtained requirement definition; and
a step of substituting the requirement definition with representation in which the detected pattern is a substitution expression.

3. A static analysis method regarding Lyee-oriented software, characterized by comprising:
a step of obtaining a requirement definition including a definition expression and preconditions of each word to produce software in accordance with Lyee methodology;
a step of obtaining a statement in which at least an identifier, the definition expression and the preconditions of the word are described in conformity with BNF grammar based on the requirement definition;
a step of defining a Def/Use function for each obtained statement; and
a step of obtaining an order relation among the statements from an order relation among the defined Def/use functions.

4. A static analysis method regarding Lyee-oriented software, characterized by comprising:
a step of obtaining a requirement definition including a definition expression and input/output attributes of each word to produce software in accordance with Lyee methodology;
a step of obtaining a statement in which at least an identifier, the definition expression and the input/output attributes of the word are described based on the requirement definition;
a step of deriving, from the obtained statement (first statement), another statement (second statement) which contributes to definition of the word of the first statement to execute a slicing function which sets the first and second statements in the same statement group for all the statements; and
a step of obtaining slices independent of each other from the slicing function.

5. A static analysis method regarding Lyee-oriented software, characterized by comprising:
a step of obtaining a requirement definition including a definition expression and input/output attributes of each word to produce software in accordance with Lyee methodology;
a step of obtaining a statement in which at least an identifier, the definition expression and the input/output attributes of the word are described based on the requirement definition; and
a step of detecting a bug in the requirement definition based on predetermined analysis for the obtained statement.

6. The static analysis method regarding the Lyee-oriented software according to claim 5, characterized in that the predetermined analysis on the statement is executed by specifying at least one of an inactive statement, a cyclic statement, an incomplete statement and an additional statement.

7. A static analysis method regarding Lyee-oriented software, characterized by comprising:
a step of obtaining a requirement definition including a definition expression and input/output attributes of each word to produce software in accordance with Lyee methodology;
a step of obtaining a statement in which at least an identifier, the definition expression and the input/output attributes of the word are described based on the requirement definition;
a step of defining type algebras for the obtained statement, an operator and data in the statement; and
a step of discovering a type error in the requirement definition by using an environment and predetermined type rules correlated to the defined type algebras.

8. A static analysis method regarding Lyee-oriented software, characterized by comprising:
a step of obtaining a requirement definition including a definition expression and input/output attributes of each word to produce software in accordance with Lyee methodology;
a step of obtaining a statement in which at least an identifier, the definition expression and the input/output attributes of the word are described based on the requirement definition;
a step of defining type algebras for the obtained statement, an operator and data in the statement; and
a step of generating types of an intermediate article and an output word from an input word in the requirement definition by using a predetermined environment and type rules based on the defined type algebras.

9. A static analysis method regarding Lyee-oriented software, characterized by comprising:
a step of obtaining a requirement definition including a definition expression and input/output attributes of each word to produce software in accordance with Lyee methodology;
a step of obtaining a statement in which at least an identifier, the definition expression, the input/output attributes and a security label of the word are described based on the requirement definition;
a step of defining a label function which correlates the security label to a value of the word by using a lattice showing a relation between security labels in the obtained statement; and
a step of determining a program which does not comply with a specific security policy by using a predetermined security policy based on the defined label function.
